(19) United States
(12) Patent Application Publication
(10) Pub. No.: US 2023/0071290 A1
(43) Pub. Date: Mar. 9, 2023

(54) PERSON SUPPORT SYSTEMS INCLUDING A PERSON SUPPORT SURFACE HAVING AN INTEGRATED BLOWER FOR MICROCLIMATE MANAGEMENT

(71) Applicant: Hill-Rom Services, Inc., Batesville, IN (US)

(72) Inventors: Kathryn SMITH, Batesville, IN (US); Qinglin MOK, Singapore (SG); Darrell L. BORGMAN, Batesville, IN (US); Jeffrey A. RUSCHKE, Lawrenceburg, IN (US); Taylor FRANKLIN, Batesville, IN (US); Catherine Marie WAGNER, Osgood, IN (US); Timothy Michael VOLK, Cleves, OH (US)

(73) Assignee: Hill-Rom Services, Inc., Batesville, IN (US)

(21) Appl. No.: 17/798,418

(22) PCT Filed: Feb. 10, 2021
(86) PCT No.: PCT/US2021/017398

§ 371 Date: Aug. 9, 2022

Related U.S. Application Data
(60) Provisional application No. 62/972,353, filed on Feb. 10, 2020.

(51) Int. Cl. A61G 7/057; A61G 7/05; A61G 7/075; A61G 7/00; A61G 7/065; A61G 7/07; A61H 23/00; A61H 1/00

(52) U.S. Cl. CPC A61G 7/05776; A61G 7/0525; A61G 7/0755; A61G 7/001; A61G 7/065; A61G 7/072; A61H 23/006; A61H 1/005; A61G 7/05792; A61H 2201/0146; A61G 2210/50

(57) ABSTRACT

A person support system including a person support surface. The person support surface may include a blower subassembly and a surface foundation layer. The person support surface may further include a turn assist bladder layer, a working cushion layer, and a support cushion layer positioned between a first lateral side bolster and a second lateral side bolster of the surface foundation layer, a foot bladder layer positioned proximally adjacent the surface foundation layer, and a microclimate management (MCM) layer, where the blower subassembly may be configured to supply air to the MCM layer. A top encasement portion of the person support surface may be removably coupled to a bottom encasement portion of the person support surface to enclose such included components within the person support surface.

### CROSS-REFERENCE TO RELATED APPLICATION

This application claims priority to U.S. Provisional Patent Application No. 62/972,353, filed Feb. 10, 2020 and entitled “PERSON SUPPORT SYSTEMS INCLUDING A PERSON SUPPORT SURFACE HAVING AN INTEGRATED BLOWER FOR MICROCLIMATE MANAGEMENT,” the entire contents of which is hereby incorporated by reference in its entirety, including the drawings thereof.

### BACKGROUND

### Field

The present disclosure generally relates to person support systems including a person support surface, and more specifically, to person support systems including a person support surface having an integrated blower for microclimate management.

### Technical Background

In general, the healthcare industry is continually seeking medical devices that improve subject quality of care, reduce subject length of stay, reduce subject re-admissions, eliminate preventable subject falls, and prevent subject complications (e.g., hospital acquired infections, muscle atrophy, pressure injuries, and/or the like) while decreasing subject mortality rates. Furthermore, the healthcare industry is continually seeking medical devices that protect its caregiver workforce (e.g., medical devices that reduce the likelihood of caregiver work-related musculoskeletal injuries, and/or the like).

Aspects of the present disclosure include a person support surface including a combination of features that improve subject pressure injury prevention, improve subject turn assistance, improve subject ventilator-acquired pneumonia (VAP) prevention, improve person support surface cleaning and disinfection, and improve fluoroscopy usage.

### SUMMARY

In a first aspect A1, a person support system includes a person support surface, including: i) a top encasement portion and a bottom encasement portion, a blower subassembly, a surface foundation layer including a proximal end, a distal end, a first lateral side bolster and a second lateral side bolster, wherein the surface foundation layer extends between the proximal end and the distal end along a longitudinal axis, iv) a turn assist bladder layer, v) a support cushion layer, wherein the turn assist bladder layer and the support cushion layer are positioned between the first lateral side bolster and the second lateral side bolster of the surface foundation layer, vi) a foot bladder layer positioned proximally adjacent to the surface foundation layer, and vii) a microclimate management (MCM) layer positioned over the surface foundation layer, the turn assist bladder layer, the support cushion layer, and the foot bladder layer, wherein the blower subassembly is fluidly coupled to the MCM layer such that air is supplied by the blower subassembly to the MCM layer, and wherein the top encasement portion is removably coupled to the bottom encasement portion to enclose the blower subassembly, the surface foundation layer, the turn assist bladder layer, the support cushion layer, the foot bladder layer, and the MCM layer within the person support surface.

A second aspect A2 includes the system of the first aspect A1, wherein the person support surface further includes: a working cushion layer positioned between the first lateral side bolster and the second lateral side bolster of the surface foundation layer, wherein the MCM layer is positioned over the working cushion layer, and wherein the top encasement portion is removably coupled to the bottom encasement portion to further enclose the working cushion layer within the person support surface.

A third aspect A3 includes the system of the first aspect A1 or the second aspect A2, wherein the support cushion layer includes a plurality of air tubes oriented transverse to the longitudinal axis, and wherein each of the plurality of air tubes is cylindrically shaped.

A fourth aspect A4 includes the system of the third aspect A3, wherein the top encasement portion includes an enclosure that retains the MCM layer in contact with a surface of the top encasement portion.

A fifth aspect A5 includes the system of the third aspect A3, wherein the foot bladder layer includes a proximal end, a distal end, and a plurality of foot air bladders oriented transverse to the longitudinal axis, and wherein in an expanded state, the plurality of foot air bladders are arranged to realize a first height at a distal end of the foot bladder layer and a second height at a proximal end of the foot bladder layer such that the foot bladder layer slopes downward from the distal end toward the proximal end to reduce a subject's heel interface pressure.

A sixth aspect A6includes the system of the first aspect A1 or the second aspect A2, wherein the support cushion layer includes a plurality of air tubes oriented transverse to the longitudinal axis, wherein a first portion of the plurality of air tubes are cylindrically shaped, and wherein a second portion of the plurality of air tubes are shaped to conform to a profile of the surface foundation layer.

A seventh aspect A7 includes the system of the sixth aspect A6, wherein the top encasement portion includes an enclosure that retains the MCM layer in contact with a surface of the top encasement portion.

An eighth aspect A8 includes the system of the sixth aspect A6, wherein the foot bladder layer includes a proximal end, a distal end, and a plurality of foot air bladders oriented transverse to the longitudinal axis, and wherein in an expanded state, the plurality of foot air bladders are arranged to realize a first height at a distal end of the foot bladder layer and a second height at a proximal end of the foot bladder layer such that the foot bladder layer slopes downward from the distal end toward the proximal end to reduce a subject's heel interface pressure.

A ninth aspect A9 includes the system of the first aspect A1 or the second aspect A2, wherein the blower subassembly comprises: a blower enclosure housing a blower that produces a continuous flow rate of air for the MCM layer, one or more than one fluid inlet coupled to the blower enclosure, wherein the one or more than one fluid inlet is located on the person support surface to interface with one or more than one gap defined on one or more than one person support apparatus, and one or more than one fluid supply tube, wherein a first end of each fluid supply tube is coupled to the blower enclosure and a second end of each fluid supply tube is coupled to the MCM layer.

A tenth aspect A10 includes the system of the ninth aspect A9, further including one or more than one blow horn coupling the second end of each fluid supply tube to the MCM layer.

An eleventh aspect A11 includes the system of the ninth aspect A9, wherein the blower subassembly includes a first fluid supply tube and a second fluid supply tube, and wherein the blower enclosure is positioned in a proximal portion of the person support surface, the first fluid supply tube is routed along the first lateral side bolster of the surface foundation layer, and the second fluid supply tube is routed along the second lateral side bolster of the surface foundation layer to define a radiolucent window in a distal portion of the person support surface for fluoroscopy procedures.

A twelfth aspect A12 includes the system of the ninth aspect A9, wherein the MCM layer comprises an internal MCM sheet that defines a seat MCM portion, wherein the seat MCM portion corresponds to a seat section of one or more than one person support apparatus, and wherein an array of holes is defined in the seat MCM portion to uniformly distribute the continuous flow rate of air across a surface of the seat MCM portion.

A thirteenth aspect A13 includes the system of the twelfth aspect A12, wherein the internal MCM sheet further defines a foot MCM portion corresponding to a foot section of the one or more than one person support apparatus, wherein the foot MCM portion includes a spacer that is relatively softer than a spacer associated with the seat MCM portion to reduce a subject's heel interface pressure.

A fourteenth aspect A14 includes the system of the twelfth aspect A12, wherein the internal MCM sheet further defines a head MCM portion corresponding to a head section of the one or more than one person support apparatus, and wherein the seat MCM portion and the head MCM portion of the MCM layer are configured such that air continuously flows from the seat MCM portion across the head MCM portion toward a vent defined in a distal portion of the MCM layer.

A fifteenth aspect A15 includes the system of the first aspect A1 or the second aspect A2, wherein a sleeve is defined on a surface of the top encasement portion, wherein the sleeve is positioned to correspond with at least one of a head section, a seat section, or a foot section of one or more than one person support apparatus, and wherein the sleeve is accessible to place a medical device under a subject positioned on the person support surface.

A sixteenth aspect A16 includes the system of the first aspect A1 or the second aspect A2, wherein the top encasement portion includes one or more than one fluid flap extending over one or more than one interlocking device such that the person support surface is one of fluid-resistant or fluid-proof.

In a seventeenth aspect A17, a person support system includes a person support surface, including: i) a top encasement portion and a bottom encasement portion, a microclimate management (MCM) air source, a surface foundation layer including a proximal end, a distal end, a first lateral side bolster and a second lateral side bolster, wherein the surface foundation layer extends between the proximal end and the distal end along a longitudinal axis, iv) a plurality of person support surface layers positioned between the first lateral side bolster and the second lateral side bolster of the surface foundation layer, v) a foot bladder layer positioned proximally adjacent to the surface foundation layer, and vi) a MCM layer positioned over the surface foundation layer, the plurality of person support surface layers, and the foot bladder layer, wherein the MCM air source is fluidly coupled to the MCM layer such that air is supplied by the MCM air source to the MCM layer, and wherein the top encasement portion is removably coupled to the bottom encasement portion to enclose the MCM air source, the surface foundation layer, the plurality of person support surface layers, the foot bladder layer, and the MCM layer within the person support surface.

An eighteenth aspect A18 includes the system of the seventeenth aspect A17, wherein the plurality of person support surface layers includes one or more than one of a turn assist bladder layer, a support cushion layer, a working cushion layer, a percussion and vibration bladder layer, and an advanced articulation bladder layer.

A nineteenth aspect A19 includes the system of the seventeenth aspect A17, wherein the top encasement portion includes an enclosure retaining the MCM layer in contact with a surface of the top encasement portion.

A twentieth aspect A20 includes the system of the seventeenth aspect A17, the eighteenth aspect A18, or the nineteenth aspect A19, wherein the foot bladder layer includes a proximal end, a distal end, and a plurality of foot air bladders oriented transverse to the longitudinal axis, and wherein in an expanded state, the plurality of foot air bladders are arranged to realize a first height at a distal end of the foot bladder layer and a second height at a proximal end of the foot bladder layer such that the foot bladder layer slopes downward from the distal end toward the proximal end to reduce a subject's heel interface pressure.

A twenty-first aspect A21 includes the system of the seventeenth aspect A17, the eighteenth aspect A18, or the nineteenth aspect A19, wherein the MCM air source includes a blower subassembly including: a blower enclosure housing a blower producing a continuous flow rate of air for the MCM layer, one or more than one fluid inlet coupled to the blower enclosure, wherein the one or more than one fluid inlet is located on the person support surface to interface with one or more than one gap defined on one or more than one person support apparatus, and one or more than one fluid supply tube, wherein a first end of each fluid supply tube is coupled to the blower enclosure and a second end of each fluid supply tube is coupled to the MCM layer.

A twenty-second aspect A22 includes the system of the twenth-first aspect A21. wherein the blower subassembly includes a first fluid supply tube and a second fluid supply tube, and wherein the blower enclosure is positioned in a proximal portion of the person support surface, the first fluid supply tube is routed along the first lateral side bolster of the surface foundation layer, and the second fluid supply tube is routed along the second lateral side bolster of the surface foundation layer to define a radiolucent window in a distal portion of the person support surface for fluoroscopy procedures.

A twenty-third aspect A23 includes the system of the seventeenth aspect A17, the eighteenth aspect A18, or the nineteenth aspect A19, wherein the MCM layer comprises an internal MCM sheet that defines a seat MCM portion, wherein the seat MCM portion corresponds to a seat section of one or more than one person support apparatus, and wherein an array of holes is defined in the seat MCM portion to uniformly distribute the continuous flow rate of air across a surface of the seat MCM portion.

A twenty-fourth aspect A24 includes the system of the twenty-third aspect A23, wherein the internal MCM sheet further defines a foot MCM portion corresponding to a foot section of the one or more than one person support apparatus, wherein the foot MCM portion includes a spacer that is relatively softer than a spacer associated with the seat MCM portion to reduce a subject's heel interface pressure.

A twenty-fifth aspect A25 includes the system of the twenty-third aspect A23, wherein the internal MCM sheet further defines a head MCM portion corresponding to a head section of the one or more than one person support apparatus, and wherein the seat MCM portion and the head MCM portion of the MCM layer are configured such that air continuously flows from the seat MCM portion across the head MCM portion toward a vent defined in a distal portion of the MCM layer.

A twenty-sixth aspect A26 includes the system of the seventeenth aspect A17, the eighteenth aspect A18, or the nineteenth aspect A19, wherein a sleeve is defined on a surface of the top encasement portion, wherein the sleeve is positioned to correspond with at least one of a head section, a seat section, or a foot section of one or more than one person support apparatus, and wherein the sleeve is accessible to place a medical device under a subject positioned on the person support surface.

A twenty-seventh aspect A27 includes the system of the seventeenth aspect A17, the eighteenth aspect A18, or the nineteenth aspect A19, wherein the top encasement portion includes one or more than one fluid flap extending over one or more than one interlocking device such that the person support surface is one of fluid-resistant or fluid-proof

In a twenty-eighth aspect A28, a person support system includes a person support apparatus, and a person support surface, including: i) a top encasement portion and a bottom encasement portion, a microclimate management (MCM) air source, a surface foundation layer including a proximal end, a distal end, a first lateral side bolster and a second lateral side bolster, wherein the surface foundation layer extends between the proximal end and the distal end along a longitudinal axis, iv) a plurality of person support surface layers positioned between the first lateral side bolster and the second lateral side bolster of the surface foundation layer, v) a foot bladder layer positioned proximally adjacent to the surface foundation layer, and vi) a MCM layer positioned over the surface foundation layer, the plurality of person support surface layers, and the foot bladder layer, wherein the MCM air source is fluidly coupled to the MCM layer such that air is supplied by the MCM air source to the MCM layer.

A twenty-ninth aspect A29 includes the system of the twenty-eighth aspect A28, wherein the plurality of person support surface layers includes one or more than one of a turn assist bladder layer, a support cushion layer, a working cushion layer, a percussion and vibration bladder layer, and an advanced articulation bladder layer.

A thirtieth aspect A30 includes the system of the twenty-eighth aspect A28 or the twenty-ninth aspect A29, wherein the foot bladder layer includes a proximal end, a distal end, and a plurality of foot air bladders oriented transverse to the longitudinal axis, and wherein in an expanded state, the plurality of foot air bladders are arranged to realize a first height at a distal end of the foot bladder layer and a second height at a proximal end of the foot bladder layer such that the foot bladder layer slopes downward from the distal end toward the proximal end to reduce a subject's heel interface pressure.

A thirty-first aspect A31 includes the system of the twenty-eighth aspect A28 or the twenty-ninth aspect A29, wherein the person support apparatus comprises at least one of a standard person support apparatus, an advanced articulation person support apparatus, or a chair egress person support apparatus.

A thirty-second aspect A32 includes the system of the thirty-first aspect A31, wherein the MCM air source includes a blower subassembly including: a blower enclosure housing a blower producing a continuous flow rate of air for the MCM layer, one or more than one fluid inlet coupled to the blower enclosure, wherein the one or more than one fluid inlet is located on the person support surface to interface with one or more than one gap defined on the person support apparatus, and one or more than one fluid supply tube, wherein a first end of each fluid supply tube is coupled to the blower enclosure and a second end of each fluid supply tube is coupled to the MCM layer.

A thirty-third aspect A33 includes the system of the thirty-second aspect A32, further including one or more than one blow horn coupling the second end of each fluid supply tube to the MCM layer.

A thirty-fourth aspect A34 includes the system of the thirty-second aspect A32, wherein the blower subassembly includes a first fluid supply tube and a second fluid supply tube, and wherein the blower enclosure is positioned in a proximal portion of the person support surface, the first fluid supply tube is routed along the first lateral side bolster of the surface foundation layer, and the second fluid supply tube is routed along the second lateral side bolster of the surface foundation layer to define a radiolucent window in a distal portion of the person support surface for fluoroscopy procedures.

A thirty-fifth aspect A35 includes the system of the thirty-second aspect A32, wherein the MCM layer comprises an internal MCM sheet that defines a seat MCM portion, wherein the seat MCM portion corresponds to a seat section of the person support apparatus, and wherein an array of holes is defined in the seat MCM portion to uniformly distribute the continuous flow rate of air across a surface of the seat MCM portion.

A thirty-sixth aspect A36 includes the system of the thirty-fifth aspect A35, wherein the internal MCM sheet further defines a foot MCM portion corresponding to a foot section of the person support apparatus, wherein the foot MCM portion includes a spacer that is relatively softer than a spacer associated with the seat MCM portion to reduce a subject's heel interface pressure.

A thirty-seventh aspect A37 includes the system of the thirty-fifth aspect A35, wherein the internal MCM sheet further defines a foot MCM portion corresponding to a foot section of the person support apparatus, and wherein the seat MCM portion and the foot MCM portion of the MCM layer are configured such that air continuously flows from the seat MCM portion across the foot MCM portion toward a vent defined in a proximal portion of the MCM layer.

A thirty-eighth aspect A38 includes the system of the thirty-first aspect A31, wherein the person support surface further includes a top encasement portion, wherein a sleeve is defined on a surface of the top encasement portion and is positioned to correspond with at least one of a head section, a seat section, or a foot section of the person support apparatus, and wherein the sleeve is accessible to place a medical device under a subject positioned on the person support surface.

A thirty-ninth aspect A39 includes the system of the twenty-eighth aspect A28 or the twenty-ninth aspect A29, wherein the person support surface further includes a top encasement portion that includes one or more than one fluid flap extending over one or more than one interlocking device such that the person support surface is one of fluid-resistant or fluid-proof.

A fortieth aspect A40 includes the system of the twenty-eighth aspect A28 or the twenty-ninth aspect A29, wherein the person support surface further includes a top encasement portion that includes an enclosure retaining the MCM layer in contact with a surface of the top encasement portion.

In a forty-first aspect A41, a person support surface includes: i) a microclimate management (MCM) air source, a surface foundation layer including a proximal end, a distal end, a first lateral side bolster and a second lateral side bolster, wherein the surface foundation layer extends between the proximal end and the distal end along a longitudinal axis, a plurality of person support surface layers positioned between the first lateral side bolster and the second lateral side bolster of the surface foundation layer, iv) a foot bladder layer positioned proximally adjacent to the surface foundation layer, and v) a MCM layer positioned over the surface foundation layer, the plurality of person support surface layers, and the foot bladder layer, wherein the MCM air source is fluidly coupled to the MCM layer such that air is supplied by the MCM air source to the MCM layer.

A forty-second aspect A42 includes the person support surface of the forty-first aspect A41, wherein the plurality of person support surface layers includes one or more than one of a turn assist bladder layer, a support cushion layer, a working cushion layer, a percussion and vibration bladder layer, and an advanced articulation bladder layer.

A forty-third aspect A43 includes the person support surface of the forty-first aspect A41 or the forty-second aspect A42, further comprising a top encasement portion, wherein the top encasement portion includes an enclosure retaining the MCM layer in contact with a surface of the top encasement portion.

A forty-fourth aspect A44 includes the person support surface of the forty-first aspect A41 or the forty-second aspect A42, wherein the foot bladder layer includes a proximal end, a distal end, and a plurality of foot air bladders oriented transverse to the longitudinal axis, and wherein in an expanded state, the plurality of foot air bladders are arranged to realize a first height at a distal end of the foot bladder layer and a second height at a proximal end of the foot bladder layer such that the foot bladder layer slopes downward from the distal end toward the proximal end to reduce a subject's heel interface pressure.

A forty-fifth aspect A45 includes the person support surface of the forty-first aspect A41 or the forty-second aspect A42, wherein the MCM air source includes a blower subassembly including: a blower enclosure housing a blower producing a continuous flow rate of air for the MCM layer, one or more than one fluid inlet coupled to the blower enclosure, wherein the one or more than one fluid inlet is located on the person support surface to interface with one or more than one gap defined on one or more than one person support apparatus, and one or more than one fluid supply tube, wherein a first end of each fluid supply tube is coupled to the blower enclosure and a second end of each fluid supply tube is coupled to the MCM layer.

A forty-sixth aspect A46 includes the person support surface of the forty-fifth aspect A45, wherein the blower subassembly includes a first fluid supply tube and a second fluid supply tube, and wherein the blower enclosure is positioned in a proximal portion of the person support surface, the first fluid supply tube is routed along the first lateral side bolster of the surface foundation layer, and the second fluid supply tube is routed along the second lateral side bolster of the surface foundation layer to define a radiolucent window in a distal portion of the person support surface for fluoroscopy procedures.

A forty-seventh aspect A47 includes the person support surface of the forty-first aspect A41 or the forty-second aspect A42, wherein the MCM layer comprises an internal MCM sheet that defines a seat MCM portion, wherein the seat MCM portion corresponds to a seat section of one or more than one person support apparatus, and wherein an array of holes is defined in the seat MCM portion to uniformly distribute the continuous flow rate of air across a surface of the seat MCM portion.

A forty-eighth aspect A48 includes the person support surface of the forty-seventh aspect A47, wherein the internal MCM sheet further defines a foot MCM portion corresponding to a foot section of the one or more than one person support apparatus, wherein the foot MCM portion includes a spacer that is relatively softer than a spacer associated with the seat MCM portion to reduce a subject's heel interface pressure.

A forty-ninth aspect A49 includes the person support surface of the forty-seventh aspect A47, wherein the internal MCM sheet further defines a head MCM portion corresponding to a head section of the one or more than one person support apparatus, and wherein the seat MCM portion and the head MCM portion of the MCM layer are configured such that air continuously flows from the seat MCM portion across the head MCM portion toward a vent defined in a distal portion of the MCM layer.

A fiftieth aspect A50 includes the person support surface of the forty-first aspect A41 or the forty-second aspect A42, further comprising a top encasement portion, wherein a sleeve is defined on a surface of the top encasement portion and is positioned to correspond with at least one of a head section, a seat section, or a foot section of one or more than one person support apparatus, and wherein the sleeve is accessible to place a medical device under a subject positioned on the person support surface.

A fifty-first aspect A51 includes the person support system of the first aspect A1, the second aspect A2, the seventeenth aspect A17, the eighteenth aspect A18, or the nineteenth aspect A19, wherein the top encasement portion comprises a first portion of a MCM interlocking device and the MCM layer comprises a second portion of the MCM interlocking device, the first portion and the second portion of the MCM interlocking device couplable to retain the MCM layer in contact with a surface of the top encasement portion.

A fifty-second aspect A52 includes the person support system of the twenty-eighth aspect A28 or the twenty-ninth aspect A29, wherein the person support surface further includes a top encasement portion comprising a first portion of a MCM interlocking device, and wherein the MCM layer comprises a second portion of the MCM interlocking device, the first portion and the second portion of the MCM interlocking device couplable to retain the MCM layer in contact with a surface of the top encasement portion.

A fifty-third aspect A53 includes the person support surface of the forty-first aspect A41 or the forty-second aspect A42, further including a top encasement portion comprising a first portion of a MCM interlocking device, and wherein the MCM layer comprises a second portion of the MCM interlocking device, the first portion and the second portion of the MCM interlocking device couplable to retain the MCM layer in contact with a surface of the top encasement portion.

A fifty-fourth aspect A54 includes the person support system of the first aspect Al or the second aspect A2, wherein the person support surface further includes an enclosure, the enclosure housing at least one of a pneumatic air control box or an electrical air control box that periodically inflates and deflates at least one of air tubes of the support cushion layer or foot air bladders of the foot bladder layer to provide one or more than one of alternating low pressure therapy and continuous low pressure therapy.

A fifty-fifth aspect A55, includes the person support system of the seventeenth aspect A17, the eighteenth aspect A18, the nineteenth aspect A19, the twenty-eighth aspect A28, or the twenty-ninth aspect A29, wherein the plurality of person support surface layers includes a support cushion layer, and wherein the person support surface further includes an enclosure, the enclosure housing at least one of a pneumatic air control box or an electrical air control box that periodically inflates and deflates at least one of air tubes of the support cushion layer or foot air bladders of the foot bladder layer to provide one or more than one of alternating low pressure therapy and continuous low pressure therapy.

A fifty-sixth aspect A56 includes the person support surface of the forty-first aspect A41 or the forty-second aspect A42, wherein the plurality of person support surface layers includes a support cushion layer, and wherein the person support surface further includes an enclosure, the enclosure housing at least one of a pneumatic air control box or an electrical air control box that periodically inflates and deflates at least one of air tubes of the support cushion layer or foot air bladders of the foot bladder layer to provide one or more than one of alternating low pressure therapy and continuous low pressure therapy.

A fifty-seventh aspect A57 includes the person support system of the second aspect A2, wherein the person support surface further includes an enclosure, the enclosure housing at least one of a pneumatic air control box or an electrical air control box that controls at least one of turn bladders of the turn assist bladder layer or working cushion bladders of the working cushion layer to provide one or more than one of turn assist therapy and continuous lateral rotation therapy.

A fifty-eighth aspect A58 includes the person support system of the seventeenth aspect A17, the eighteenth aspect A18, the nineteenth aspect A19, the twenty-eighth aspect A28, or the twenty-ninth aspect A29, wherein the plurality of person support surface layers includes a turn assist bladder layer and a working cushion layer, and wherein the person support surface further includes an enclosure, the enclosure housing at least one of a pneumatic air control box or an electrical air control box that controls at least one of turn bladders of the turn assist bladder layer or working cushion bladders of the working cushion layer to provide one or more than one of turn assist therapy and continuous lateral rotation therapy.

A fifty-ninth aspect A59 includes the person support surface of the forty-first aspect A41 or the forty-second aspect A42, wherein the plurality of person support surface layers includes a turn assist bladder layer and a working cushion layer, and wherein the person support surface further includes an enclosure, the enclosure housing at least one of a pneumatic air control box or an electrical air control box that controls at least one of turn bladders of the turn assist bladder layer or working cushion bladders of the working cushion layer to provide one or more than one of turn assist therapy and continuous lateral rotation therapy.

A sixtieth aspect A60 includes the person support system of the first aspect A1 or the second aspect A2, wherein the person support surface further includes a percussion and vibration bladder layer and an enclosure, the enclosure housing at least one of a pneumatic air control box or an electrical air control box that controls percussion and vibration bladders of the percussion and vibration bladder layer to provide percussion and vibration therapy.

A sixty-first aspect A61 includes the person support system of the seventeenth aspect A17, the eighteenth aspect A18, the nineteenth aspect A19, the twenty-eighth aspect A28, or the twenty-ninth aspect A29, wherein the plurality of person support surface layers includes a percussion and vibration bladder layer, and wherein the person support surface further includes an enclosure, the enclosure housing at least one of a pneumatic air control box or an electrical air control box that controls percussion and vibration bladders of the percussion and vibration bladder layer to provide percussion and vibration therapy.

A sixty-second aspect A62 includes the person support surface of the forty-first aspect A41 or the forty-second aspect A42, wherein the plurality of person support surface layers includes a percussion and vibration bladder layer, and wherein the person support surface further includes an enclosure, the enclosure housing at least one of a pneumatic air control box or an electrical air control box that controls percussion and vibration bladders of the percussion and vibration bladder layer to provide percussion and vibration therapy.

In a sixty-third aspect A63, a person support system includes a person support surface, including: a surface foundation layer including a proximal end, a distal end, a first lateral side bolster and a second lateral side bolster, wherein the surface foundation layer extends between the proximal end and the distal end along a longitudinal axis; a foot bladder layer positioned proximally adjacent to the surface foundation layer, the foot bladder layer comprising one or more tube bladders arranged between one or more raft layers and a substrate in a system vertical direction, the one or more tube bladders arranged to define one or more voids between the one or more raft layers and the substrate.

A sixty fourth aspect A64 includes the system of the sixty third aspect A63, wherein the person support surface further includes: a top encasement portion and a bottom encasement portion; a blower subassembly; a turn assist bladder layer; a support cushion layer, wherein the turn assist bladder layer and the support cushion layer are positioned between the first lateral side bolster and the second lateral side bolster of the surface foundation layer; and a microclimate management (MCM) layer positioned over the surface foundation layer, the turn assist bladder layer, the support cushion layer, and the foot bladder layer, wherein the blower subassembly is fluidly coupled to the MCM layer such that air is supplied by the blower subassembly to the MCM layer; wherein the top encasement portion is removably coupled to the bottom encasement portion to enclose the blower subassembly, the surface foundation layer, the turn assist bladder layer, the support cushion layer, the foot bladder layer, and the MCM layer within the person support surface.

A sixty fifth aspect A65 includes the system of the sixty fourth aspect A64, wherein the person support surface further includes: a working cushion layer positioned between the first lateral side bolster and the second lateral side bolster of the surface foundation layer, wherein the MCM layer is positioned over the working cushion layer, and wherein the top encasement portion is removably coupled to the bottom encasement portion to further enclose the working cushion layer within the person support surface.

A sixty sixth aspect A66 includes the system as in the sixty fourth aspect A64 or the sixty fifth aspect A65, wherein the support cushion layer includes a plurality of air tubes oriented transverse to the longitudinal axis, wherein a first portion of the plurality of air tubes are cylindrically shaped, and wherein a second portion of the plurality of air tubes are shaped to conform to a profile of the surface foundation layer.

A sixty seventh aspect A67 includes the system of the sixty sixth aspect A66, wherein the top encasement portion includes an enclosure that retains the MCM layer in contact with a surface of the top encasement portion.

A sixty eighth aspect A68 includes the system as in the sixty fourth aspect A64 or the sixty fifth aspect A65, wherein the blower subassembly comprises: a blower enclosure housing a blower that produces a continuous flow rate of air for the MCM layer; one or more than one fluid inlet coupled to the blower enclosure, wherein the one or more than one fluid inlet is located on the person support surface to interface with one or more than one gap defined on one or more than one person support apparatus; and one or more than one fluid supply tube, wherein a first end of each fluid supply tube is coupled to the blower enclosure and a second end of each fluid supply tube is coupled to the MCM layer.

A sixty ninth aspect A69 includes the system of the sixty eighth aspect A68, further including one or more than one blow horn coupling the second end of each fluid supply tube to the MCM layer.

A seventieth aspect A70 includes the system of the sixty eighth aspect A68, wherein the blower subassembly includes a first fluid supply tube and a second fluid supply tube, and wherein the blower enclosure is positioned in a proximal portion of the person support surface, the first fluid supply tube is routed along the first lateral side bolster of the surface foundation layer, and the second fluid supply tube is routed along the second lateral side bolster of the surface foundation layer to define a radiolucent window in a distal portion of the person support surface for fluoroscopy procedures.

A seventy first aspect A71 includes the system of the sixty eighth aspect A68, wherein the MCM layer comprises an internal MCM sheet that defines a seat MCM portion, wherein the seat MCM portion corresponds to a seat section of one or more than one person support apparatus, and wherein an array of holes is defined in the seat MCM portion to uniformly distribute the continuous flow rate of air across a surface of the seat MCM portion.

A seventy second aspect A72 includes the system of the seventy first aspect A71, wherein the internal MCM sheet further defines a head MCM portion corresponding to a head section of the one or more than one person support apparatus, and wherein the seat MCM portion and the head MCM portion of the MCM layer are configured such that air continuously flows from the seat MCM portion across the head MCM portion toward a vent defined in a distal portion of the MCM layer.

A seventy third aspect A73 includes the system as in the sixty fourth aspect A64 or the sixty fifth aspect A65, wherein a sleeve is defined on a surface of the top encasement portion, wherein the sleeve is positioned to correspond with at least one of a head section, a seat section, or a foot section of one or more than one person support apparatus, and wherein the sleeve is accessible to place a medical device under a subject positioned on the person support surface.

A seventy fourth aspect A74 includes the system as in the sixty fourth aspect A64 or the sixty fifth aspect A65, wherein the top encasement portion includes one or more than one fluid flap extending over one or more than one interlocking device such that the person support surface is one of fluid-resistant or fluid-proof.

In a seventy fifth aspect A75, a person support surface includes a microclimate management (MCM) air source; a surface foundation layer including a proximal end, a distal end, a first lateral side bolster and a second lateral side bolster, wherein the surface foundation layer extends between the proximal end and the distal end along a longitudinal axis; a plurality of person support surface layers positioned between the first lateral side bolster and the second lateral side bolster of the surface foundation layer; a foot bladder layer positioned proximally adjacent to the surface foundation layer, the foot bladder layer comprising one or more tube bladders arranged between one or more raft layers and a substrate in a system vertical direction, the one or more tube bladders arranged to define one or more voids between the one or more raft layers and the substrate; and a MCM layer positioned over the surface foundation layer, the plurality of person support surface layers, and the foot bladder layer, wherein the MCM air source is fluidly coupled to the MCM layer such that air is supplied by the MCM air source to the MCM layer.

A seventy sixth aspect A76 includes the person support surface of the seventy fifth aspect A75, wherein the plurality of person support surface layers includes one or more than one of a turn assist bladder layer, a support cushion layer, a working cushion layer, a percussion and vibration bladder layer, and an advanced articulation bladder layer.

A seventy seventh aspect A77 includes the person support surface as in the seventy fifth aspect A75 or seventy sixth aspect 76, further comprising a top encasement portion, wherein the top encasement portion includes an enclosure retaining the MCM layer in contact with a surface of the top encasement portion.

A seventy eighth aspect A78 includes the person support surface as in the seventy fifth aspect A75 or seventy sixth aspect 76, wherein the MCM air source includes a blower subassembly comprising: a blower enclosure housing a blower producing a continuous flow rate of air for the MCM layer; one or more than one fluid inlet coupled to the blower enclosure, wherein the one or more than one fluid inlet is located on the person support surface to interface with one or more than one gap defined on one or more than one person support apparatus; and one or more than one fluid supply tube, wherein a first end of each fluid supply tube is coupled to the blower enclosure and a second end of each fluid supply tube is coupled to the MCM layer.

A seventy ninth aspect A79 includes the person support surface of the seventy eighth aspect A78, wherein the blower subassembly includes a first fluid supply tube and a second fluid supply tube, and wherein the blower enclosure is positioned in a proximal portion of the person support surface, the first fluid supply tube is routed along the first lateral side bolster of the surface foundation layer, and the second fluid supply tube is routed along the second lateral side bolster of the surface foundation layer to define a radiolucent window in a distal portion of the person support surface for fluoroscopy procedures.

An eightieth aspect A80 includes the person support surface as in the seventy fifth aspect A75 or seventy sixth aspect 76, wherein the MCM layer comprises an internal MCM sheet that defines a seat MCM portion, wherein the seat MCM portion corresponds to a seat section of one or more than one person support apparatus, and wherein an array of holes is defined in the seat MCM portion to uniformly distribute the continuous flow rate of air across a surface of the seat MCM portion.

An eighty first aspect A81 includes the person support surface of the eightieth aspect A80, wherein the internal MCM sheet further defines a foot MCM portion corresponding to a foot section of the one or more than one person support apparatus, wherein the foot MCM portion includes a spacer that is relatively softer than a spacer associated with the seat MCM portion to reduce a subject's heel interface pressure.

An eighty second aspect A82 includes the person support surface of the eightieth aspect A80, wherein the internal MCM sheet further defines a head MCM portion corresponding to a head section of the one or more than one person support apparatus, and wherein the seat MCM portion and the head MCM portion of the MCM layer are configured such that air continuously flows from the seat MCM portion across the head MCM portion toward a vent defined in a distal portion of the MCM layer.

An eighty third aspect A83 includes the person support surface as in the seventy fifth aspect A75 or the seventy sixth aspect A76, further comprising a top encasement portion, wherein a sleeve is defined on a surface of the top encasement portion and is positioned to correspond with at least one of a head section, a seat section, or a foot section of one or more than one person support apparatus, and wherein the sleeve is accessible to place a medical device under a subject positioned on the person support surface.

Additional features and advantages of the aspects described herein will be set forth in the detailed description which follows, and in part will be readily apparent to those skilled in the art from that description or recognized by practicing the aspects described herein, including the detailed description, which follows, the claims, as well as the appended drawings.

It is to be understood that both the foregoing general description and the following detailed description describe various aspects and are intended to provide an overview or framework for understanding the nature and character of the claimed subject matter. The accompanying drawings are included to provide a further understanding of the various aspects, and are incorporated into and constitute a part of this specification. The drawings illustrate the various aspects described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts an illustrative person support system that includes a person support apparatus with a person support surface positioned thereon, according to one or more aspects of the present disclosure;

FIG. 2 schematically depicts a block diagram of illustrative control modules associated with the person support surface of the person support apparatus of FIG. 1, according to one or more aspects of the present disclosure;

FIG. 3 schematically depicts a block diagram of an illustrative therapy or support surface control module associated with the person support surface of the person support apparatus of FIG. 1, according to one or more aspects of the present disclosure;

FIG. 4 depicts an exploded perspective view of various illustrative internal component combinations of the person support surface of FIG. 1, the person support surface positionable on a deck portion of a person support apparatus, according to one or more aspects of the present disclosure;

FIG. 5 depicts an exploded perspective view of an illustrative microclimate management (MCM) layer of FIG. 4, according to one or more aspects of the present disclosure;

FIG. 6 depicts a top plan view of the MCM layer of FIG. 5, according to one or more aspects of the present disclosure;

FIG. 7A depicts a cross-sectional view, along axis A-A of FIG. 4, of a first illustrative person support surface, according to one or more aspects of the present disclosure;

FIG. 7B depicts a cross-sectional view, along axis B-B of FIG. 7A, of the first person support surface, according to one or more aspects of the present disclosure;

FIG. 7C depicts a cross-sectional view, along axis B-B of FIG. 7A, of the first person support surface where a turn assist bladder of the subject head right side zone of the turn assist bladder layer is in an inflated state and a working cushion bladder of the subject head right side zone of the working cushion layer is in a hyper-inflated state, according to one or more aspects of the present disclosure;

FIG. 8A depicts a cross-sectional view, along axis A-A of FIG. 4, of a second illustrative person support surface, according to one or more aspects of the present disclosure;

FIG. 8B depicts a cross-sectional view, along axis C-C of FIG. 8A, of the second person support surface, according to one or more aspects of the present disclosure;

FIG. 8C depicts a cross-sectional view, along axis C-C of FIG. 8A, of the second person support surface where the turn assist bladder of the subject head right side zone of the turn assist bladder layer is in an inflated state, according to one or more aspects of the present disclosure;

FIG. 9A depicts a cross-sectional view, along axis A-A of FIG. 4, of a third illustrative person support surface, according to one or more aspects of the present disclosure;

FIG. 9B depicts a cross-sectional view, along axis D-D of FIG. 9A, of the third person support surface, according to one or more aspects of the present disclosure;

FIG. 9C depicts a cross-sectional view, along axis E-E of FIG. 9A, of the third person support surface, according to one or more aspects of the present disclosure;

FIG. 9D depicts a cross-sectional view, along axis F-F of FIG. 9A, of the third person support surface 904, according to one or more aspects of the present disclosure;

FIG. 10A depicts an illustrative blower subassembly, according to one or more aspects of the present disclosure;

FIG. 10B depicts a perspective view of a proximal portion of the surface foundation layer of FIG. 4, according to one or more aspects of the present disclosure;

FIG. 10C depicts another perspective view of the proximal portion of the surface foundation layer of FIG. 4, according to one or more aspects of the present disclosure;

FIG. 11A depicts a perspective view of an illustrative person support surface including a fluid inlet located on a bottom side of the person support surface and a fluid inlet located on a lateral side of the person support surface, according to one or more aspects of the present disclosure;

FIG. 11B depicts another perspective view of the illustrative person support surface of FIG. 11A, according to one or more aspects of the present disclosure;

FIG. 12A depicts a top plan view of the MCM layer of FIG. 5 that illustrates fluid flow paths into, through, and out of a person support surface, according to one or more aspects of the present disclosure;

FIG. 12B depicts a side view of the MCM layer of FIG. 12A that illustrates fluid flow paths into, through, and out of the person support surface, according to one or more aspects of the present disclosure;

FIG. 13A depicts an exploded perspective view of an illustrative foot bladder layer according to one or more embodiments shown and described herein;

FIG. 13B depicts a perspective view of another illustrative foot bladder layer with upper raft layers removed according to one or more embodiments shown and described herein; and

FIG. 13C depicts a perspective view of the illustrative foot bladder layer of FIG. 13B with an enclosure disposed over a lower raft layer according to one or more embodiments shown and described herein.

### DETAILED DESCRIPTION

According to various aspects, a person support system may include a person support surface and a person support apparatus. The person support surface of the present disclosure may include a stack of internal layers such as a surface foundation layer, a plurality of person support surface layers (e.g., a turn assist bladder layer, a working cushion layer, a support cushion layer, a percussion and vibration bladder, an advanced articulation bladder, and/or the like) positioned within the surface foundation layer, a foot bladder layer, and a microclimate management (MCM) layer. In particular, the MCM layer of the present disclosure may be fluidly coupled to an integrated MCM air source and may target cooling fluid across a seat portion of the person support surface to reduce the risk of subject pressure injuries. Such an MCM layer may help resist or mitigate skin tissue breakdown (e.g., by receiving and discharging a stream of air that acts as a heat sink to keep the subject's skin cool, thereby reducing the metabolic demands of the skin tissue and, as a result, reducing the likelihood of pressure injuries, by evaporating perspiration present at the interface between the person support surface and the subject's skin during the heat transfer from the subject's skin, thereby reducing moisture at the skin/surface interface and, as a result, reducing skin tissue breakdown). In addition, the MCM air source of the present disclosure may be positioned and/or routed within the person support surface to enable expanded fluoroscopy procedures. Yet further, the foot bladder layer of the present disclosure may define a gradual slope to reduce heel pressure and further reduce the risk of subject pressure injuries. Such aspects, the benefits thereof, and further combinable features of the person support surface are described more fully herein.

The person support apparatus may include a standard person support apparatus, an advanced articulation person support apparatus, and/or a chair egress person support apparatus (e.g., available from Hill-Rom Holdings, Inc. (Batesville, Ind.)). An advanced articulation person support apparatus may support progressive subject mobility stages including a breathe stage (e.g., maintaining optimal head-of-bed (HOB) angle per ventilator-acquired pneumonia (VAP) protocols, avoiding pulmonary complications via continuous lateral rotation therapy (CLRT), and improving respiratory efficiency via percussion and vibration (P&V) therapies, and/or the like), a tilt stage (e.g., maintaining optimal HOB angle per VAP protocols, providing orthostatic conditioning via an 18° reverse Trendelenburg-tilt table, and/or the like), and a sit stage (e.g., facilitating gas exchange via a partial chair position, allowing lung expansion via a chair egress position, preventing subject migration and minimizing repositioning via a stay-in-place system that responds to HOB angle, and/or the like). A chair egress person support apparatus may support progressive subject mobility stages including a stand stage (e.g., building subject strength via a chair egress positions, providing partial weight bearing via a sit-to-stand lift system, and/or the like) and a move stage (e.g., realizing out-of-bed orders via the chair egress positions and/or the sit-to-stand lift system, and/or the like). A standard person support apparatus may or may not support the above-described features and/or may include an add-on (e.g., a “topper” surface to resist or mitigate skin tissue breakdown).

In this vein, aspects of the present disclosure include person support surfaces that include a combination of components that realize a plurality of features and functionalities such that the person support surfaces are interchangeably usable on and/or compatible with such person support apparatuses (e.g., the standard person support apparatus, the advanced articulation person support apparatus, the chair egress person support apparatus, and/or the like). Accordingly, each person support surface may allow more than one different person support apparatuse to support a wide range of therapies (i.e., CLRT, P&V, CLP, ALP and/or the like) while improving additional therapies including microclimate management (MCM). Each person support surface, as described herein, may be configured for use in an intensive care unit (ICU) facility, environment, and/or platform. Each person support surface, as described herein, may further include varying widths (e.g., from about 36 inches (91.44 cm) wide to about 40 inches (101.6 cm) wide.

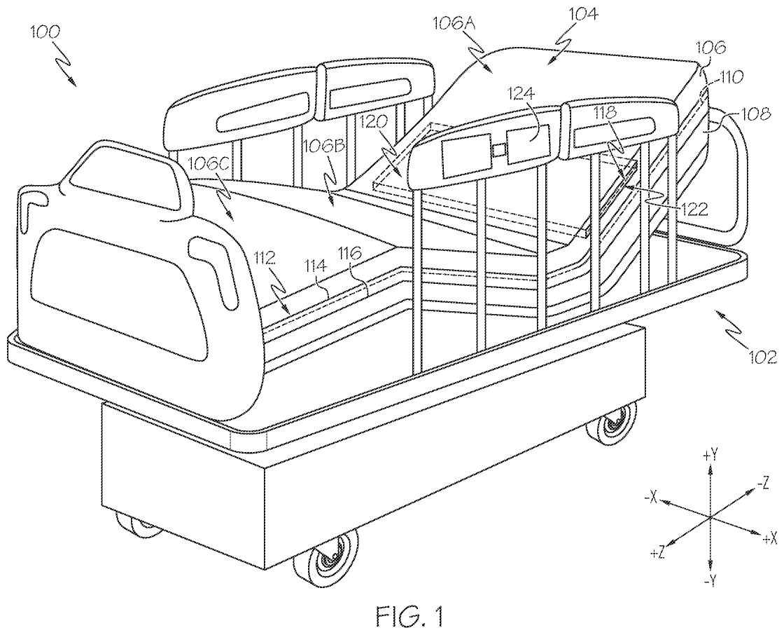

Turning now to the drawings, FIG. 1 depicts an illustrative person support system 100 that includes a person support apparatus 102 with a person support surface 104 positioned thereon, according to various aspects described herein. In view of FIG. 1, the person support surface 104 may include a top encasement portion 106 coupled to a bottom encasement portion 108. The coupled top encasement portion 106 and bottom encasement portion 108 define an internal cavity to house the various internal components as described herein. The person support surface 104 may define a head section 106A, a seat section 106B, and a foot section 106C. In some aspects, the top encasement portion 106 may be securely coupled to the bottom encasement portion 108 via an interlocking device 110 that extends around a perimeter of the person support surface 104. In such aspects, a first portion of the interlocking device 110 may be attached to the top encasement portion 106 and a second portion of the interlocking device 110 may be attached to the bottom encasement portion 108. One of the first portion or the second portion of the interlocking device 110 may include an interlocking device actuator (e.g., zipper pull tab, slider, or the like). In other aspects, the interlocking device 110 may extend around a portion of the perimeter of the person support surface 104. The interlocking device 110 may be a zipper and/or the like in some aspects, or may be a permanent coupling (e.g., a thermoplastic weld). According to various aspects, the top encasement portion 106 and the bottom encasement portion 108 may be defined by a fluid-resistant and/or fluid-proof material. In some aspects the top encasement portion 106 and/or the bottom encasement portion 108 may be defined by a two-ply fabric. Referring to FIG. 1, all seams (e.g., corners, edges, and/or the like) of the top encasement portion 106 and the bottom encasement portion 108 may be welded (e.g., thermoplastic welded) together or taped in lieu of being sewn (e.g., to avoid fluid access holes/points). Furthermore, in view of FIG. 1, the person support surface 104 may include a fluid-resistant interlocking device 110. In particular, the top encasement portion 106 may include fluid flap 112 having a first edge 114 permanently coupled adjacent the interlocking device 110 and a second edge 116 that extends over and/or beyond the interlocking device 110. Accordingly, any fluids flowing on and/or over the top encasement portion 106 will not permeate the top encasement portion 106 and will flow off the person support surface 104 via the fluid flap 112 without interfacing with the interlocking device 110. According to various aspects, the person support surface 104 is fluid-resistant and/or fluid-proof for cleansing and/or disinfection purposes (e.g., so that no contaminants can get to the inside of person support surface 104). According to various aspects, the top encasement portion 106 and/or the bottom encasement portion 108 may be removable and/or replaceable. Accordingly, if the top encasement portion 106 and/or the bottom encasement portion 108 is in need of replacement (e.g., every “Y” years of use, due to a puncture, damage, due to exposure to infectious agents, bodily fluids, or the like) it can be removed by disengaging (e.g., unzipping) the first portion of the interlocking device 110 from the second portion of the interlocking device 110 such that a replacement top encasement portion 106 and/or a replacement bottom encasement portion 108 may be installed by engaging (e.g., zipping) its respective first portion and/or second portion of the interlocking device 110 to the remaining/new second portion and/or first portion of the interlocking device 110, respectively.

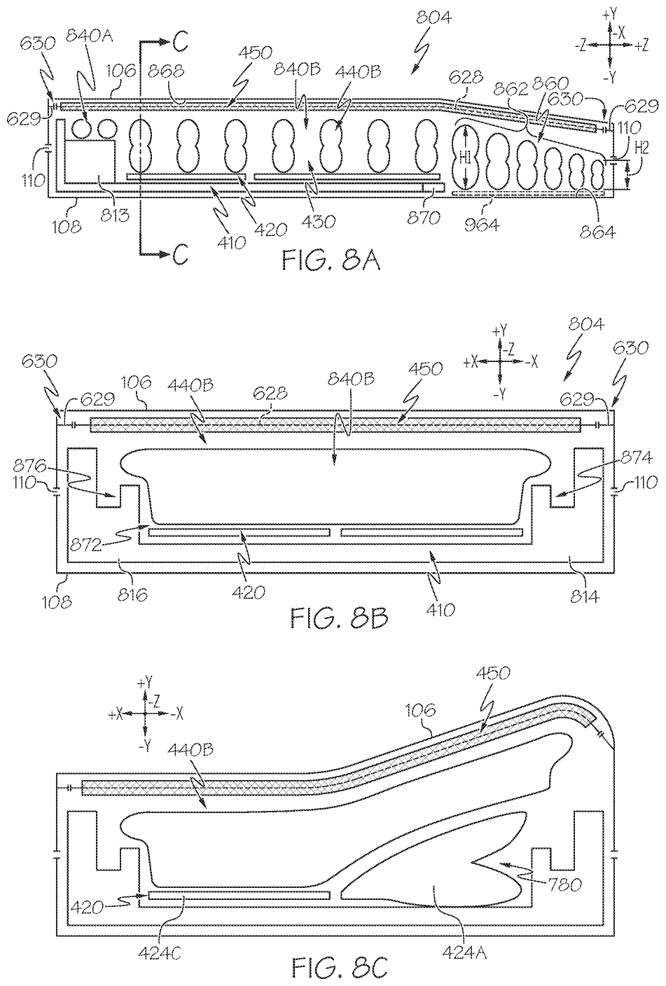

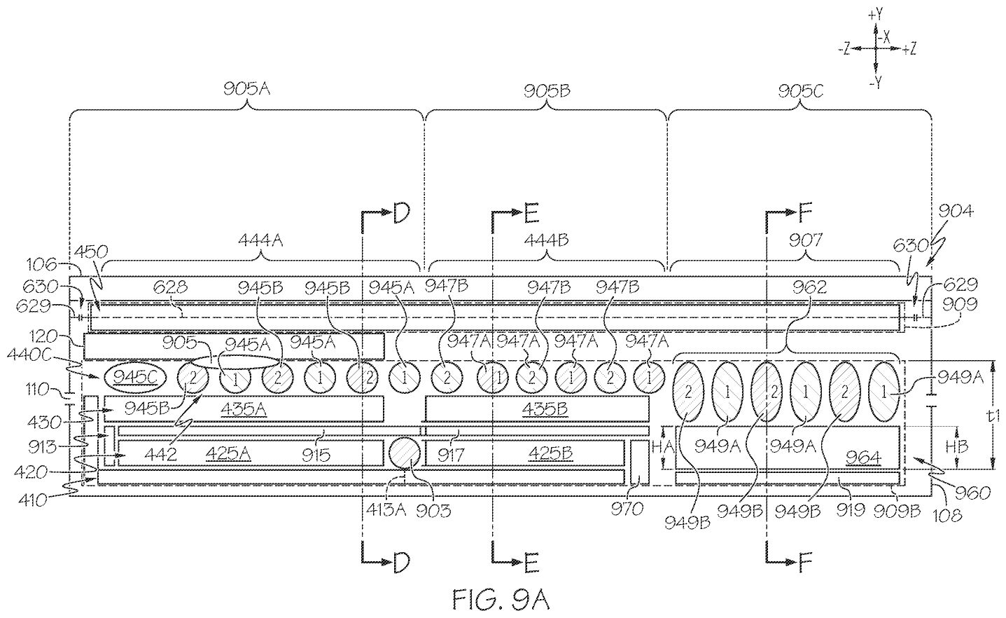

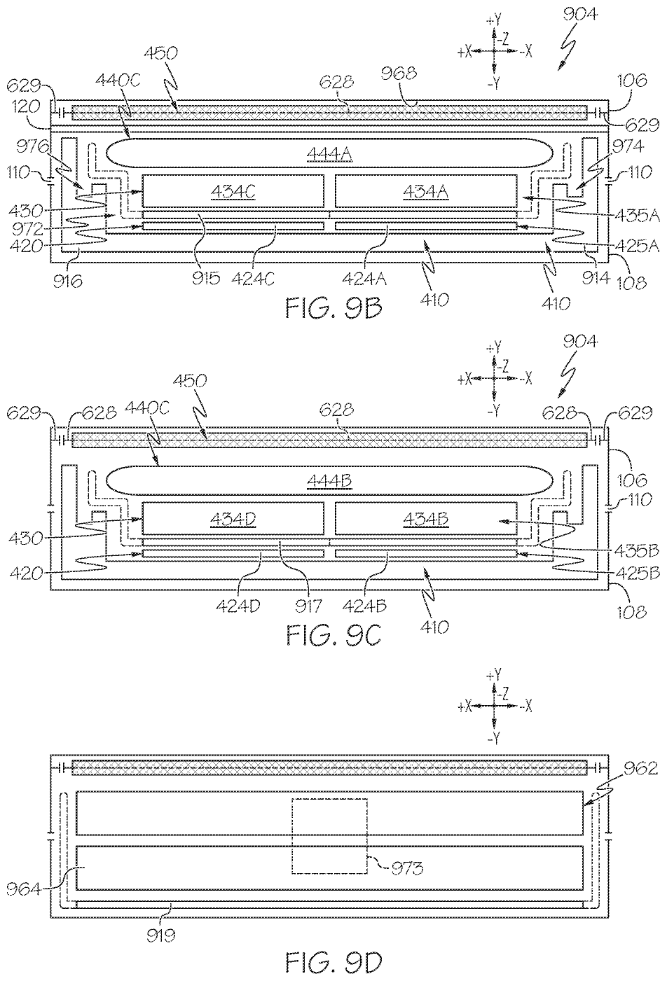

Referring still to FIG. 1, the top encasement portion 106 may further include a sleeve interlocking device 118 (e.g., a zipper and/or the like) to access a sleeve 120 (e.g., an X-ray sleeve) coupled to the top encasement portion 106. In various aspects, the sleeve 120 may be defined on a bottom surface and/or an internal surface of the top encasement portion 106. In one aspect, a perimeter of a top surface of the sleeve 120 may be coupled (e.g., thermoplastic welded) to the bottom surface of the top encasement portion 106. In another aspect, a perimeter of a first side (e.g., in the −X direction of the coordinate axes of FIG. 1) and/or a perimeter of a second side (e.g., in the +X direction of the coordinate axes of FIG. 1) of the sleeve 120 may be coupled (e.g., thermoplastic welded) to a first internal side (e.g., in the −X direction of the coordinate axes of FIG. 1) and/or a second internal side (e.g., in the +X direction of the coordinate axes of FIG. 1) of the top encasement portion 106, respectively. In such an aspect, an aperture may be defined between the top surface of the sleeve 120 and the bottom surface of the top encasement portion 106. In some aspects, as described herein, an MCM layer 450 may be insertable through the aperture (e.g., FIG. 9A, MCM layer 450 positioned above the sleeve 120) prior to being coupled to the top encasement portion 106. In such aspects, the top encasement portion 106 may further include a first portion 629 (e.g., FIGS. 8A & 9A) of an MCM interlocking device 630 (FIGS. 8A, 9A, e.g., zipper) attached to an internal surface (e.g., internal bottom surface, internal side surface, or the like) of the top encasement portion 106 and the MCM layer 450 may include a second portion 628 (e.g., FIGS. 6, 8A & 9A) of the MCM interlocking device 630 (FIGS. 8A, 9A) to couple a top surface of the MCM layer 450 with the bottom internal surface of the top encasement portion 106 (e.g., FIG. 9A). Further in such aspects, the inserted MCM layer 450 may provide comfort to a subject while a medical procedure is being performed using the sleeve 120. In view of FIG. 1, the sleeve interlocking device 118 may be opened to insert, slide and/or place a medical device and/or medical equipment (e.g., X-ray cassette, or the like) under a subject positioned on the person support surface 104. As depicted in FIG. 1, the sleeve 120 may extend across a width of the person support surface 104 to maximize an area of the person support surface 104 on which the subject can be positioned to lie while a medical procedure (e.g., X-ray) is performed. The sleeve 120 permits the medical device, medical equipment, or the like, to be utilized through a portion of the person support surface 104 without exposure to any internal components (e.g., as described herein) of the person support surface 104. For example, in aspects where the first side and second side of the sleeve are coupled (e.g., thermoplastic welded) to the first internal side and the second internal side of the top encasement portion 106, respectively, the medical device, medical equipment, or the like, may be inserted and/or removed through a first interlocking device (e.g., sleeve interlocking device 118) on the second side (e.g., in the +X direction of the coordinate axes of FIG. 1) and/or a second interlocking device on the second side (e.g., in the −X direction of the coordinate axes of FIG. 1, not shown) without ever being exposed to any internal components of the person support surface 104 (e.g., sleeve 120 defines an opening through which medical devices, medical equipment, or the like, can pass). Furthermore, after use of the medical device, medical equipment, or the like, the internal surfaces of the sleeve 120 may be cleaned and/or disinfected without exposing any internal components of the person support surface 104. Accordingly, the person support surface 104 may be fluid-resistant and/or fluid-proof for cleansing and/or disinfection purposes (e.g., such that no contaminants can get to the inside of the person support surface 104). Overall, the sleeve 120, as depicted in FIG. 1, may further avoid and/or minimize subject moves (e.g., less risk to the subject and/or caregiver injury) as well as minimize interference and/or blockage within an image (e.g., an X-ray image) due to various components, as described herein, internal to the person support surface 104. The top encasement portion 106 may further include a sleeve fluid flap 122 having a first edge permanently coupled adjacent the sleeve interlocking device 118 and a second edge that extends over and/or beyond the sleeve interlocking device 118. Accordingly, any fluids flowing on and/or over the top encasement portion 106 will not permeate the top encasement portion 106 and will flow off the person support surface 104 via the sleeve fluid flap 122 without interfacing with the sleeve interlocking device 118. In light of FIG. 1, the sleeve 120 may be positioned to correspond with the head section 106A of the person support surface 104. According to other aspects, the sleeve 120 may be similarly positioned to correspond with the seat section 106B and/or the foot section 106C of the person support surface 104. In yet further aspects, the sleeve 120 may extend across any width and/or any length of the person support surface 104. In some aspects, the sleeve interlocking device 118 may include two interlocking device actuators (e.g., zipper pull tabs/sliders) to open access to the sleeve 120 at a desired position and to minimize exposure of internal surfaces of the sleeve 120. In some aspects, the sleeve interlocking device 118 and/or its corresponding sleeve fluid flap 122, as described herein, may be positioned on the first lateral side (e.g., in the −X direction of the coordinate axes of FIG. 1), the second lateral side (e.g., in the +X direction of the coordinate axes of FIG. 1), the distal side (e.g., in the −Z direction of the coordinate axes of FIG. 1) and/or the proximal side (e.g., in the +Z direction of the coordinate axes of FIG. 1) of the person support surface 104 (e.g., to access the sleeve 120 from any side of the person support surface 104). According to yet further aspects, the sleeve 120 may be defined on a top surface (e.g., in the +Y direction of the coordinate axes of FIG. 1) of the top encasement portion 106. In such aspects, a material that defines the sleeve 120 may be coated such that the sleeve 120 is fluid-resistant and/or fluid-proof.

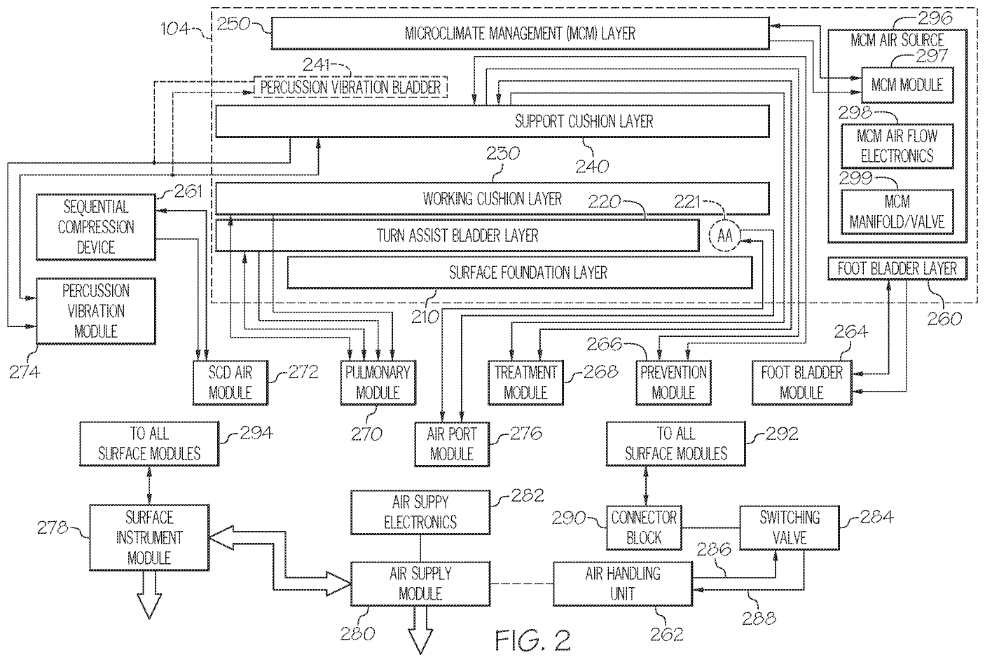

FIG. 2 schematically depicts a block diagram of illustrative control modules associated with the person support surface 104 of a person support apparatus 102 of FIG. 1, according to various aspects described herein. Referring to FIG. 2, the person support surface 104 of the present disclosure permits several support layers and therapy devices to be driven by at least one external fluid (e.g., air) source and a microclimate management layer to be driven by a fluid (e.g., air) source integrated within the person support surface 104. In view of FIG. 2, the person support surface 104, as described herein, may include a surface foundation layer 210, a turn assist bladder layer 220, a working cushion layer 230, a support cushion layer 240, a MCM layer 250 and/or a foot bladder layer 260. In some aspects, the person support surface 104 may further comprise one or more than one percussion vibration bladder 241 and/or an advanced articulation (AA) bladder 221 (each depicted in phantom as optional). A sequential compression device 261 for venous compression therapy of a subject is also provided.

A plurality of separate treatment/therapy and surface control modules are provided for interconnecting the various treatment/therapy devices and surface layers to a communication network associated with the person support apparatus 102 (FIG. 1) and its on-board air handling unit 262. In particular, aspects of the present disclosure include a foot bladder control module 264, a decubitus prevention control module 266, and a decubitus treatment control module 268. Further modules include a pulmonary rotation control module 270, a sequential compression device air control module 272, and a pulmonary percussion and vibration control module 274. An auxiliary air-port control module 276 is also provided. The air-port control module 276 may provide for an auxiliary air output for manual filling of auxiliary bladder systems for positioning, safety barriers, clinical treatments such as burn contractures, and other purposes. In some aspects, the air-port control module 276 may provide for auxiliary air output to the advanced articulation (AA) bladder 221. Referring to FIG. 2, it should be understood that each of the control modules may be included or positioned within the envelope of the person support surface 104 depicted in FIG. 2 (e.g., pneumatic aspects within first enclosures 711, 811, 911 (e.g., pneumatic air control boxes), electrical aspects within second enclosures 713, 813, 913 (e.g., electrical air control boxes), pneumatic and/or electrical aspects within optional enclosures 473, 973, or the like, as described herein).

Each of the modules is designed to physically and functionally connect the various bladders and treatment devices to both the communication network of the person support apparatus 102 through a surface instrument module 278 and to the air handling unit 262 which may be controlled by an air supply module 280. The air supply module 280 may be coupled to the communication network (e.g., peer-to-peer). Air supply electronics 282 may be connected to the air supply module 280 for controlling the air handling unit 262 and switching valve 284 based on network commands for controlling the various surface and treatment modules illustrated in FIG. 2.

The air handling unit 262 may supply air under pressure to the switching valve 284 on supply tube 286. The air handling unit 262 may also apply a vacuum to the switching valve 284 through supply tube 288. An output of the switching valve 284 is coupled to a connector block 290. The connector block 290 may provide an air and a vacuum supply tube (not shown) to each of the surface control and treatment control modules as illustrated in block 292 of FIG. 2. It should be understood that dual control lines for both air and vacuum may be supplied to each of the surface control and treatment control modules of FIG. 2. Such a dual control may allow each module to apply pressure and vacuum simultaneously to different zones of a bladder or treatment device.

The surface instrument module 278, which is also coupled to the communication network, is electrically coupled to each of the surface control modules and treatment control modules as illustrated in block 294 of FIG. 2. This network connection may permit all the modules to receive input commands from other network modules and/or to output information to other network modules via the communication network.

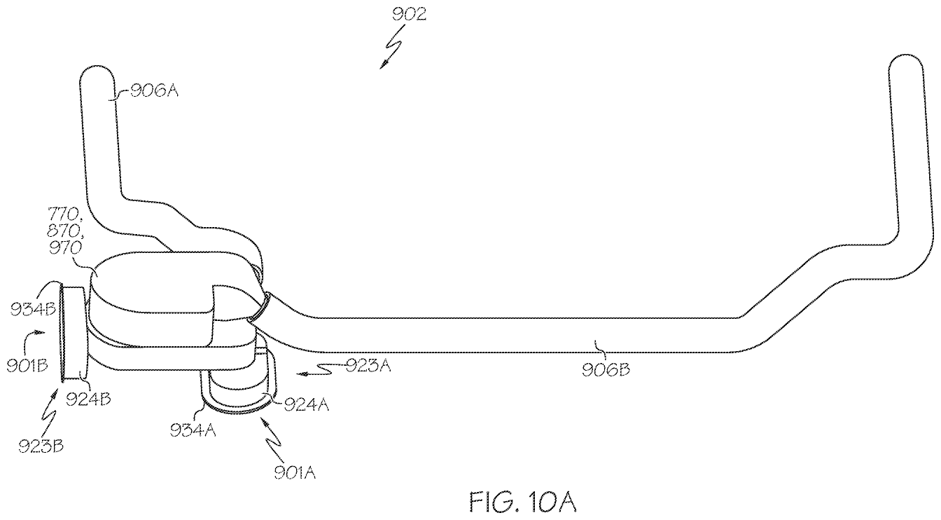

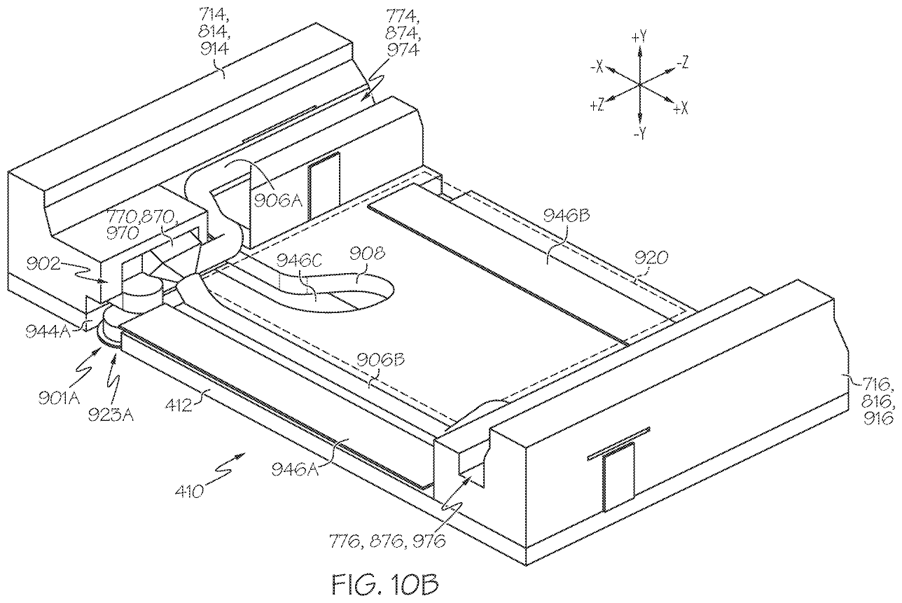

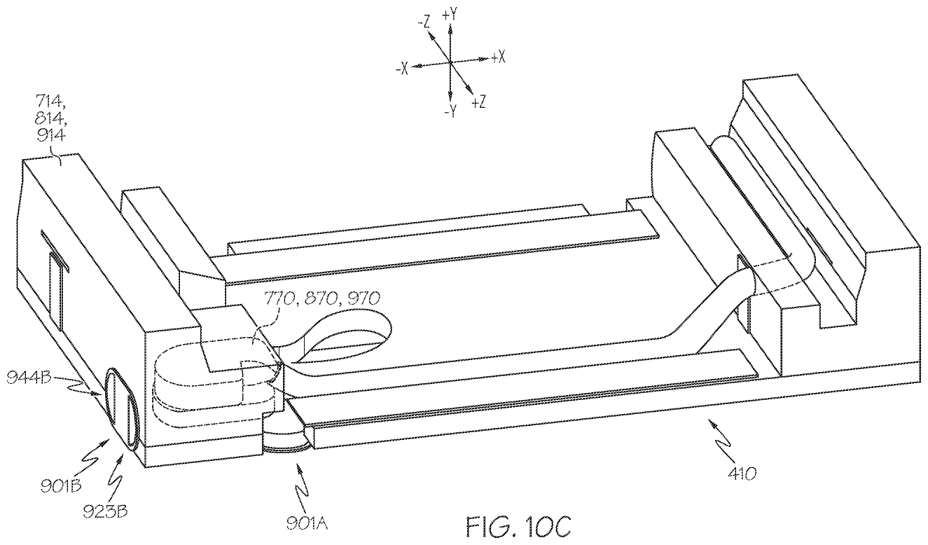

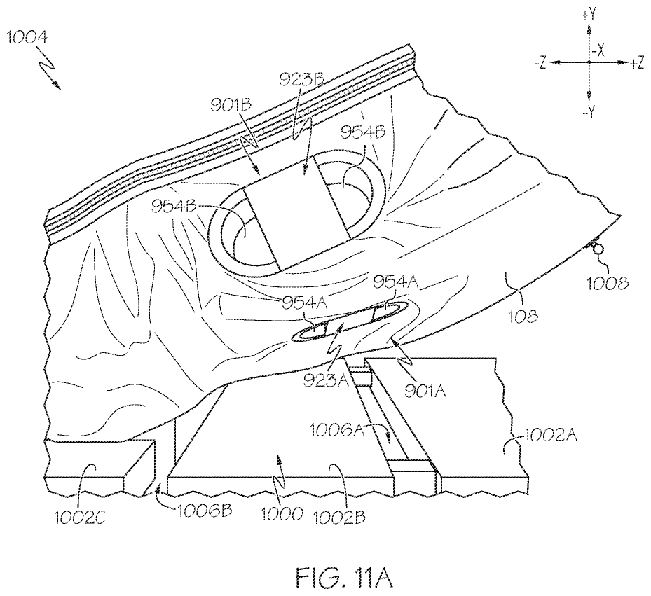

Referring still to FIG. 2, the person support surface 104 of the present disclosure may include an integrated MCM air source 296 (e.g., FIG. 10A, blower subassembly 902). According to various aspects, the integrated MCM air source 296 may include an MCM control module 297, MCM air flow electronics 298, and/or an MCM air manifold and/or valve 299 to control the air flow rate and/or pressure through the MCM layer 250 in a manner similar to the other control modules (e.g., control modules 264-276) as described herein. As an air source integrated within the person support surface 104, the MCM air source 296 may target high-flow, low-pressure air to desired portions (e.g., MCM layer 250) of the person support surface 104 without relying on and/or drawing from an external air source (e.g., air source associated with a person support apparatus 102). According to aspects described herein, an external air source may include a blower (not shown, e.g., usable for percussion and vibration therapies) coupled to a frame of the person support apparatus 102 and/or a pump (not shown, e.g., usable for subject support, turn-assist and CLRT functionalities as described herein) coupled to the frame of the person support apparatus 102. Accordingly, the integrated MCM air source 296 of the present disclosure further enables interchangeability between multiple person support apparatuses without requiring customization for each person support apparatus. Furthermore, the integrated MCM air source 296 of the present disclosure reduces and/or eliminates deficiencies introduced by an external air source. According to various aspects, the integrated MCM air source 296 provides an air source dedicated to MCM. In particular, the MCM control module 297 of the present disclosure may optimize flow rate at a desired interface pressure to realize maximum skin cooling. This is an improvement over a person support surface that taps into an external air source taxed with supplying air for other functionalities (e.g., P&V, turn assist, CLRT, ALP, CLP, or the like as described herein).

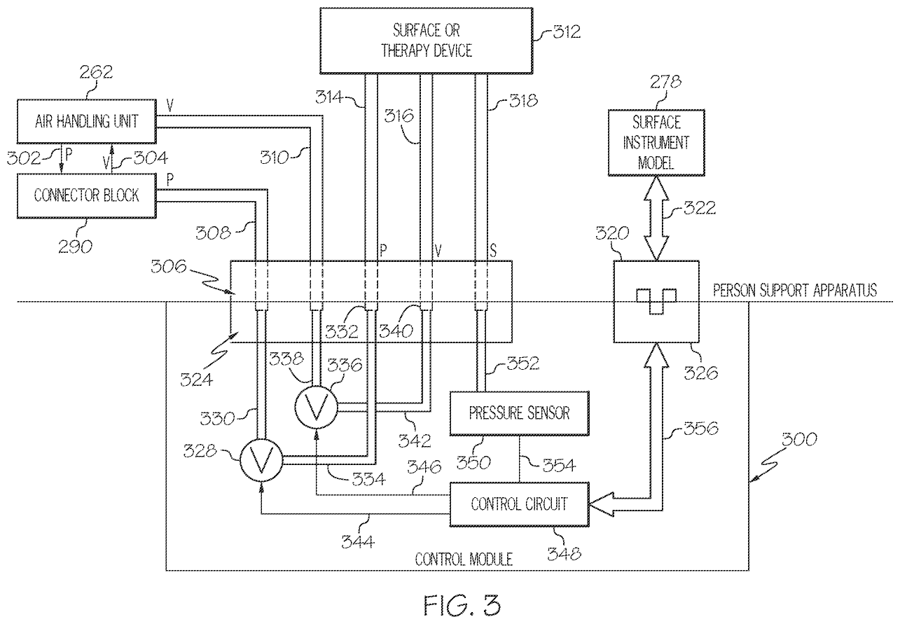

FIG. 3 schematically depicts a block diagram of an illustrative therapy or support surface control module 300 associated with the person support surface 104 of a person support apparatus 102 of FIG. 1, according to various aspects described herein. It should be understood that the details of the foot bladder control module 264, the decubitus prevention control module 266, the decubitus treatment control module 268, the pulmonary rotation control module 270, the SCD air control module 272, the pulmonary percussion and vibration control module 274, the air-port control module 276, and/or the MCM module 297 may include the same and/or similar structural components as the therapy or support surface control module 300 illustrated in FIG. 3.

Referring to FIG. 3, the air handling unit 262 may be coupled directly to the connector block 290 by both an air pressure supply tube 302 and a vacuum supply tube 304. In some aspects, as discussed herein, tubes 302 and 304 from the air handling unit 262 may be coupled to a switching valve 284 and only a single pressure/vacuum tube may be coupled to the connector block 290 as illustrated in FIG. 2.

Referring still to FIG. 3, the connector block 290 may be coupled to a module connector 306 located on the person support apparatus 102 (FIG. 1). In particular, the connector block 290 may be coupled to the module connector 306 by a pressure supply tube 308 and a vacuum supply tube 310. It should be understood that, in some aspects, a single supply line for both pressure and vacuum could also be used.

The module connector 306 may also be coupled to one of the surface or therapy devices 312 by a pressure supply tube 314, a vacuum supply tube 316, and/or a sensor supply tube 318. Depending upon the particular surface or therapy device, more than one pressure, vacuum, and/or sensor tubes may be connected between the module connector 306 and the surface or therapy device 312. For example, each separate air zone of the surface or therapy device may have its own pressure, vacuum, and/or sensor tubes. For illustration purposes, however, only a single set of supply tubes will be discussed.

The person support apparatus 102 may also include an electrical connector 320 coupled to the surface instrument module 278 of the communication network of the person support apparatus 102 by suitable cable 322. The therapy or support surface control module 300 illustrated in FIG. 3 may be designed to facilitate a coupling of the therapy or support surface control module 300 to the person support apparatus 102. Each of the surface and treatment options illustrated in FIG. 2 may be provided in the person support apparatus 102 with a pneumatic connector such as module connector 306 and a connector such as electrical connector 320 provided for each of the surface and therapy devices. The therapy or support surface control module 300 may be easily installed by coupling module connector 306 on the person support apparatus 102 to a mating connector 324 of the therapy or support surface control module 300. In addition, a mating electrical connector 326 may be provided on the therapy or support surface control module 300 for coupling to electrical connector 320 on the person support apparatus 102 (FIG. 1). The configuration of the therapy or support surface control module 300 may permit a simple “slide in” connection to be used to install the therapy or support surface control module 300 and activate the surface of therapy device 312.

An air pressure input from pneumatic mating connector 324 may be coupled to an electrically controlled valve 328 by line 330. An output of the valve 328 may be coupled to a pressure output port 332 by line 334. Pressure output port 332 may be coupled to the surface or therapy device 312 by the pressure supply tube 314.

The vacuum supply tube 310 from the connector block 290 may be coupled to an electrically controlled valve 336 by line 338 of the therapy or support surface control module 300. An output of valve 336 may be coupled to a vacuum port 340 of mating connector 324 by line 342. The vacuum port 340 may be coupled to the surface or therapy device 312 by the vacuum supply tube 316. The electrically controlled valves 328 and 336 may be controlled by output signals on lines 344 and 346, respectively, from a control circuit 348 of the therapy or support surface control module 300. The control circuit 348 may include a microprocessor or other controller for selectively opening and closing the valves 328 and 336 to control the surface or therapy device 312.

It should be understood that several valves may be used for each surface or treatment device. For instance, the support cushion layer 240 may have a plurality of different air zones which are independently controlled. In this instance, separate pressure, vacuum and/or sensor lines may be coupled to each zone. A electrically controlled valve may be provided for each pressure and/or vacuum line in each zone to provide independent controls for each zone.

The therapy or support surface control module 300 may also include a pressure sensor 350 (e.g., a pressure transducer). The pressure sensor 350 may be coupled to sensor supply tube 318 by line 352. The pressure sensor 350 may generate an output signal indicative of the pressure in the particular zone of the surface or therapy device 312. This output signal from the pressure sensor 350 may be coupled to the control circuit 348 by line 354.

The control circuit 348 may also be coupled to the electrical connector 326 by a suitable connection 356 to couple the control circuit 348 of the therapy or support surface control module 300 to the surface instrument module 278. Therefore, the control circuit 348 may receive instructions from the other modules coupled to the communications network. The control circuit 348 may also output information related to the particular surface or therapy device 312 to the communications network. Specifically, a graphical interactive display (FIG. 1, user interface 124) may be coupled to the communication network for transmitting command signals for the plurality of air therapy devices over the communication network to control operation of the plurality of air therapy devices. The graphical interactive display may include a display for a user (e.g., subject, caregiver, or the like) input. Each control module (FIG. 2) may transmit display commands to the display related to the corresponding air therapy device. The display commands from each control module may provide a menu driven list of options to the display to permit user selection/input of control options for the plurality of air therapy devices.

A plurality of person support surfaces including a plurality of combinations and subcombinations of internal components and/or functionalities are described herein. At the outset, is should be understood that the present disclosure should not be limited to any particularly described person support surface and/or any combination or subcombination of internal components and/or functionalities. Accordingly, it is envisioned that a person support surface of the present disclosure may include all, less than all, or any subset of, the internal components and/or functionalities described herein.

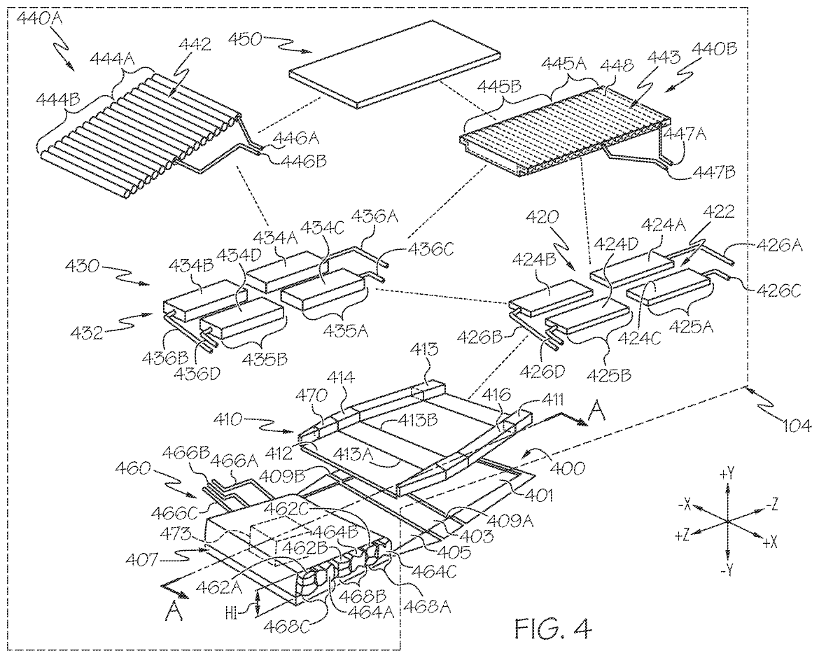

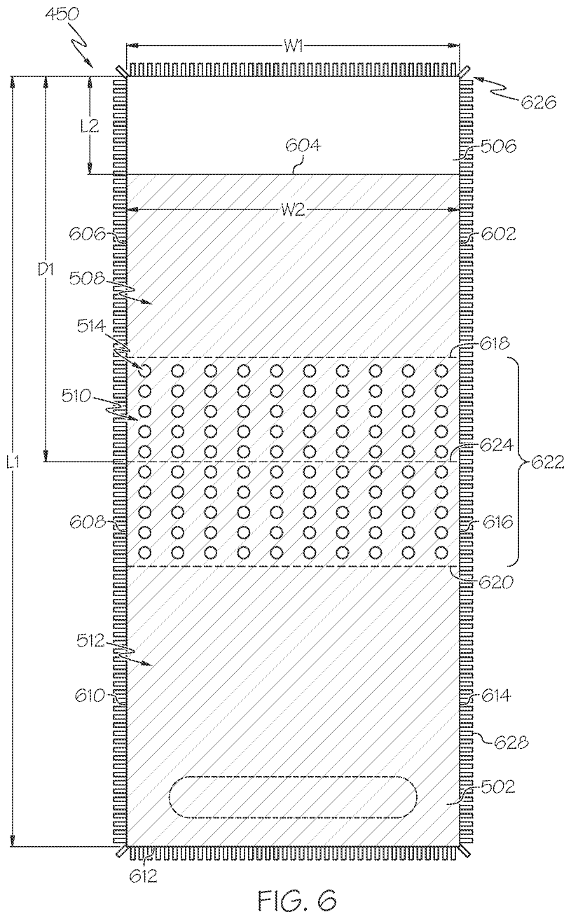

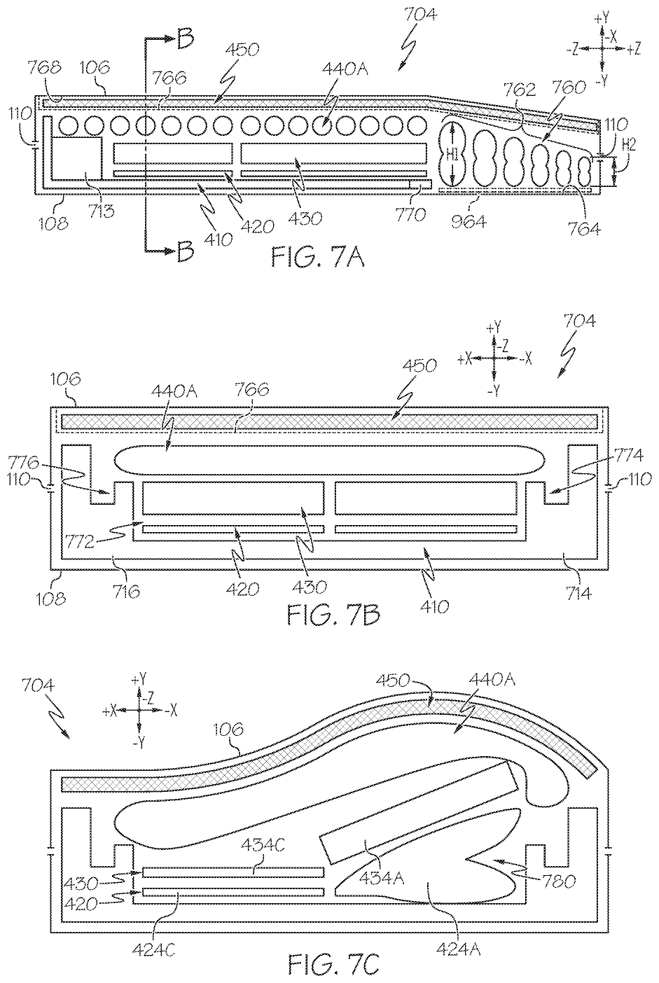

FIG. 4 depicts an exploded perspective view of various illustrative internal component combinations of the person support surface 104 of FIG. 1, the person support surface 104 positionable on a deck portion 400 of a person support apparatus 102 (e.g., an advanced articulation person support apparatus), according to various aspects described herein. Referring to FIG. 4, various internal components of the person support surface 104 (e.g., generally enclosed by the dashed line depicted in FIG. 4) may include a surface foundation layer 410, a turn assist bladder layer 420, a working cushion layer 430, a support cushion layer 440A, 440B, a microclimate management (MCM) layer 450, and/or a foot bladder layer 460. In one aspect, in view of FIG. 4, the person support surface 104 may include the surface foundation layer 410, the turn assist bladder layer 420, the support cushion layer 440B, the microclimate management (MCM) layer 450, and the foot bladder layer 460 (see also e.g., FIGS. 8A-8C). In another aspect, in view of FIG. 4, person support surface 104 may include the surface foundation layer 410, the turn assist bladder layer 420, the working cushion layer 430, the support cushion layer 440A, the microclimate management (MCM) layer 450, and the foot bladder layer 460 (see also, e.g., FIGS. 7A-7C). In such aspects, each of the components may be “internal” with respect to the top encasement portion 106 and the bottom encasement portion 108, as described herein. That is, the components may be contained within the cavity defined by joining the top encasement portion 106 and the bottom encasement portion with the interlocking device 110 (FIG. 1) as described herein.

The deck portion 400 of FIG. 4 may include a head section 401, a seat section 403, a thigh section 405, and/or a foot section 407. Since the deck portion 400, as illustrated in FIG. 4, is associated with an advanced articulation person support apparatus, the head section 401, the seat section 403, the thigh section 405, and/or the foot section 407 are articulatable relative to one another.

The surface foundation layer 410 of FIG. 4 may include a foundation base 412 (e.g., foam such as thigh foam), a subject right side bolster 414 (e.g., a first lateral side bolster, in the −X direction of the coordinate axes of FIG. 4), and a subject left side bolster 416 (e.g., a second lateral side bolster, in the +X direction of the coordinate axes of FIG. 4). The surface foundation layer 410 may extend longitudinally between a proximal end (e.g., in the +Z direction of the coordinate axes of FIG. 4) and a distal end (e.g., in the −Z direction of the coordinate axes of FIG. 4) along axes A-A as depicted in FIG. 4. The foundation base 412 may include one or more than one separable section 413A, 413B that corresponds to a gap(s) between adjacent sections of the deck portion 400 (e.g., gap 409A between the head section 401 and the seat section 403, gap 409B between the seat section 403 and the thigh section 405, and/or the like). In light of FIG. 4, the surface foundation layer 410 may extend between a distal end (e.g., in the −Z direction of the coordinate axes depicted in FIG. 4) of the head section 401 and a proximal end (e.g., in the +Z direction of the coordinate axes depicted in FIG. 4) of the thigh section 405. According to various aspects, the surface foundation layer 410 may be alternatively referred to herein as a crib (e.g., if made of foam, a foam crib, and/or the like) since it may restrain and/or provide structure to support various internal components of the person support surface 104 as described herein. According to various aspects, a first enclosure 411, a second enclosure 413, and a third enclosure 470 may be defined in the surface foundation layer 410. Such enclosures may house various air supply components (e.g., air valves, air manifolds, air control boards, blowers, and/or the like) as described herein.

The turn assist bladder layer 420, as depicted in FIG. 4, may be positionable above (e.g., in the +Y direction of the coordinate axes of FIG. 4) the foundation base 412 of the surface foundation layer 410 and may be locatable between the subject right side bolster 414 and the subject left side bolster 416 of the surface foundation layer 410 (e.g., to restrain lateral movement and/or lateral expansion of the turn assist bladder layer 420). In some aspects, the turn assist bladder layer 420 may include a plurality of turn bladders 422 (e.g., collar turn bladders, or the like) oriented parallel to a plane (e.g., a Y-Z plane of the coordinate axes of FIG. 4) defined through the longitudinal axis A-A, as depicted in FIG. 4. In some aspects, each of the plurality of turn bladders 422 may be defined by a polyurethane coated impermeable heavy-duty fabric. According to various aspects, each of the plurality of turn bladders 422 may minimize volume given an inflated height thereof (e.g., FIGS. 7C and 8C, e.g., bladder dimple 780), and are controllable via high-flow valves to increase and/or improve turn angle and to reduce inflation and/or deflation time. As depicted in FIG. 4, the turn assist bladder layer 420 may include a head section turn bladder zone 425A and a seat section turn bladder zone 425B. The head section turn bladder zone 425A may include a subject head right side zone 424A and a subject head left side zone 424C. Similarly, the seat section turn bladder zone 425B may include a subject seat right side zone 424B and a subject seat left side zone 424D. In view of FIG. 4, the subject head right side zone 424A and the subject seat right side zone 424B, positioned on a first lateral side (e.g., in the −X direction of the coordinate axes of FIG. 4) of the plane (e.g., the Y-Z plane), may turn and/or roll the subject toward and/or on the subject's left side. Similarly, the subject head left side zone 424C and the subject seat left side zone 424D, positioned on a second lateral side (e.g., in the +X direction of the coordinate axes of FIG. 4) of the plane (e.g., the Y-Z plane), may turn and/or roll the subject toward and/or on the subject's right side. In some aspects, each of the subject head right side zone 424A, the subject seat right side zone 424B, the subject head left side zone 424C, and the subject seat left side zone 424D may include a single turn bladder. According to other aspects, each of the subject head right side zone 424A, the subject seat right side zone 424B, the subject head left side zone 424C, and the subject seat left side zone 424D may include more than one turn bladder. Each of the subject head right side zone 424A, the subject seat right side zone 424B, the subject head left side zone 424C, and the subject seat left side zone 424D may be controlled (e.g., inflated and/or deflated) independently (e.g., via supply tubes 426A, 426B, 426C, 426D, and/or the like, respectively). In a similar manner, according to other aspects, each turn bladder of the subject head right side zone 424A, the subject seat right side zone 424B, the subject head left side zone 424C, and the subject seat left side zone 424D may be controlled (e.g., inflated and/or deflated) independently (e.g., via independent supply tubes, not shown). According to various aspects, to turn and/or roll the subject toward and/or on the subject's left side, a control module (FIG. 2, pulmonary rotation control module 270) may cause the subject head right side zone 424A and the subject seat right side zone 424B to inflate. Similarly, to turn and/or roll the subject toward and/or on the subject's right side, the control module may cause the subject head left side zone 424C and the subject seat left side zone 424D to inflate.

The working cushion layer 430 of FIG. 4 may be positionable above (e.g., in the +Y direction of the coordinate axes of FIG. 4) the turn assist bladder layer 420 and may be locatable between the subject right side bolster 414 and the subject left side bolster 416 of the surface foundation layer 410 (e.g., to restrain lateral movement and/or lateral expansion of the working cushion layer 430). In some aspects, the working cushion layer 430 may include a plurality of working cushion bladders 432 oriented parallel to a plane (e.g., a Y-Z plane of the coordinate axes of FIG. 4) defined through the longitudinal axis A-A, as depicted in FIG. 4. In some aspects, each of the plurality of working cushion bladders 432 may be defined by a polyurethane coated impermeable heavy-duty fabric. As depicted in FIG. 4, the working cushion layer 430 may include a head section working cushion zone 435A and a seat section working cushion zone 435B. The head section working cushion zone 435A may include a subject head right side zone 434A and a subject head left side zone 434C. Similarly, the seat section working cushion zone 435B may include a subject seat right side zone 434B and a subject seat left side zone 434D. In view of FIG. 4, the subject head right side zone 434A and the subject seat right side zone 434B, positioned on a first lateral side (e.g., in the −X direction of the coordinate axes of FIG. 4) of the plane (e.g., the Y-Z plane), may assist to turn and/or roll the subject toward and/or on the subject's left side. Similarly, the subject head left side zone 434C and the subject seat left side zone 434D, positioned on a second lateral side (e.g., in the +X direction of the coordinate axes of FIG. 4) of the plane (e.g., the Y-Z plane), may assist to turn and/or roll the subject toward and/or on the subject's right side. In some aspects, each of the subject head right side zone 434A, the subject seat right side zone 434B, the subject head left side zone 434C, and the subject seat left side zone 434D may include a single working cushion bladder.

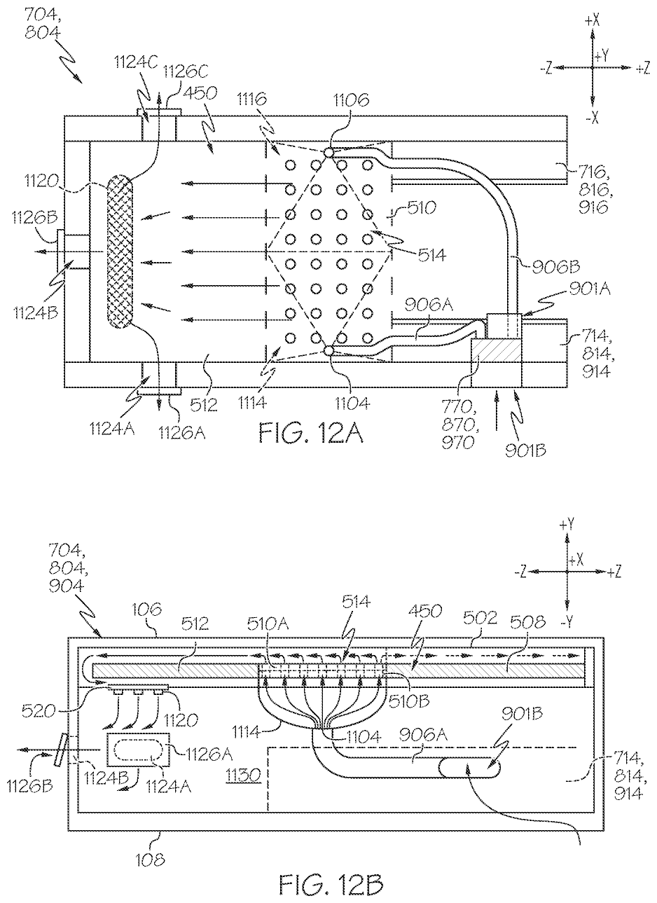

According to other aspects, each of the subject head right side zone 434A, the subject seat right side zone 434B, the subject head left side zone 434C, and the subject seat left side zone 434D may include more than one working cushion bladder. Each of the subject head right side zone 434A, the subject seat right side zone 434B, the subject head left side zone 434C, and the subject seat left side zone 434D may be controlled (e.g., inflated and/or deflated) independently (e.g., via supply tubes 436A, 436B, 436C, 436D, and/or the like, respectively). In a similar manner, according to other aspects, each working cushion bladder of the subject head right side zone 434A, the subject seat right side zone 434B, the subject head left side zone 434C, and the subject seat left side zone 434D may be controlled (e.g., inflated and/or deflated) independently (e.g., via independent supply tubes, not shown). According to various aspects described herein, each working cushion bladder of the subject head right side zone 434A, the subject seat right side zone 434B, the subject head left side zone 434C, and the subject seat left side zone 434D may maintain a predetermined or default level of inflation. According to various aspects, a control module (FIG. 2, pulmonary rotation control module 270) may monitor the predetermined or default level of inflation. According to aspects described herein, to turn assist and/or roll the subject toward and/or on the subject's left side, the control module may cause the subject head left side zone 434C and the subject seat left side zone 434D to deflate (e.g., to vent within the person support surface 104 and ultimately flow out of a fluid outlet (FIG. 12A, e.g., fluid outlet 1124)) while causing the subject head right side zone 434A and the subject seat right side zone 434B to inflate (e.g., from the predetermined or default level of inflation). According to aspects of the present disclosure, deflation of the subject head left side zone 434C and the subject seat left side zone 434D combined with inflation of the subject head right side zone 434A and the subject seat right side zone 434B (e.g., coordinated with inflation of the subject head right side zone 424A and the subject seat right side zone 424B of the turn assist bladder layer 420 positioned below the working cushion layer 430) may realize an increased subject turn angle (e.g., up to about 30 degrees) relative to a person support surfaces without a plurality of working cushion bladders 432, without a need for a rotatable deck portion 400 (e.g., about axis A-A), and/or person support surfaces with a turn assist bladder layer 420 positioned above a working cushion layer 430. Similarly, to turn assist and/or roll the subject toward and/or on the subject's right side, the control module may cause the subject head right side zone 434A and the subject seat right side zone 434B to deflate (e.g., to vent within the person support surface 104 and ultimately flow out of a fluid outlet (FIG. 12A, e.g., fluid outlet 1124)) while causing the subject head left side zone 434C and the subject seat left side zone 434D to inflate (e.g., from the predetermined or default level of inflation). According to aspects of the present disclosure, deflation of the subject head right side zone 434A and the subject seat right side zone 434B combined with inflation of the subject head left side zone 434C and the subject seat left side zone 434D (e.g., coordinated with inflation of the subject head left side zone 424C and the subject seat left side zone 424D of the turn assist bladder layer 420 positioned below the working cushion layer 430) may realize an increased subject turn angle (e.g., up to and/or greater than about 30 degrees) relative to person support surfaces without a plurality of working cushion bladders 432, without a need for a rotatable deck portion 400 (e.g., about axis A-A), and/or person support surfaces with a turn assist bladder layer 420 positioned above a working cushion layer 430.

Still referring to FIG. 4, in one aspect, the support cushion layer 440A may be positionable above (e.g., in the +Y direction of the coordinate axes of FIG. 4) the working cushion layer 430 and the turn assist bladder layer 420 (see FIGS. 7A-7C). In another aspect, the support cushion layer 440B may be positionable above (e.g., in the +Y direction of the coordinate axes of FIG. 4) the working cushion layer 430 and the turn assist bladder layer 420. In yet another aspect, the support cushion layer 440B may be positionable above (e.g., in the +Y direction of the coordinate axes of FIG. 4) the turn assist bladder layer 420 (see, e.g., FIGS. 8A-8C).

In view of FIG. 4, the support cushion layer 440A may include a plurality of adjacent air tubes 442 oriented transverse to the longitudinal axis A-A, as depicted in FIG. 4. As illustrated in FIG. 4, and referring briefly to FIG. 7A, the plurality of adjacent air tubes 442 may be cylindrically and/or uniformly shaped. In some aspects, each of the plurality of adjacent air tubes 442 may be defined by a polyurethane coated impermeable heavy-duty fabric. In some aspects, the plurality of adjacent air tubes 442 may connected in one or more than one zone (e.g., a head section support cushion zone 444A, a seat section support cushion zone 444B, and/or the like), where each zone may be controlled (e.g., inflated and/or deflated) independently (e.g., via supply tubes 446A, 446B, and/or the like, respectively). According to various aspects, every other air tube of any subset of the plurality of adjacent air tubes 442 may be associated with a zone. In a similar manner, according to other aspects, each air tube of the plurality of adjacent air tubes 442 may be controlled (e.g., inflated and/or deflated) independently. As depicted in FIG. 4, in some aspects, the plurality of adjacent air tubes 442 (e.g., including the head section support cushion zone 444A, the seat section support cushion zone 444B, and/or the like) may not be encapsulated within a cover (e.g., similar to cover 448 of support cushion layer 440B). In other aspects, the plurality of adjacent air tubes 442 may be encapsulated within a cover (e.g., shaped to retain the positional relationship between the plurality of adjacent air tubes 442).

Similar to as described herein, the support cushion layer 440B may include a plurality of adjacent air tubes 443 (e.g., depicted in phantom in FIG. 4) oriented transverse to the longitudinal axis A-A, as depicted in FIG. 4. However, the plurality of adjacent air tubes 443 may be encapsulated within a cover 448 (e.g., shaped to retain the positional relationship between the plurality of adjacent air tubes 443). In other aspects, the plurality of adjacent air tubes 443 may not be encapsulated within the cover 448. Further, referring to FIG. 4 in light of FIGS. 8A and 8B, the plurality of adjacent air tubes 443 of the support cushion layer 440B may include one or more than one air tube shape. In one aspect, one or more than one air tube of the plurality of adjacent air tubes 443 may be cylindrically and/or uniformly shaped and one or more than one air tube of the plurality of adjacent air tubes 443 may not be cylindrically and/or uniformly shaped (e.g., more than one set of air tubes). Referring briefly to FIG. 8A, for example, one or more than one air tube 840A positioned at or near a distal end (e.g., in the −Z direction of the coordinate axes of FIG. 8A) of the support cushion layer 440B may be cylindrically and/or uniformly shaped and one or more than one air tube 840B positioned in a proximal portion (e.g., in the +Z direction of the coordinate axes of FIG. 8A) of the support cushion layer 440B may not be cylindrically and/or uniformly shaped (see FIGS. 4 and 8B, e.g., t-shaped profile to fit a profile described in FIG. 8B herein, see also FIGS. 4 and 8A, e.g., profile similar to foot air bladders 462A of the foot bladder layer 460, as described herein). In some aspects, each of the plurality of adjacent air tubes 443 may be defined by a polyurethane coated impermeable heavy-duty fabric. In some aspects, the plurality of adjacent air tubes 443 may connected in one or more than one zone (e.g., a head section support cushion zone 445A, a seat section support cushion zone 445B, and/or the like), where each zone may be controlled (e.g., inflated and/or deflated) independently (e.g., via supply tubes 447A, 447B, and/or the like, respectively). According to various aspects, every other air tube of any subset of the plurality of adjacent air tubes 443 may be associated with a zone. In a similar manner, according to other aspects, each air tube of the plurality of adjacent air tubes 443 may be controlled (e.g., inflated and/or deflated) independently.

The microclimate management (MCM) layer 450 of FIG. 4 may be positionable above (e.g., in the +Y direction of the coordinate axes of FIG. 4) the support cushion layer 440A, 440B. In some aspects, the MCM layer 450 may be locatable between the subject right side bolster 414 and the subject left side bolster 416 of the surface foundation layer 410. In other aspects, the MCM layer 450 is positionable above and/or covers (e.g., in the +Y direction of the coordinate axes of FIG. 4) the surface foundation layer 410 (e.g., including the subject right side bolster 414 and the subject left side bolster 416), the turn assist bladder layer 420, the working cushion layer 430, the support cushion layer 440A, 440B, and/or the foot bladder layer 460, as described herein.

According to aspects of the present disclosure, the risk of a subject developing a pressure injury can be reduced by controlling the microclimate (e.g., parameters such as temperature) in the immediate vicinity of the subject's body. In particular, the risk of a pressure injury can be reduced by cooling susceptible portions of the subject's body. Aspects of the present disclosure include the MCM layer 450, as described herein, to target and/or focus on controlling the microclimate at a seat section 106B of a person support surface 104 (FIG. 1). Such an MCM layer 450 may reduce a risk of the subject in developing a pressure injury in areas that correspond to the seat section 106B. More specifically, aspects of the present disclosure utilize an air source (FIGS. 10A-10C, e.g., a high-flow, low pressure blower) integrated within the person support surface 104 itself to provide targeted and/or focused microclimate management to the seat section 106B. Further details regarding the MCM layer 450 are described in FIGS. 7A-7C, 8A-8C, 12A, and 12B herein.

The foot bladder layer 460 may include a first set of foot air bladders 462A, 462B, 462C and a second set of foot air bladders 464A, 464B, 464C. Similar to above, the first set of foot air bladders 462A, 462B, 462C and the second set of foot air bladders 464A, 464B, 464C may be oriented transverse to longitudinal axis A-A, as depicted in FIG. 4. The first set of foot air bladders 462A, 462B, 462C may be oriented to expand and/or collapse vertically (e.g., in the +Y and/or −Y directions of the coordinate axes of FIG. 4) and the second set of foot air bladders 464A, 464B, 464C may be oriented to expand and/or collapse horizontally (e.g., in the +Z and/or −Z directions of the coordinate axes of FIG. 4). According to various aspects, the foot bladder layer 460 may only include the first set of foot air bladders 462A, 462B, 462C or the second set of foot air bladders 464A, 464B, 464C. Further in view of FIG. 4, the first set of foot air bladders 462A, 462B, 462C and/or the second set of foot air bladders 464A, 464B, 464C may, in an expanded state, realize a first height “H1” above (e.g., in the +Y direction of the coordinate axes of FIG. 4) the foot section 407 of the deck portion 400 between a distal end (e.g., in the −Z direction of the coordinate axes of FIG. 4) and a proximal end (e.g., in the +Z direction of the coordinate axes of FIG. 4) of the foot bladder layer 460. In some aspects, as depicted in FIG. 4, the first height “H1” may be a uniform height between the distal end and the proximal end of the foot bladder layer 460. According to other aspects, as described more fully herein (see, e.g., FIGS. 7A & 8A), the foot bladder layer 460 may include a non-uniform height between the distal end and the proximal end of the foot bladder layer 460 (e.g., between a first height “H1” at the distal end and a second height “H2” at the proximal end of the foot bladder layer 460). Similar to as described herein, each bladder of the first set of foot air bladders 462A, 462B, 462C and the second set of foot air bladders 464A, 464B, 464C may be defined by a polyurethane coated impermeable heavy-duty fabric. Still referring to FIG. 4, in some aspects, the first set of foot air bladders 462A, 462B, 462C and/or the second set of foot air bladders 464A, 464B, 464C may be connected in one or more than one zone (e.g., a distal foot zone 468A, a central foot zone 468B, a proximal foot zone 468C, and/or the like), where each zone may be controlled (e.g., inflated and/or deflated) independently (e.g., via supply tubes 466A, 466B, 466C, and/or the like, respectively). In a similar manner, according to other aspects, each foot air bladder of the first set of foot air bladders 462A, 462B, 462C and the second set of foot air bladders 464A, 464B, 464C may be controlled (e.g., inflated and/or deflated) independently. In some aspects, an enclosure 473 may be defined in the foot bladder layer 460 (e.g., depicted in phantom as optional). In one aspect, the enclosure 473 may be positioned centrally (e.g., vertically, laterally, and/or longitudinally) within the foot bladder layer 460. Such an enclosure 473 may house various air supply components (e.g., air valves, air manifolds, air control boards, blowers, and/or the like) as described herein (e.g., in addition to and/or in lieu of the first enclosure 411, the second enclosure 413 and/or the third enclosure 470 of the surface foundation layer 410). In one aspect, for example, the enclosure 473 may house components including an alternating air manifold (not shown, e.g., independent of or dependent on (e.g., downstream of) an air manifold of the first enclosure 411) and an alternating air control board (not shown, e.g., to control the alternating air manifold) that provide a continuous low pressure (CLP) and/or an alternating low pressure (APL) functionality, as described herein. In another aspect, for example, the enclosure 473 may house components including a blower and a blower control board (e.g., independent of or dependent on (e.g., slave to) an air control board of the second enclosure 413) to supply a cooling fluid to the MCM layer 450, as described herein. In yet a further aspect, for example, the enclosure 473 may house a blower without a separate blower control board (e.g., blower controlled by the air control board of the second enclosure 413).

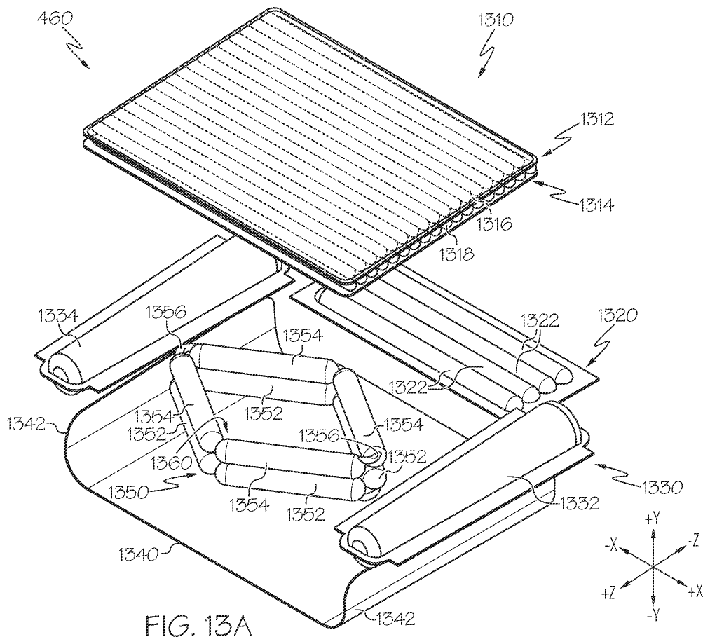

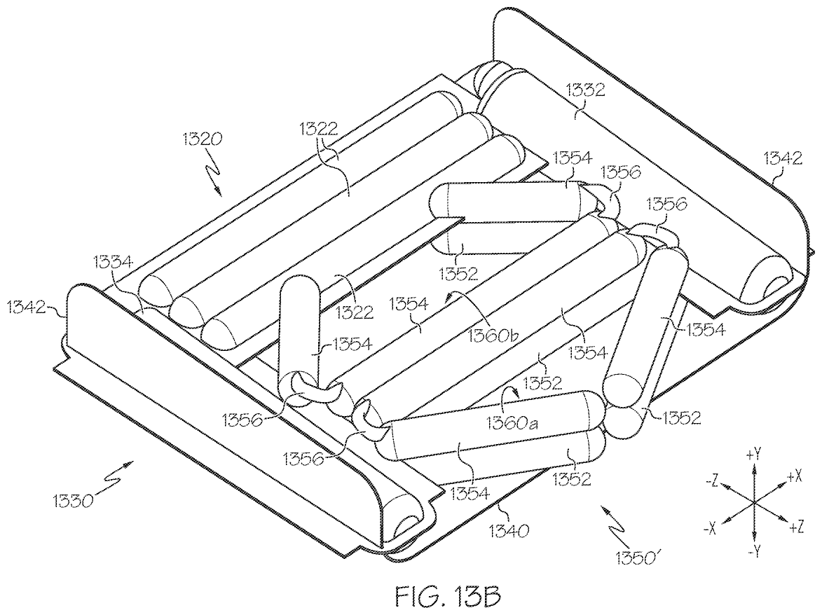

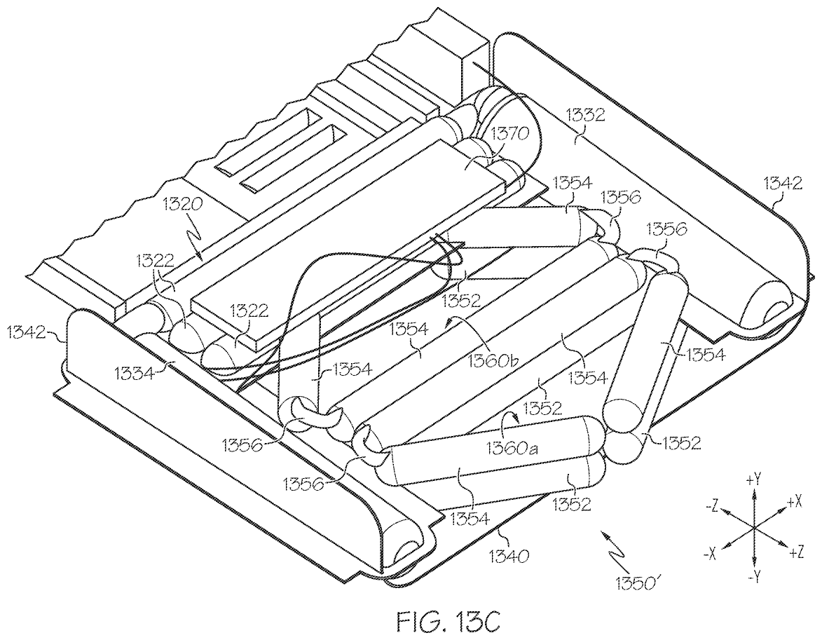

Referring now to FIGS. 13A-13C, other embodiments of the foot bladder layer 460 are depicted. As shown in FIGS. 13A-13C, the foot bladder layer 460 may include, for example, one or more upper raft layers 1310 (e.g., a first upper raft layer 1312 and a second upper raft layer 1314), one or more lower raft layers 1320, one or more side bolsters 1330 (e.g., a first side bolster 1332 and a second side bolster 1334), and/or one or more tube bladders 1350 disposed on a supportive substrate 1340. The first upper raft layer 1312 may include one or more first upper raft bladders 1316 and the second upper raft layer 1314 may include one or more second upper raft bladders 1318. The one or more lower raft layers 1320 may include one or more lower raft bladders 1322. The one or more tube bladders 1350 may generally include one or more first tube bladders 1352 that are coupled to one another via articulating hinges 1356. The one or more tube bladders 1350 may also include one or more second tube bladders 1354 disposed underneath (e.g., in the −y direction of the coordinate axes of FIGS. 13A-C) the one or more first tube bladders 1352 and may also be coupled to one another via articulating hinges 1356, as described in greater detail herein.

The various air bladders of the foot bladder layer 460 may have any shape and/or size. For example, some various air bladders may be generally tubular in shape (e.g., having a circular or oval cross section). In addition, the various bladders of the foot bladder layer 460 may be arranged into particular configurations. For example, the one or more first tube bladders 1352 and/or the one or more second tube bladders 1354 may be arranged relative to one another via the articulating hinges 1356 in a diamond configuration whereby the one or more first tube bladders 1352 and/or the one or more second tube bladders 1354 are positioned to define a void 1360 that is diamond shaped, as depicted in FIG. 13A. However, other configurations of the one or more first tube bladders 1352 and/or the one or more second tube bladders 1354 are also contemplated, including, but not limited to, triangular shaped configurations that result in one or more triangular shaped voids, quadrilateral shaped configurations that result on one or more quadrilateral shaped voids, and/or the like. For example, as shown in FIGS. 13B-13C, an alternative configuration of the one or more tube bladders 1350′ is such that a first void 1360a (e.g., a triangular void) and a second void 1360b (e.g., a trapezoidal void) are formed by the arrangement of the one or more first tube bladders 1352 and/or the one or more second tube bladders 1354. The voids 1360a, 1360b may have a similar shape and/or size, or may have different shapes and/or sizes. Further, the locations of the voids 1360a, 1360b are not limited by the present disclosure.

Still referring generally to FIGS. 13A-13C, in some embodiments, the foot bladder layer 460 may be arranged such that the side bolsters 1330 are arranged on either side of the one or more tube bladders 1350. For example, the first side bolster 1332 may be arranged on one side of the one or more tube bladders 1350 (e.g., a first lateral side) and the second side bolster 1334 may be arranged on another side of the one or more tube bladders 1350 opposite the first side (e.g., a second lateral side). In some embodiments, the side bolsters 1330 may be secured to another component (e.g., the supportive substrate 1340). In some embodiments, the side bolsters 1330 may be held in place by side walls 1342 of the supportive substrate 1340.

In some embodiments, the upper raft layers 1310 (e.g., the first upper raft layer 1312 and the second upper raft layer 1314) is disposed over (e.g., in the +y direction of the coordinate axes of FIGS. 13A-13C) the one or more lower raft layers 1320 and/or the one or more tube bladders 1350. However, other arrangements are contemplated, including, but not limited to, underneath (e.g., in the −y direction of the coordinate axes of FIG. 4) the one or more lower raft layers 1320 and/or the one or more tube bladders 1350. The one or more lower raft layers 1320 are generally disposed distally (e.g., in the −z direction of the coordinate axes of FIGS. 13A-13C) relative to the one or more tube bladders 1350, and/or disposed proximally (e.g., in the +z direction of the coordinate axes of FIGS. 13A-13C) relative to the one or more tube bladders. In some embodiments, the one or more raft layers (e.g., the upper raft layers 1310 and the lower raft layers 1320) may extend any distance. In some embodiments, the one or more raft layers (e.g., the upper raft layers 1310 and the lower raft layers 1320) may be fluidly coupled to various blowers and arranged such that the raft layers define a plurality of zones (e.g., a raft layer may be a two zone cushion raft. For example, in one illustrative embodiment, the foot bladder layer 460 may include the one or more tube bladders 1350 sandwiched in the system vertical direction (e.g., the +y/−y directions) between a 2 zone support cushion raft (e.g., the upper raft layers 1320) and the supportive substrate 1340, sandwiched in the system lateral direction (e.g., the −x/+x directions) between the side bolsters 1332, 1334 that are also sandwiched in the system vertical direction between the 2 zone support cushion raft and the supportive substrate 1340, and positioned proximally (e.g., in the +z direction) of lower raft layers 1320 that is also sandwiched between the 2 zone support cushion raft and the supportive substrate 1340. In some embodiments, various other components, such as, but not limited to, an enclosure 1370 containing ALP valves, a PCB, and/or a blower may also be disposed between various layers (e.g., disposed between the upper raft layers 1310 and the lower raft layers 1320).

It should be understood that the various components of the foot bladder layer 460 described with respect to FIGS. 13A-13C may be integrated with one or more components described herein with respect to FIG. 4. In addition, any of the components, features, or the like discussed with respect to the foot bladder layer 460 in FIG. 4 may also be incorporated with the various components, features, or the like discussed with respect to FIGS. 13A-13C.

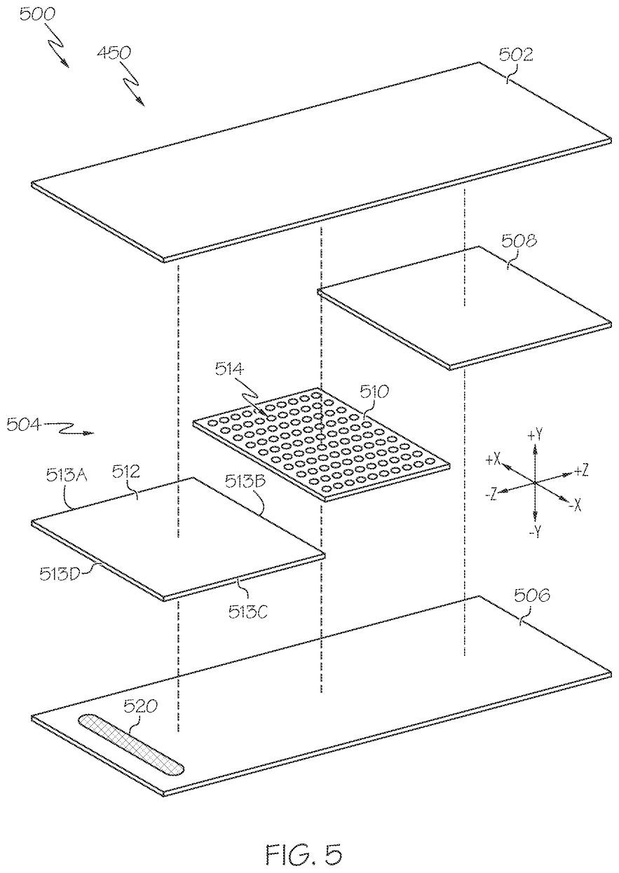

FIG. 5 depicts an exploded perspective view of the illustrative microclimate management (MCM) layer 450 of FIG. 4, according to various aspects of the present disclosure. As described herein, the MCM layer 450 may be positioned within the person support surface 104 (e.g., FIG. 1) over various internal components of the person support surface 104 (e.g., including the surface foundation layer 410, the turn assist bladder layer 420, the working cushion layer 430, the support cushion layer 440A, 440B, the foot bladder layer 460, various enclosures as described herein, and/or the like). According to various aspects of the present disclosure, the MCM layer 450 may cool and/or dry the skin of a subject that is near and/or in contact with the top encasement portion 106 of the person support surface 104.

Referring to FIG. 5, the MCM layer 450 may be defined by a stack of MCM sheets 500. In particular, the MCM layer 450 may include a top MCM sheet 502, an internal MCM sheet 504, and a bottom MCM sheet 506. The top MCM sheet 502 may include a spacer material that includes a fire barrier (e.g., Carflex® The Sherwin-Williams Company, Cleveland, Ohio, and/or the like). In some aspects, the spacer material of the top MCM sheet 502 may be defined by a coated, breathable material (e.g., LYCRA®, A&AT LLC, Wilmington, Del.) to promote the cooling and/or drying of the skin of a subject. The internal MCM sheet 504 may include, for example, a foot MCM portion 508, a seat MCM portion 510, and a head MCM portion 512. Referring to FIGS. 1, 4, and 5, the foot MCM portion 508 may be dimensioned to correspond to the foot section 106C of a person support surface 104, the seat MCM portion 510 may be dimensioned to correspond to the seat section 106B of the person support surface 104, and the head MCM portion 512 may be dimensioned to correspond to the head section 106A of the person support surface 104. According to various aspects described herein, each of the foot MCM portion 508, the seat MCM portion 510, and the head MCM portion 512 of the internal MCM sheet 504 may include a spacer material. In some aspects, the spacer material of the foot MCM portion 508, the seat MCM portion 510, and/or the head MCM portion 512 may be defined by a material such as a synthetic thermoplastic fiber network material, a three-dimensional engineered material, an indented fiber layer material, a molded thermoplastic spacer matrix material, and/or the like. In other aspects, the spacer material may be a monofilament spacer (e.g., supplied by Pressless of Saxony, Germany, Eastex Products, Inc. of Holbrook, Massachusetts, or the like). In yet further aspects, the spacer material may optimize air flow and/or interface pressures within the MCM layer 450. In some aspects, referring briefly to FIG. 12B, the seat MCM portion 510 may include an upper portion 510A (e.g., in the +Y direction of the coordinate axes of FIG. 12B) and a lower portion 510B (e.g., in the −Y direction of the coordinate axes of FIG. 12B). In such aspects, one portion (e.g., the lower portion 510B) may include the spacer material and the other portion (e.g., the upper portion 510A) may include an air permeable fabric. Referring again to FIG. 5, the foot MCM portion 508 may include a spacer that is softer relative to a firmer head MCM portion 512 and/or seat MCM portion 510. In such aspects, the relatively softer spacer at the foot MCM portion 508 may reduce a subject's heel interface pressure. In some aspects, the relatively softer spacer at the foot MCM portion 508 may be used in conjunction with a foot bladder layer 460, 760, 860, 960 (e.g., FIGS. 4, 7A, 8A, 9A), as described herein, to further reduce a subject's heel interface pressure. In view of FIG. 5, an array of holes 514 may be defined in and/or through the seat MCM portion 510 to distribute cooling air across the surface of the seat MCM portion 510. In some aspects, the array of holes 514 is defined in and/or through at least one of the upper portion 510A or the lower portion 510B of the seat MCM portion 510. According to other aspects, a plurality of channels (not shown) may be defined in and/or through the seat MCM portion 510 transverse the seat MCM portion 510 from or between a first lateral side (e.g., in the −X direction of the coordinate axes of FIG. 5) and a second lateral side (e.g., in the +X direction of the coordinate axes of FIG. 5) of the MCM layer 450. According to yet further aspects, the spacer material of the seat MCM portion 510 (e.g., as well as the head MCM portion 512 and/or the foot MCM portion 508) may be an air permeable fabric (e.g., in lieu of and/or in addition to the array of holes 514 and/or the plurality of channels). The array of holes 514, the plurality of transverse channels, and/or the air permeable fabric may be an improvement over MCM systems including a single inlet that focuses a cooling fluid (e.g., air) on a particular area (e.g., a central area with diminishing lateral performance) rather than distributing the cooling fluid (e.g., uniformly) across an area (e.g., centrally as well as laterally).

The bottom MCM sheet 506, in some aspects, may include a spacer material. In other aspects, the bottom MCM sheet 506 may be defined by a material such as an open weave nylon material and/or the like. According to various aspects a vent 520 (see also e.g., FIG. 12B) may be defined in the bottom MCM sheet 506.

In view of FIG. 5, according to various aspects, the top MCM sheet 502 may be fixedly attached (e.g., via stitching, gluing, and/or the like) to the bottom MCM sheet 506 to envelop the internal MCM sheet 504. According to some aspects, the top MCM sheet 502 may be fixedly attached to the bottom MCM sheet 506 around a perimeter of the top MCM sheet 502 and the bottom MCM sheet 506.

In some aspects, the top MCM sheet 502 may be fixedly attached to the bottom MCM sheet 506 between the foot MCM portion 508 and the seat MCM portion 510 to define a physical (e.g., fluid sealed) separation between the foot MCM portion 508 and the seat MCM portion 510 (see FIG. 12B, depicted in phantom as optional). Further in such aspects, the seat MCM portion 510 may be fixedly attached, around the perimeter of the seat MCM portion 510 to the bottom MCM sheet 506 (e.g., to define a channel for fluid flow into the seat MCM portion 510 on the bottom MCM sheet 506 side). The head MCM portion 512 may be fixedly attached to the bottom MCM sheet 506 on a first side 513A, a second side 513B, and a third side 513C of the head MCM portion 512 and may not be fixedly attached to the bottom MCM sheet 506 on a fourth side 513D (see FIG. 12B, to define a channel for distal fluid flow across the head MCM portion 512). Accordingly, in such aspects, the top MCM sheet 502 may not be fixedly attached to the seat MCM portion 510 and/or the head MCM portion 512 between the seat MCM portion 510 and the head MCM portion 512. In such aspects, a fluid is able to flow between the seat MCM portion 510 and the head MCM portion 512 on the top MCM sheet 502 side but not between the head MCM portion 512 and/or the seat MCM portion 510 and the foot MCM portion 508 on the top MCM sheet 502 side. In such aspects, fluid flow is impeded from the foot MCM portion 508 and is directed from the seat MCM portion 510 to the head MCM portion 512 toward a distal end (e.g., in the −Z direction of the coordinate axes of FIG. 5) of the MCM layer 450 (e.g., to vent 520).

According to other aspects, each of the foot MCM portion 508, the seat MCM portion 510, and the head MCM portion 512 may be fixedly attached (e.g., via stitching, gluing, and/or the like) to the bottom MCM sheet 506. In such aspects, a perimeter of each of the foot MCM portion 508 and the seat MCM portion 510 may be fixedly attached to the bottom MCM sheet 506 (e.g., to define a physical,fluid sealed separation between the foot MCM portion 508 and the seat MCM portion 510 and/or to define a channel for fluid flow into the seat MCM portion 510 on the bottom MCM sheet 506 side). The head MCM portion 512 may be fixedly attached to the bottom MCM sheet 506 on a first side 513A, a second side 513B, and a third side 513C of the head MCM portion 512 (e.g., to define a channel for distal fluid flow across the head MCM portion 512). The top MCM sheet 502 may then be fixedly attached to the bottom MCM sheet 506 to envelop the internal MCM sheet 504. In such aspects, the top MCM sheet 502 may be fixedly attached to the bottom MCM sheet 506 around a perimeter of the top MCM sheet 502 and the bottom MCM sheet 506 as described herein. In some aspects, the top MCM sheet 502 may be further fixedly attached to the bottom MCM sheet 506 between the foot MCM portion 508 and the seat MCM portion 510 to define a physical (e.g., fluid sealed) separation between the foot MCM portion 508 and the seat MCM portion 510 (see FIG. 12B, depicted in phantom as optional). Accordingly, in such aspects, the top MCM sheet 502 may not be fixedly attached to the seat MCM portion 510 and/or the head MCM portion 512 between the seat MCM portion 510 and the head MCM portion 512. In such aspects, a fluid is able to flow between the seat MCM portion 510 and the head MCM portion 512 on the top MCM sheet 502 side but not between the head MCM portion 512 and/or the seat MCM portion 510 and the foot MCM portion 508 on the top MCM sheet 502 side. In such aspects, fluid flow is impeded from the foot MCM portion 508 and is directed from the seat MCM portion 510 to the head MCM portion 512 toward a distal end (e.g., in the −Z direction of the coordinate axes of FIG. 5) of the MCM layer 450 (e.g., to de 520).

In other aspects, the top MCM sheet 502 may not be fixedly attached to the bottom MCM sheet 506 between the foot MCM portion 508 and the seat MCM portion 510 (FIG. 12B, depicted in phantom as optional, e.g., no physical, fluid sealed, separation defined between the seat MCM portion 510 and the foot MCM portion 508 on the top MCM sheet 502 side) and/or between the seat MCM portion 510 and the head MCM portion. Further in such aspects, the seat MCM portion 510 may be fixedly attached, around a perimeter of the seat MCM portion 510, to the bottom MCM sheet 506 (e.g., to define a channel for fluid flow into the seat MCM portion 510 on the bottom MCM sheet 506 side). Accordingly, in such aspects, a fluid is able to flow between the seat MCM portion 510 and the head MCM portion 512 and/or the foot MCM portion 508 (see FIG. 12B, flow arrows depicted in phantom) on the top MCM sheet 502 side. In such aspects, while fluid flow is not impeded to the foot MCM portion 508, fluid may ultimately flow toward the distal end (e.g., in the −Z direction of the coordinate axes of FIG. 5) of the MCM layer 450 (e.g., to vent 520). Such aspects may realize the benefit of at least partial fluid flow (and associated MCM benefits) in the foot MCM portion 508 (FIG. 12B, flow arrows depicted in phantom). Accordingly, an MCM layer 450 of the present disclosure may realize relatively low fluid flow in the foot MCM portion 508, relatively high fluid flow in the seat MCM portion 510, and relatively moderate or high fluid flow in the head MCM portion 512.

According to such aspects as described herein, the seat MCM portion 510 may act as a seat MCM zone 622 (e.g., FIG. 6) to distribute cooling air (e.g., via the array of holes 514) within the seat MCM portion 510 to cool and/or to dry the skin of a subject that is near and/or in contact with a seat section 106B of the top encasement portion 106 of the person support surface 104 (e.g., FIG. 1) in contact with and/or corresponding to the seat MCM portion 510 of the MCM layer 450. Further, cooling air may, as described herein, be distributed to at least one of the head MCM portion 512 and/or the foot MCM portion 508 to cool and/or dry the skin of the subject that is near and/or in contact with the head section 106A and/or the foot section 106C, respectively of the top encasement portion 106 of the person support surface 104.

Referring still to FIG. 5, the internal MCM sheet 504 is depicted as a separate foot MCM portion 508, seat MCM portion 510, and head MCM portion 512. According to another aspect of the present disclosure (not shown), the internal MCM sheet 504 may include a single piece spacer material. In such aspects, an array of holes 514 may be similarly defined in and/or through the single piece internal MCM sheet 504. Further in such aspects, the top MCM sheet 502 may be fixedly attached (e.g., via stitching, gluing, and/or the like) to the bottom MCM sheet 506 to envelop the internal MCM sheet 504. In some aspects, the top MCM sheet 502 may be fixedly attached to the bottom MCM sheet 506 around a perimeter of the top MCM sheet 502 and the bottom MCM sheet 506. In some aspects, the top MCM sheet 502 may be further fixedly attached to the bottom MCM sheet 506 to define the foot MCM portion 508 dimensioned to correspond with the foot section 106C of a person support surface 104 (e.g., FIG. 1) and to define a physical (e.g., fluid sealed) separation between the foot MCM portion 508 and a remainder of the internal MCM sheet 504 (see FIG. 12B, depicted in phantom as optional). Further in such aspects, the remainder of the internal MCM sheet 504 may be fixedly attached to the bottom MCM sheet 506 to define the seat MCM portion 510 (e.g., via a perimeter of the seat MCM portion 510 to define a channel for fluid flow into the seat MCM portion 510 on the bottom MCM sheet 506 side) dimensioned to correspond with the seat section 106B of the person support surface 104 (e.g., FIG. 1), and to define the head MCM portion 512 (e.g., via the first side 513A, the second side 513B, and the third side 513C of the head MCM portion 512, to define a channel for distal fluid flow across the head MCM portion 512) dimensioned to correspond with the head section 106A of the person support surface 104 (e.g., FIG. 1). Accordingly, the top MCM sheet 502 may not be fixedly attached to the seat MCM portion 510 and/or the head MCM portion 512 between the seat MCM portion 510 and the head MCM portion 512 and a fluid is able to flow between the seat MCM portion 510 and the head MCM portion 512 on the top MCM sheet 502 side but not between the head MCM portion 512 and/or the seat MCM portion 510 and the foot MCM portion 508 on the top MCM sheet 502 side. In such aspects, fluid flow is impeded from the foot MCM portion 508 and is directed from the seat MCM portion 510 to the head MCM portion 512 toward a distal end (e.g., in the −Z direction of the coordinate axes of FIG. 5) of the MCM layer 450 (e.g., to vent 520).

According to other aspects, the single piece internal MCM sheet 504 may be fixedly attached (e.g., via stitching, gluing, and/or the like) to the bottom MCM sheet 506. In such aspects, internal MCM sheet 504 may be fixedly attached to the bottom MCM sheet 506 to define the foot MCM portion 508 (e.g., via a perimeter of the foot MCM portion 508) dimensioned to correspond with the foot section 106C (e.g., FIG. 4) of a person support surface 104 (e.g., FIG. 1), to define the seat MCM portion 510 (e.g., via a perimeter of the seat MCM portion 510) dimensioned to correspond with the seat section 106B of the person support surface 104 (e.g., FIG. 1), and to define the head MCM portion 512 (e.g., via the first side 513A, the second side 513B, and the third side 513C of the head MCM portion 512) dimensioned to correspond with the head section 106A of the person support surface 104 (e.g., FIG. 1) to define physical separations between the foot MCM portion 508, the seat MCM portion 510, and the head MCM portion 512 on the bottom MCM sheet 506 side. The top MCM sheet 502 may then be fixedly attached to the bottom MCM sheet 506 to envelop the internal MCM sheet 504. In such aspects, the top MCM sheet 502 may be fixedly attached to the bottom MCM sheet 506 around a perimeter of the top MCM sheet 502 and the bottom MCM sheet 506, as described herein. In some aspects, the top MCM sheet 502 may be further fixedly attached to the bottom MCM sheet 506 between the foot MCM portion 508 and the seat MCM portion 510 to define a physical (e.g., fluid sealed) separation between the foot MCM portion 508 and a remainder of the internal MCM sheet 504 on the top MCM sheet 502 side. Accordingly, in such aspects the top MCM sheet 502 is not fixedly attached to the seat MCM portion 510 and/or the head MCM portion 512 between the seat MCM portion 510 and the head MCM portion 512 on the top MCM sheet 502 side. As such, a fluid is able to flow between the seat MCM portion 510 and the head MCM portion 512 on the top MCM sheet 502 side but not between the head MCM portion 512 and/or the seat MCM portion 510 and the foot MCM portion 508 on the top MCM sheet 502 side. In such aspects, fluid flow is impeded from the foot MCM portion 508 and is directed from the seat MCM portion 510 to the head MCM portion 512 toward a distal end (e.g., in the −Z direction of the coordinate axes of FIG. 5) of the MCM layer 450 (e.g., to vent 520).

In other aspects, the top MCM sheet 502 may not be fixedly attached to the bottom MCM sheet 506 between the foot MCM portion 508 and the seat MCM portion 510 (FIG. 12B, depicted in phantom as optional, e.g., no physical, fluid sealed, separation defined between the seat MCM portion 510 and the foot MCM portion 508 on the top MCM sheet 502 side) and/or between the seat MCM portion 510 and the head MCM portion. Further in such aspects, internal MCM sheet 504 may be fixedly attached, around a perimeter of the seat MCM portion 510, to the bottom MCM sheet 506 (e.g., to define a channel for fluid flow into the seat MCM portion 510 on the bottom MCM sheet 506 side). Accordingly, in such aspects, a fluid is able to flow between the seat MCM portion 510 and the head MCM portion 512 and/or the foot MCM portion 508 (see FIG. 12B, flow arrows depicted in phantom) on the top MCM sheet 502 side. In such aspects, while fluid flow is not impeded to the foot MCM portion 508, fluid may ultimately flow toward the distal end (e.g., in the −Z direction of the coordinate axes of FIG. 5) of the MCM layer 450 (e.g., to vent 520). Such aspects may realize the benefit of at least partial fluid flow (and associated MCM benefits) in the foot MCM portion 508 (FIG. 12B, flow arrows depicted in phantom). Accordingly, an MCM layer 450 of the present disclosure may realize relatively low fluid flow in the foot MCM portion 508, relatively high fluid flow in the seat MCM portion 510, and relatively moderate or high fluid flow in the head MCM portion 512.

According to such aspects as described herein, the seat MCM portion 510 may act as a seat MCM zone 622 (e.g., FIG. 6) to distribute cooling air (e.g., via the array of holes 514) within the seat MCM portion 510 to cool and/or to dry the skin of a subject that is near and/or in contact with a seat section 106B of the top encasement portion 106 of the person support surface 104 (e.g., FIG. 1) in contact with and/or corresponding to the seat MCM portion 510 of the MCM layer 450. Further, cooling air may, as described herein, be distributed to at least one of the head MCM portion 512 and/or the foot MCM portion 508 to cool and/or dry the skin of the subject that is near and/or in contact with the head section 106A and/or the foot section 106C, respectively of the top encasement portion 106 of the person support surface 104.

FIG. 6 depicts a top plan view of the MCM layer 450 of FIG. 5, according to various aspects described herein. In particular, FIG. 6 illustrates the top MCM sheet 502 as fixedly attached to the bottom MCM sheet 506 and/or the internal MCM sheet 504 fixedly attached to the bottom MCM sheet 506, as described with respect to FIG. 5, to define the foot MCM portion 508, the seat MCM portion 510, and the head MCM portion 512. According to various aspects, such a fixed attachment may include perimeter stitching 602, 604, 606, 608, 610, 612, 614, 616, or the like, a first stitching 618, and a second stitching 620. Further, as described with respect to FIG. 5, the first stitching 618 may physically (e.g., fluid seal) separate the defined seat MCM portion 510 and the defined foot MCM portion 512 on the bottom MCM sheet 506 side but may or may not physically (e.g., fluid seal) separate the defined seat MCM portion 510 and the defined foot MCM portion 512 on the top MCM sheet 502 side (see FIG. 12B, depicted in phantom) and the second stitching 620 may physically (e.g., fluid seal) separate the defined seat MCM portion 510 and the defined head MCM portion 512 on the bottom MCM sheet 506 side but not on the top MCM sheet 502 side (see FIG. 12B). According to various aspects described herein, the seat MCM portion 510 may act as a seat MCM zone 622 to distribute cooling air (e.g., via the array of holes 514) within the seat MCM portion 510 to cool and/or to dry the skin of a subject that is near and/or in contact with a seat section 106B of the top encasement portion 106 of the person support surface 104 (e.g., FIG. 1) in contact with and/or corresponding to the seat MCM portion 510 of the MCM layer 450. Further, cooling air may, as described herien, be distributed to at least one of the head MCM portion 512 and/or the foot MCM portion 508 to cool and/or dry the skin of the subject that is near and/or in contact with the head section 106A and/or the foot section 106C, respectively of the top encasement portion 106 of the person support surface 104. Yet further in view of FIG. 6, in some aspects, a second portion 628 of an MCM interlocking device 630 (FIGS. 8A, 9A) may be attached around the perimeter of the top MCM sheet 502 and the bottom MCM sheet 506 (e.g., to fixedly attach the top MCM sheet 502 to the bottom MCM sheet 506). As described herein, the second portion 628 of the MCM interlocking device 630 may couple the MCM layer 450 to a first portion 629 (FIGS. 8A, 9A) of the MCM interlocking device 630 attached to an internal surface of the top encasement portion 106.

Still referring to FIG. 6, the bottom MCM sheet 506 may have a length “L1” and a width “W1”. According to various aspects, the length “L1” and the width “W1” may correspond to the external dimensions of a person support surface 104 (e.g., FIG. 1). In some aspects the person support surface 104 may be a standard version at about 36 inches (91.44 cm) wide. In other aspects, the person support surface 104 may be a wide version at about 40 inches (101.6 cm) wide. Further in view of FIG. 6, the top MCM sheet 502, in some aspects, may be a length “L2” shorter than the length “L1” of the bottom MCM sheet 506 and a width “W2” equal to the bottom MCM sheet 506. Furthermore a centerline 624 associated with the array of holes 514 may be positioned a distance “D1” from a first end 626 of the bottom MCM sheet 506. The distance “D 1” may correspond to a target distance associated with the seat section 106B of the top encasement portion 106 of the person support surface 104 (e.g., FIG. 1). Accordingly, in light of FIGS. 5 and 6, it should be understood that any “X” MCM portion of the internal MCM sheet 504 may be physically separated, as described herein, to create an “X” MCM zone to distribute and/or focus cooling air within the “X” MCM portion to cool and/or to dry the skin of a subject that is near and/or in contact with an “X” section of the top encasement portion 106 of the person support surface 104 (e.g., FIG. 1) in contact with and/or corresponding to the “X” MCM portion of the MCM layer 450. Accordingly, any “X” section of the top encasement portion 106 may be similarly targeted to address any subject areas susceptible to pressure injuries.

First Person Support Surface—Including a Working Cushion

FIG. 7A depicts a cross-sectional view, along axis A-A of FIG. 4, of a first illustrative person support surface 704, according to various aspects described herein. Referring to FIG. 7A, similar to as described herein, the first person support surface 704 may include a top encasement portion 106 coupled, via an interlocking device 110 (e.g., zipper or the like), to a bottom encasement portion 108. In view of FIG. 7A, the first person support surface 704 may house various internal components including a surface foundation layer 410 (e.g., a foam crib), a turn assist bladder layer 420 (e.g., depicted in a deflated state), a working cushion layer 430, a support cushion layer 440A, and a MCM layer 450, as described herein. The first person support surface 704 may further house a blower (e.g., pneumatic) enclosure 770 that supplies air to the MCM layer 450, as described herein (e.g., FIGS. 12A and 12B). Yet further, the first person support surface 704 may house a first enclosure 711 (not shown, similar to the first enclosure 411 of FIG. 4) positioned in a first lateral corner (e.g., in the −Z and +X directions of the coordinate axes of FIG. 7A) and a second enclosure 713 positioned in a second lateral corner (e.g., in the −Z and −X directions of the coordinate axes of FIG. 7A), or vice versa, of the first person support surface 704. According to various aspects, the first enclosure 711 (e.g., a pneumatic air control box) and the second enclosure 713 (e.g., an electrical air control box) may be defined in the surface foundation layer 410. In some aspects, the first enclosure 711 may house air valves and/or air manifolds and the second enclosure 713 may house an air control board. In such aspects, the air control board of the second enclosure 713 may be configured to control the air valves and/or air manifolds of the first enclosure 711 to distribute air (e.g., air from an external air source(s)) to the plurality of air tubes and/or air bladders as discussed herein (e.g., for turn-assist, CLRT, P&V, and/or the like). Positioning the first enclosure 711 in the first lateral corner and the second enclosure 713 in the second lateral corner may further define a radiolucent window, as discussed elsewhere herein, over an otherwise centrally positioned enclosure that houses the air valves, the air manifold, and/or the air control board.

The first person support surface 704, according to some aspects, may further include the foot bladder layer 460 of FIG. 4. However, in other aspects, the first person support surface 704 may include a foot bladder layer 760, as depicted in FIG. 7A. The foot bladder layer 760 may include a plurality of foot air bladders 762. In one aspect, the plurality of foot air bladders 762 may each be oriented to expand and/or collapse vertically (e.g., in the +Y and/or −Y directions of the coordinate axes of FIG. 7A). In another aspect, the plurality of foot air bladders 762 may each be oriented to expand and/or collapse horizontally (e.g., in the +Z and/or −Z directions of the coordinate axes of FIG. 7A). In yet other aspects, the plurality of foot air bladders 762 may alternate between air bladders oriented to expand and/or collapse vertically and air bladders oriented to expand and/or collapse horizontally. In some aspects, the plurality of foot air bladders 762 may be positioned over (e.g., in the +Y direction of the coordinate axes of FIG. 7A) a foot support layer 964 (e.g., shown in phantom as optional) as discussed more thoroughly herein (FIG. 9A, e.g., to minimize a volume of air required by the plurality of foot air bladders 762 to function as described herein). Still referring to FIG. 7A, the plurality of foot air bladders 762 may be arranged to, in an expanded state, realize a first height “H1” (e.g., in the +Y direction of the coordinate axes of FIG. 7A) relative to an internal surface 764 of the bottom encasement portion 108 or the foot support layer 964 at a distal end (e.g., in the −Z direction of the coordinate axes of FIG. 7A) of the foot bladder layer 760 and a second height “H2” (e.g., in the +Y direction of the coordinate axes of FIG. 7A) relative to the internal surface 764 of the bottom encasement portion 108 or the foot support layer 964 at a proximal end (e.g., in the +Z direction of the coordinate axes of FIG. 7A) of the foot bladder layer 760. According to various aspects, the first height “H1” may be greater than the second height “H2” such that the foot bladder layer 760 gradually slopes downward from the distal end toward the proximal end. This gradual (e.g., downward) slope may be defined via a plurality of foot air bladders 762 of varying (e.g., incrementally shorter, stair-stepped, and/or the like) heights (e.g., a series of tall bladders, a series of medium bladders, a series of short bladders, and/or the like). According to aspects of the present disclosure, the gradual slope may improve or reduce a subject's heel interface pressure by offloading pressure from underneath the subject's heels to underneath the subject's calves (e.g., tissue on a subject's calves is less likely to break down and/or result in pressure injuries relative to skin on the subject's heels).

Referring still to FIG. 7A, according to various aspects, the top encasement portion 106 may further define an enclosure 766 (e.g., depicted in phantom as optional) that retains the MCM layer 450. According to various aspects, the enclosure 766 may include a pouch, a sleeve, or the like, that keeps the MCM layer 450 in contact with a bottom internal surface 768 of the top encasement portion 106 (e.g., above the surface foundation layer 410, the turn assist bladder layer 420, the working cushion layer 430, and/or the support cushion layer 440A, 440B as described herein. According to various aspects, the enclosure 766 may include an interlocking device (not shown, e.g., zipper) such that the MCM layer 450 is removable. In some aspects, the MCM layer 450 of the first person support surface 704 may be replaced periodically (e.g., every “X” months of use) or as needed (e.g., due to a puncture, damage, contamination, or the like). The enclosure 766 of the present disclosure may assist removal of an existing MCM layer 450 and/or insertion of a replacement MCM layer 450 (e.g., without disturbing other internal components of the first person support surface 704). According to various aspects, the interlocking device may be positioned around a perimeter of the enclosure 766. In some aspects, one or more than one air supply hole (not shown) may be defined in a bottom (e.g., in the −Y direction of the coordinate axes of FIG. 7A) of the enclosure 766 for air supply components (see, e.g., FIGS. 12A, 12B, e.g., subject right blow horn 1114 and/or subject left blow horn 1116) coupled to the MCM layer 450. In some aspects, a sleeve 120 (e.g., similar to FIGS. 1 and 9A) may be defined on a bottom surface (e.g., in the −Y direction of the coordinate axes of FIG. 7A) of the enclosure 766.

FIG. 7B depicts a cross-sectional view, along axis B-B of FIG. 7A, of the first person support surface 704, according to various aspects described herein. As described in FIG. 7A, the first person support surface 704 may include a top encasement portion 106 coupled, via an interlocking device 110 (e.g., zipper or the like), to a bottom encasement portion 108 and the first person support surface 704 may house various internal components including a surface foundation layer 410 (e.g., a foam crib), a turn assist bladder layer 420 (e.g., depicted in a deflated state), a working cushion layer 430, a support cushion layer 440A, and a MCM layer 450. Further, according to various aspects, the top encasement portion 106 may further define an enclosure 766 (e.g., depicted in phantom as optional) that retains the MCM layer 450.

Referring still to FIG. 7B, the surface foundation layer 410 may restrain lateral movement (e.g., in the +X and −X directions of the coordinate axes of FIG. 7B) of various internal components of the first person support surface 704. In particular, in view of FIG. 7B, a first void 772 may be defined in the surface foundation layer 410 to restrain lateral movement and/or lateral expansion of the turn assist bladder layer 420 and/or the working cushion layer 430. According to various aspects, the first void 772 may be defined by an internally facing surface (e.g., in the +X direction of the coordinate axes of FIG. 7B) of a subject right side bolster 714 and an internally facing surface (e.g., in the −X direction of the coordinate axes of FIG. 7B) of a subject left side bolster 716. Accordingly, the surface foundation layer 410 may permit efficient expansion of the bladders of the turn assist bladder layer 420 and/or the cushions of the working cushion layer 430.

Still referring to FIG. 7B, the surface foundation layer 410 may further act as a conduit for one or more than one supply tube (FIG. 4, e.g., 426A, 426B, 426C, 426D, 436A, 436B, 436C, 436D, 446A, 446B, 447A, 447B, 466A, 466B, 466C, and/or the like) that supply a fluid (e.g., air) to the various layers (e.g., 420, 430, 440A, 760 and/or the like) described herein as well as one or more than one supply tube (see, e.g., FIGS. 10A-10C, 12A, and 12B) that supply a fluid (e.g., air) to the MCM layer 450 as described herein. In particular, in view of FIG. 7B, a subject right channel 774 may be defined in the subject right side bolster 714 and a subject left channel 776 may be defined in the subject left side bolster 716 of the surface foundation layer 410 to act as a conduit for the one or more than one supply tube as described herein. According to other aspects of the present disclosure, gaps between the various bladders (e.g., the plurality of turn bladders 422, the plurality of working cushion bladders 432, and/or the plurality of adjacent air tubes 442, 443) may act as ducts and/or conduits for the one or more than one supply tube as described herein.

FIG. 7C depicts a cross-sectional view, along axis B-B of FIG. 7A, of the first person support surface 704 where the turn assist bladder of the subject head right side zone 424A of the turn assist bladder layer 420 is in an inflated state and the working cushion bladder of the subject head right side zone 434A of the working cushion layer 430 is in a hyper-inflated state, according to various aspects described herein. As described herein, such an arrangement may be utilized to turn and/or roll the subject toward and/or on their left side. In view of FIG. 7C, according to various aspects of the present disclosure, the turn assist bladder of the subject head right side zone 424A may be wedge-shaped. The working cushion bladder of the subject head right side zone 434A may also be wedge-shaped. In such aspects, the turn assist bladder and/or the working cushion bladder may include one or more than one longitudinal bladder dimple 780 (e.g., gap, in lieu of a rounded, unconstrained bladder) to minimize a volume of fluid (e.g., air) necessary to inflate the turn assist bladder and/or to hyper-inflate the working cushion bladder. Referring to FIG. 7C, the turn assist bladder of the subject head left side zone 424C of the turn assist bladder layer 420 is in a deflated state (e.g., to vent within the first person support surface 704) and the working cushion bladder of the subject head left side zone 434C of the working cushion layer 430 is in its default inflated state (e.g., to its default or predetermined level of inflation) or a deflated state (e.g., to vent within the first person support surface 704). In view of FIG. 7C, the support cushion layer 440A, the MCM layer 450, and the top encasement portion 106 may flex to define a surface sloped toward a left side (e.g., in the +X direction of the coordinate axes of FIG. 7C) of the first person support surface 704 to turn and/or roll the subject toward and/or on their left side.

In light of FIG. 7C, it should be appreciated that, similar to as described herein, the turn assist bladder of the subject head left side zone 424C of the turn assist bladder layer 420 may be in an inflated state and the working cushion bladder of the subject head left side zone 434C of the working cushion layer 430 may be in a hyper-inflated state. Such an arrangement may be utilized to turn and/or roll the subject toward and/or on their right side. In light of FIG. 7C, according to various aspects of the present disclosure, the turn assist bladder of the subject head left side zone 424C may be wedge-shaped. The working cushion bladder of the subject head left side zone 434C may also be wedge-shaped. In such aspects, the turn assist bladder and/or the working cushion bladder may similarly include one or more than one longitudinal bladder dimple (not shown, e.g., gap, in lieu of a rounded, unconstrained bladder) to minimize a volume of fluid (e.g., air) to inflate the turn assist bladder and/or to hyper-inflate the working cushion bladder respectively. Further in light of FIG. 7C, the turn assist bladder of the subject head right side zone 424A of the turn assist bladder layer 420 may be in a deflated state (e.g., to vent within the first person support surface 704) and the working cushion bladder of the subject head right side zone 434A of the working cushion layer 430 may be in its default inflated state (e.g., to its default or predetermined level of inflation) or a deflated state (e.g., to vent within the first person support surface 704). In such an aspect, the support cushion layer 440A, the MCM layer 450, and the top encasement portion 106 are similarly configured to flex to define a surface sloped toward a right side (e.g., in the −X direction of the coordinate axes of FIG. 7C) of the first person support surface 704 to turn and/or roll the subject toward and/or on their right side.

Second Person Support Surface—Regular Cushion

FIG. 8A depicts a cross-sectional view, along axis A-A of FIG. 4, of a second illustrative person support surface 804, according to various aspects described herein. Referring to FIG. 8A, similar to as described herein, the second person support surface 804 may include a top encasement portion 106 coupled, via an interlocking device 110 (e.g., zipper or the like), to a bottom encasement portion 108. In view of FIG. 8A, the second person support surface 804 may house various internal components including a surface foundation layer 410 (e.g., a foam crib), a turn assist bladder layer 420 (e.g., depicted in a deflated state), a support cushion layer 440B, and a MCM layer 450, as described herein. The second person support surface 804 may further house a blower (e.g., pneumatic) enclosure 870 that supplies air to the MCM layer 450, as described herein (e.g., FIGS. 12A and 12B). Yet further, the second person support surface 804 may house a first enclosure 811 (not shown, similar to the first enclosure 411 of FIG. 4) positioned in a first lateral corner (e.g., in the −Z and +X directions of the coordinate axes of FIG. 8A) and a second enclosure 813 positioned in a second lateral corner (e.g., in the −Z and −X directions of the coordinate axes of FIG. 8A), or vice versa, of the second person support surface 804. According to various aspects, the first enclosure 811 (e.g., a pneumatic air control box) and the second enclosure 813 (e.g., an electrical air control box) may be defined in the surface foundation layer 410. In some aspects, the first enclosure 811 may house air valves and/or air manifolds and the second enclosure 813 may house an air control board. In such aspects, the air control board of the second enclosure 813 may be configured to control the air valves and/or air manifolds of the first enclosure 811 to distribute air (e.g., air from an external air source(s)) to the plurality of air tubes and/or air bladders as discussed herein (e.g., for turn-assist, CLRT, P&V, and/or the like). Positioning the first enclosure 811 in the first lateral corner and the second enclosure 813 in the second lateral corner may further define a radiolucent window, as discussed elsewhere herein, over an otherwise centrally positioned enclosure that houses the air valves, the air manifold, and/or the air control board.

The second person support surface 804, according to some aspects, may further include the foot bladder layer 460 of FIG. 4. However, in other aspects, the second person support surface 804 may include a foot bladder layer 860, as depicted in FIG. 8A. The foot bladder layer 860 may include a plurality of foot air bladders 862. In one aspect, the plurality of foot air bladders 862 may each be oriented to expand and/or collapse vertically (e.g., in the +Y and/or −Y directions of the coordinate axes of FIG. 8A). In another aspect, the plurality of foot air bladders 862 may each be oriented to expand and/or collapse horizontally (e.g., in the +Z and/or −Z directions of the coordinate axes of FIG. 8A). In yet other aspects, the plurality of foot air bladders 862 may alternate between air bladders oriented to expand and/or collapse vertically and air bladders oriented to expand and/or collapse horizontally. In some aspects, the plurality of foot air bladders 862 may be positioned over (e.g., in the +Y direction of the coordinate axes of FIG. 7A) a foot support layer 964 (e.g., shown in phantom as optional) as discussed more thoroughly herein (FIG. 9A, e.g., to minimize a volume of air required by the plurality of foot air bladders 862 to function as described herein).

Still referring to FIG. 8A, the plurality of foot air bladders 862 may be arranged to, in an expanded state, realize a first height “H1” (e.g., in the +Y direction of the coordinate axes of FIG. 8A) relative to an internal surface 864 of the bottom encasement portion 108 or the foot support layer 964 at a distal end (e.g., in the −Z direction of the coordinate axes of FIG. 8A) of the foot bladder layer 860 and a second height “H2” (e.g., in the +Y direction of the coordinate axes of FIG. 8A) relative to the internal surface 864 of the bottom encasement portion 108 or the foot support layer 964 at a proximal end (e.g., in the +Z direction of the coordinate axes of FIG. 7A) of the foot bladder layer 860. According to various aspects, the first height “H1” may be greater than the second height “H2” such that the foot bladder layer 860 gradually slopes downward from the distal end toward the proximal end. This gradual (e.g., downward) slope may be defined via a plurality of foot air bladders 862 of varying (e.g., incrementally shorter, stair-stepped, and/or the like) heights. According to aspects of the present disclosure, the gradual slope may improve or reduce a subject's heel interface pressure by offloading pressure from underneath the subject's heels to underneath the subject's calves (e.g., tissue on a subject's calves is less likely to break down and/or result in pressure injuries relative to skin on the subject's heels).

Referring still to FIG. 8A, according to various aspects, the MCM layer 450 itself may include at least a portion (e.g., second portion 628) of an MCM interlocking device 630 (e.g., zipper). Here, a first portion 629 of the MCM interlocking device 630 may be attached to an internal surface perimeter of the top encasement portion 106 (e.g., located to position the MCM layer 450 in contact with the bottom internal surface 868 of the top encasement portion 106) and the second portion 628 of the MCM interlocking device 630 may be attached to a perimeter of the MCM layer 450 (see also FIG. 6). Accordingly, in such aspects, an existing MCM layer 450 may be removed by disengaging (e.g., unzipping) its second portion 628 from the first portion 629 of the MCM interlocking device 630 attached to the top encasement portion 106 and a replacement MCM layer 450 may be installed by engaging (e.g., zipping) its second portion 628 to the first portion 629 of the MCM interlocking device 630 attached to the top encasement portion 106. As described herein, the MCM layer 450 of the second person support surface 804 may be replaced periodically (e.g., every “X” months of use) or as needed (e.g., due to a puncture, damage, contamination, or the like). An MCM layer 450 including at least a portion of the interlocking device may assist such replacements without disturbing other internal components of the second person support surface 804.

FIG. 8B depicts a cross-sectional view, along axis C-C of FIG. 8A, of the second person support surface 804, according to various aspects described herein. As described in FIG. 8A, the second person support surface 804 may include a top encasement portion 106 coupled, via an interlocking device 110 (e.g., zipper or the like), to a bottom encasement portion 108 and the second person support surface 804 may house various internal components including a surface foundation layer 410 (e.g., a foam crib), a turn assist bladder layer 420 (e.g., depicted in a deflated state), a support cushion layer 440B, and a MCM layer 450. As described herein, the first portion 629 and the second portion 628 of the MCM interlocking device 630 may position and/or retain the MCM layer 450 in contact with the bottom internal surface 868 of the top encasement portion 106.

Referring still to FIG. 8B, the surface foundation layer 410 may restrain lateral movement (e.g., in the +X and −X directions of the coordinate axes of FIG. 8B) of various internal components of the second person support surface 804. In particular, in view of FIG. 8B, a first void 872 may be defined in the surface foundation layer 410 to restrain lateral movement and/or lateral expansion of the turn assist bladder layer 420 and/or a lower portion (e.g., in the −Y direction of the coordinate axes of FIG. 8B) of the support cushion layer 440B. According to various aspects, the first void 872 may be defined by an internally facing surface (e.g., in the +X direction of the coordinate axes of FIG. 8B) of a subject right side bolster 814 and an internally facing surface (e.g., in the −X direction of the coordinate axes of FIG. 8B) of a subject left side bolster 816. Accordingly, the surface foundation layer 410 may permit efficient expansion of the bladders of the turn assist bladder layer 420 and/or the lower portion of the support cushion layer 440B.

Still referring to FIG. 8B, the surface foundation layer 410 may further act as a conduit for one or more than one supply tube (FIG. 4, e.g., 426A, 426B, 426C, 426D, 436A, 436B, 436C, 436D, 446A, 446B, 447A, 447B, 466A, 466B, 466C, and/or the like) that supply a fluid (e.g., air) to the various layers (e.g., 420, 430, 440B, 860 and/or the like) described herein as well as one or more than one supply tube (see FIGS. 10A-10C, 12A, and 12B) that supply a fluid (e.g., air) to the MCM layer 450 as described herein. In particular, in view of FIG. 8B, a subject right channel 874 may be defined in the subject right side bolster 814 and a subject left channel 876 may be defined in the subject left side bolster 816 of the surface foundation layer 410 to act as a conduit for the one or more than one supply tube as described herein.

FIG. 8C depicts a cross-sectional view, along axis C-C of FIG. 8A, of the second person support surface 804 where the turn assist bladder of the subject head right side zone 424A of the turn assist bladder layer 420 is in an inflated state, according to various aspects described herein. As described herein, such an arrangement may be utilized to turn and/or roll the subject toward and/or on their left side. Referring to FIG. 8C, the turn assist bladder of the subject head left side zone 424C of the turn assist bladder layer 420 is in a deflated state (e.g., to vent within the second person support surface 804). In view of FIG. 8C, the support cushion layer 440B, the MCM layer 450, and the top encasement portion 106 flex to define a surface sloped toward a left side (e.g., in the +X direction of the coordinate axes of FIG. 8C) of the second person support surface 804 to turn and/or roll the subject toward and/or on their left side.

In light of FIG. 8C, it should be appreciated that, similar to as described herein, the turn assist bladder of the subject head left side zone 424C of the turn assist bladder layer 420 may be in an inflated state. Such an arrangement may be utilized to turn and/or roll the subject toward and/or on their right side. Further in light of FIG. 8C, the turn assist bladder of the subject head right side zone 424A of the turn assist bladder layer 420 may be in a deflated state (e.g., to vent within the second person support surface 804). In such an aspect, the support cushion layer 440B, the MCM layer 450, and the top encasement portion 106 similarly flex to define a surface sloped toward a right side (e.g., in the −X direction of the coordinate axes of FIG. 8C) of the second person support surface 804 to turn and/or roll the subject toward and/or on their right side.

Third Person Support Surface—Alternating Low Pressure Feature

FIG. 9A depicts a cross-sectional view, along axis A-A of FIG. 4, of a third illustrative person support surface 904, according to various aspects described herein. Referring to FIG. 9A, similar to as described herein, the third person support surface 904 may include a top encasement portion 106 coupled, via an interlocking device 110 (e.g., zipper or the like), to a bottom encasement portion 108. Similar to FIGS. 7A and 8A, the third person support surface 904 of FIG. 9A may house various internal components including a surface foundation layer 410 (e.g., a foam crib), a turn assist bladder layer 420, a working cushion layer 430, a support cushion layer 440C, and a MCM layer 450, as described herein. The third person support surface 904 may further house a blower (e.g., pneumatic) enclosure 970 that supplies air to the MCM layer 450, as described herein (e.g., FIGS. 12A and 12B). Furthermore, similar to FIG. 1, the third person support surface 904 of FIG. 9A depicts a head section sleeve 120 (e.g., X-ray sleeve) illustratively positioned between the support cushion layer 440C and the MCM layer 450. In such aspects, the MCM layer 450 may function to pad the subject during use of the head section sleeve 120 (e.g., when an X-ray cassette is inserted within the head section sleeve 120). As described herein, the MCM layer 450 may be insertable through an aperture defined between a top surface of the head section sleeve 120 and a bottom surface of the top encasement portion 106 (e.g., when a perimeter of a first side (e.g., in the −X direction of the coordinate axes of FIG. 9A) and/or a perimeter of a second side (e.g., in the +X direction of the coordinate axes of FIG. 9A) of the head section sleeve 120 is coupled to a first internal side (e.g., in the −X direction of the coordinate axes of FIG. 9A) and/or a second internal side (e.g., in the +X direction of the coordinate axes of FIG. 9A) of the top encasement portion 106, respectively) prior to being coupled, as described herein, within the third person support surface 904. Here, it should be understood that the head section sleeve 120 may be similarly positioned in the first person support surface 704 of FIG. 7A and/or the second person support surface 804 of FIG. 8A.

Further, as depicted in FIG. 9A, the turn assist bladder layer 420 may include a head section turn bladder zone 425A and a seat section turn bladder zone 425B, the working cushion layer 430 may include a head section working cushion zone 435A and a seat section working cushion zone 435B, and the support cushion layer 440C may include a head section support cushion zone 444A and a seat section support cushion zone 444B. According to various aspects described herein, such zone separation may permit efficient use of the third person support surface 904 on one or more than one person support apparatus 102 (FIG. 1, e.g., an advanced articulation person support apparatus).

The third person support surface 904 of FIG. 9A, according to some aspects, may further include the foot bladder layer 460 of FIG. 4. However, in other aspects, the third person support surface 904 may include a foot bladder layer 960, as depicted in FIG. 9A. The foot bladder layer 960 may include a plurality of foot air bladders 962 positioned over (e.g., in the +Y direction of the coordinate axes of FIG. 9A) a foot support layer 964. In view of FIG. 9A, a thickness “t1” of the foot bladder layer 960 may correspond to a combination of the support cushion layer 440C, the working cushion layer 430, the turn assist bladder layer 420, and either a head substrate layer 915 or a seat substrate layer 917, as described herein. In some aspects, the foot support layer 964 may minimize a volume of air required by the plurality of foot air bladders 962 to function as described herein. In some aspects the foot support layer 964 may include a foot support bladder that maintains a default inflation state to fill volume within the foot section 905C of the third person support surface 904. Accordingly, the foot support layer 964 may be controlled (e.g., inflated and/or deflated) as needed (e.g., with respect to positional changes of the person support apparatus, to chair egress, and/or the like). Further in view of FIG. 9A, a foot substrate layer 919 may be positioned under (e.g., in the −Y direction of the coordinate axes of FIG. 9A) the foot support layer 964, as described herein. Here it should be understood that the foot bladder layer 760 of FIG. 7A may similarly include the plurality of foot air bladders 762 positioned over a foot support layer 964 (depicted in FIG. 7A in phantom as optional), as described herein, and that the foot bladder layer 860 of FIG. 8A may similarly include the plurality of foot air bladders 862 positioned over a foot support layer 964 (depicted in FIG. 8A in phantom as optional), as described herein (e.g., to minimize a volume of air required by the plurality of foot air bladders 762 and the plurality of foot air bladders 862 to function as described herein). In some aspects, the foot support layer 964, as depicted in FIG. 9A, may be a consistent height (e.g., HA=HB) between a distal end (e.g., in the −Z direction of the coordinate axes of FIG. 9A) and a proximal end (e.g., in the +Z direction of the coordinate axes of FIG. 9A). Similarly, the foot support layer 964, as depicted in FIG. 7A and FIG. 8A may be a consistent height to maintain the gradual downward slope as described herein (e.g., when the plurality of foot air bladders 762 and the plurality of foot air bladders 862, respectively, define the gradual downward slope via a series of incrementally shorter and/or stair-stepped heights as depicted in FIG. 7A and FIG. 8A). However, according to some aspects, to realize a gradual downward slope (e.g., in FIGS. 7A, 8A and/or 9A), the foot support layer 964 itself may be defined by a first height (e.g., HA) at its distal end and a second height (e.g., HB) at its proximal end (e.g., the first height HA being greater than the second height HB) and the plurality of foot air bladders 762, 862, 962 may be a consistent height (FIGS. 7A and 8A, e.g., H1=H2). In other aspects, the foot support layer 964 (e.g., HA >HB) and the plurality of foot air bladders 762, 862, 962 (e.g., series of incrementally shorter and/or stair-stepped heights) may realize a gradual downward slope.

Yet further in view of FIG. 9A, a head section 905A of the third person support surface 904 may include one or more than one enclosure. For example, a first enclosure 911 (not shown, similar to the first enclosure 411 of FIG. 4) may be positioned in a first lateral corner (e.g., in the −Z and +X directions of the coordinate axes of FIG. 9A) and a second enclosure 913 may be positioned in a second lateral corner (e.g., in the −Z and −X directions of the coordinate axes of FIG. 9A). According to various aspects, the first enclosure 911 and the second enclosure 913 may be defined in the surface foundation layer 410. In some aspects, the first enclosure 911 (e.g., pneumatic air control box) may house air valves and/or air manifolds and the second enclosure 913 (e.g., electrical air control box) may house an air control board. In such aspects, the air control board of the second enclosure 913 may be configured to control the air valves and/or air manifolds of the first enclosure 911 to distribute air (e.g., air from an external air source(s)) to the plurality of air tubes and/or air bladders as discussed herein (e.g., for turn-assist, CLRT, P&V, and/or the like). Positioning the first enclosure 911 in the first lateral corner and the second enclosure 913 in the second lateral corner may further define the radiolucent window, as discussed elsewhere herein, over an otherwise centrally positioned enclosure that houses the air valves, air manifold, and/or air control board.

Still further in view of FIG. 9A, the third person support surface 904 may include an advanced articulation bladder 903 (e.g., an advanced articulation bladder layer). According to various aspects, the advanced articulation bladder 903 may be positioned to interface with a gap 409A of a deck portion 400 of an advanced articulation person support apparatus 102 (FIG. 4). In particular, the advanced articulation bladder 903 may be positioned to interface with (e.g., above) and/or expand into one or more than one separable section of the surface foundation layer 410 (e.g., separable section 413A) that corresponds to the gap 409A of the deck portion 400. In some aspects, the advanced articulation bladder 903 may be positioned at a proximal portion (e.g., in the +Z direction of the coordinate axes of FIG. 9A) of the head section 905A. In other aspects, the advanced articulation bladder 903 may be positioned between the head section 905A and the seat section 905B. In such aspects, the advanced articulation bladder 903 may extend between a first lateral side (e.g., in the −X direction of the coordinate axes of FIG. 9A) and a second lateral side (e.g., in the +X direction of the coordinate axes of FIG. 9A) to fill the gap 409A. In some aspects, the advanced articulation bladder 903 may extend between the subject right side bolster 914 and the subject left side bolster 916 (e.g., FIG. 9B). According to various aspects, the advanced articulation bladder 903 may be deflated and/or partially inflated when the third person support surface 904 is in a flat position (e.g., when the gap 409A is minimized). In such aspects, as depicted in FIG. 9A, the advanced articulation bladder 903 may not interface with and/or expand into the separable section 413A to fill any gap 409A. However, as the third person support surface 904 is repositioned (e.g., toward a raised head section 905A position, toward a chair egress position, and/or the like) the advanced articulation bladder 903 may be progressively inflated to interface with and/or expand into a progressively dividing separable section 413A to fill an increasing gap 409A. Filling such a gap 409A may be pertinent to an advanced articulation person support apparatus (e.g., where the head section 401 and/or the seat section 403 of the deck portion 400 may translate relative to one another during repositioning and form the gap 409A). In some aspects, the bottom encasement portion 108 may define a relief portion (not shown) into which the advanced articulation bladder 903 may expand when inflated. According to some aspects, the third person support surface 904 may not include the advanced articulation bladder (e.g., for use with a standard person support apparatus).

Yet further in view of FIG. 9A, the head section 905A of the third person support surface 904 may include one or more than one percussion and vibration bladder 905 (e.g., a percussion and vibration bladder layer). As depicted in FIG. 9A, the one or more than one percussion and vibration bladder 905 may be positioned above and/or within gaps between (e.g., in the +Y direction of the coordinate axes of FIG. 9A) one or more than one air tube of the support cushion layer 440C (e.g., positioned in and/or near a chest area of a subject). The one or more than one percussion and vibration bladder 905 may be configured to deliver P&V therapies. A P&V therapy, according to various aspects, may include a percussion frequency from about 1 beat per second to about 5 beats per second and a vibration frequency from about 5 beats per second to about 25 beats per second for about 5 minutes to about 30 minutes in duration. Percussion therapy and vibration therapy can be performed separately or together as a sequential treatment. Each of the percussion and vibration settings may be operate at a low, medium, or high intensity. According to various aspects, P&V therapy duration may be limited if CLRT therapy is being simultaneously performed. In such aspects, operating P&V with CLRT may contribute to elevated person support surface temperatures (e.g., thereby reducing the effectiveness of the MCM layer 450 as described herein). In one aspect, for example, P&V therapy may be limited to about “X” minutes for about every “Y” minutes of CLRT therapy. According to various aspects, air may be supplied to the one or more than one percussion and vibration bladder 905 from an air source (not shown, e.g., compressor) located on a frame of the person support apparatus 102 (e.g., via one or more than one supply tube coupled to the frame-based air source). According aspects of the present disclosure, air may be delivered to the one or more than one percussion and vibration bladder 905 through an oscillating valve in the person support surface.

As depicted in FIG. 9A, the third person support surface 904 may further include an upper fire barrier 909A and a lower fire barrier 909B (e.g., depicted in phantom as optional). As illustrated in FIG. 9A, the upper fire barrier 909A may encase the MCM layer 450. The upper fire barrier 909A may include a fire-resistant and/or fire-proof material that is flexible, elastic and/or breathable (e.g., such that it does not structurally inhibit the functionalities of the various components encased therein). Similarly, the lower fire barrier 909B may encase the surface foundation layer 410, the turn assist bladder layer 420, the working cushion layer 430, the support cushion layer 440C, and/or the foot bladder layer 960 as well as other components including the head substrate layer 915, the seat substrate layer 917, the foot substrate layer 919, the first and second enclosures 911, 913, the blower enclosure 970, the advanced articulation bladder 903, the percussion and vibration bladder 905, and/or the like. The lower fire barrier 909B may similarly include a fire-resistant and/or fire-proof material that is flexible, elastic and/or breathable (e.g., such that it does not structurally inhibit the functionalities of the various components encased therein).

FIG. 9B depicts a cross-sectional view, along axis D-D of FIG. 9A, of the third person support surface 904, according to various aspects described herein. As described in FIG. 9A, the third person support surface 904 may include a top encasement portion 106 coupled, via an interlocking device 110 (e.g., zipper or the like), to a bottom encasement portion 108 and the third person support surface 904 may house various internal components including the surface foundation layer 410 (e.g., a foam crib), the turn assist bladder layer 420 (e.g., depicted in a deflated state), the working cushion layer 430, the support cushion layer 440C, and the MCM layer 450. Similar to as described herein, a first portion 629 and a second portion 628 of an MCM interlocking device 630 may position and/or retain the MCM layer 450 in contact with the bottom internal surface 968 of the top encasement portion 106.

Similar to FIGS. 7B and 8B, the surface foundation layer 410 of FIG. 9B may restrain lateral movement (e.g., in the +X and −X directions of the coordinate axes of FIG. 9B) of various internal components of the third person support surface 904. In particular, in view of FIG. 9B, a first void 972 may be defined in the surface foundation layer 410 to restrain lateral movement and/or lateral expansion of the turn assist bladder layer 420 and/or the working cushion layer 430. According to various aspects, the first void 972 may be defined by an internally facing surface (e.g., in the +X direction of the coordinate axes of FIG. 9B) of a subject right side bolster 914 and an internally facing surface (e.g., in the −X direction of the coordinate axes of FIG. 9B) of a subject left side bolster 916. Accordingly, the surface foundation layer 410 may permit efficient expansion of the bladders of the turn assist bladder layer 420 and/or the cushions of the working cushion layer 430.

Referring still to FIG. 9B, the surface foundation layer 410 may further act as a conduit for one or more than one supply tube (FIG. 4, e.g., 426A, 426B, 426C, 426D 436A, 436B, 436C, 436D, 446A, 446B, 447A, 447B, 466A, 466B, 466C, and/or the like) that supply a fluid (e.g., air) to the various layers (e.g., 420, 430, 440C, 960 and/or the like) described herein as well as one or more than one supply tube (see, e.g., FIGS. 10A-10C, 12A, and 12B) that supply a fluid (e.g., air) to the MCM layer 450 as described herein. In particular, in view of FIG. 9B, a subject right channel 974 may be defined in the subject right side bolster 914 and a subject left channel 976 may be defined in the subject left side bolster 916 of the surface foundation layer 410 to act as a conduit for the one or more than one supply tube as described herein. According to other aspects of the present disclosure, gaps between the various bladders (e.g., the plurality of turn bladders 422, the plurality of working cushion bladders 432, and/or the plurality of adjacent air tubes 442, 443) may act as ducts and/or conduits for the one or more than one supply tube as described herein.

Referring to FIG. 9B in light of FIG. 4, the head section turn bladder zone 425A (e.g., FIG. 9A) may include a subject head right side zone 424A and a subject head left side zone 424C. Similarly, the head section working cushion zone 435A may include a subject head right side zone 434A and a subject head left side zone 434C. Further in view of FIG. 9B, a head substrate layer 915 may be positioned between the head section turn bladder zone 425A and the head section working cushion zone 435A. According to various aspects described herein, the head substrate layer 915 may comprise a fabric layer or a polymer layer. In some aspects, the head substrate layer 915 may comprise a coated, woven (e.g., non-tear), and/or non-stretch material. Here, it should be appreciated that the first person support surface 704 and/or the second person support surface 804 may similarly include a head substrate layer 915 as described herein.

In some aspects, as depicted in FIG. 9B, the head substrate layer 915 may extend from a first lateral side (e.g., in the −X direction of the coordinate axes of FIG. 9B) of the subject head right side zone 424A of the head section turn bladder zone 425A and the subject head right side zone 434A of the head section working cushion zone 435A to a second lateral side (e.g., in the +X direction of the coordinate axes of FIG. 9B) of the subject head left side zone 424C of the head section turn bladder zone 425A and the subject head left side zone 434C of the head section working cushion zone 435A. According to various aspects of the present disclosure, each of the subject head right side zone 424A and the subject head left side zone 424C of the head section turn bladder zone 425A may be coupled to a bottom surface (e.g., in the −Y direction of the coordinate axes of FIG. 9B) of the head substrate layer 915. Similarly, according to various aspects of the present disclosure, each of the subject head right side zone 434A and the subject head left side zone 434C of the head section working cushion zone 435A may be coupled to a top surface (e.g., in the +Y direction of the coordinate axes of FIG. 9B) of the head substrate layer 915. In such aspects, the head substrate layer 915 may function to keep the various zones (e.g., 424A, 424C, 434A, 434C) in position within the head section 905A of the third person support surface 904 (e.g., relative to other internal components and/or the like).

In other aspects, in light of FIG. 9B, the head substrate layer 915 may be divided (division shown in phantom as optional). In such aspects, a first portion of the head substrate layer 915 may be positioned between the subject head right side zone 424A of the head section turn bladder zone 425A and the subject head right side zone 434A of the head section working cushion zone 435A. Here, the subject head right side zone 424A of the head section turn bladder zone 425A may be coupled to a bottom surface (e.g., in the −Y direction of the coordinate axes of FIG. 9B) of the first portion of the head substrate layer 915 and the subject head right side zone 434A of the head section working cushion zone 435A may be coupled to a top surface (e.g., in the +Y direction of the coordinate axes of FIG. 9B) of the first portion of the head substrate layer 915. Similarly, a second portion of the head substrate layer 915 may be positioned between the subject head left side zone 424C of the head section turn bladder zone 425A and the subject head left side zone 434C of the head section working cushion zone 435A. Here, the subject head left side zone 424C of the head section turn bladder zone 425A may be coupled to a bottom surface (e.g., in the −Y direction of the coordinate axes of FIG. 9B) of the second portion of the head substrate layer 915 and the subject head left side zone 434C of the head section working cushion zone 435A may be coupled to a top surface (e.g., in the +Y direction of the coordinate axes of FIG. 9B) of the second portion of the head substrate layer 915.

In some aspects, the head substrate layer 915 (e.g., depicted in FIG. 9B in phantom as optional) may extend upwardly (e.g., in the +Y direction of the coordinate axes of FIG. 9B) on the first lateral side (e.g., in the −X direction of the coordinate axes of FIG. 9B) and the second lateral side (e.g., in the +X direction of the coordinate axes of FIG. 9B). In such aspects, a first lateral end (e.g., in the −X direction of the coordinate axes of FIG. 9B) of each of the plurality of adjacent air tubes 442 (FIG. 4) of the head section support cushion zone 444A may couple to the head substrate layer 915 on the first lateral side and a second lateral end (e.g., in the +X direction of the coordinate axes of FIG. 9B) of each of the plurality of adjacent air tubes 442 (FIG. 4) of the head section support cushion zone 444A may couple to the head substrate layer 915 on the second lateral side to keep the head section support cushion zone 444A in position within the head section 905A of the third person support surface 904. According to various aspects, the first lateral end and the second lateral end of each of the plurality of adjacent air tubes 442 may include a fastener insertable within respective receiving apertures (not shown) defined and positioned in the head substrate layer 915 for each of the plurality of adjacent air tubes 442.

FIG. 9C depicts a cross-sectional view, along axis E-E of FIG. 9A, of the third person support surface 904, according to various aspects described herein. As described in FIG. 9A, the third person support surface 904 may include a top encasement portion 106 coupled, via an interlocking device 110 (e.g., zipper or the like), to a bottom encasement portion 108 and the third person support surface 904 may house various internal components including the surface foundation layer 410 (e.g., a foam crib), the turn assist bladder layer 420 (e.g., depicted in a deflated state), the working cushion layer 430, the support cushion layer 440C, and the MCM layer 450. Similar to as described in FIG. 9B, the surface foundation layer 410 may restrain lateral movement (e.g., in the +X and −X directions of the coordinate axes of FIG. 9C) of various internal components of the third person support surface 904 and may act as a conduit for one or more than one supply tube (FIG. 4, e.g., 426A, 426B, 426C, 426D 436A, 436B, 436C, 436D, 446A, 446B, 447A, 447B, 466A, 466B, 466C and/or the like) that supply a fluid (e.g., air) to the various layers (e.g., 420, 430, 440C, 960 and/or the like) described herein as well as one or more than one supply tube (see, e.g., FIGS. 10A-10C, 12A, and 12B) that supply a fluid (e.g., air) to the MCM layer 450 as described herein.

Referring to FIG. 9C in light of FIG. 4, the seat section turn bladder zone 425B (e.g., FIG. 9A) may include a subject seat right side zone 424B and a subject seat left side zone 424D. Similarly, the seat section working cushion zone 435B may include a subject seat right side zone 434B and a subject seat left side zone 434D. Further in view of FIG. 9C, a seat substrate layer 917 may be positioned between the seat section turn bladder zone 425B and the seat section working cushion zone 435B. According to various aspects described herein, the seat substrate layer 917 may comprise a fabric layer or a polymer layer. In some aspects, the seat substrate layer 917 may comprise a coated, woven (e.g., non-tear), and/or non-stretch material. Here, it should be appreciated that the first person support surface 704 and/or the second person support surface 804 may similarly include a seat substrate layer 917 as described herein.

In some aspects, as depicted in FIG. 9C, the seat substrate layer 917 may extend from a first lateral side (e.g., in the −X direction of the coordinate axes of FIG. 9C) of the subject seat right side zone 424B of the seat section turn bladder zone 425B and the subject seat right side zone 434B of the seat section working cushion zone 435B to a second lateral side (e.g., in the +X direction of the coordinate axes of FIG. 9C) of the subject seat left side zone 424D of the seat section turn bladder zone 425B and the subject seat left side zone 434D of the seat section working cushion zone 435B. According to various aspects of the present disclosure, each of the subject seat right side zone 424B and the subject seat left side zone 424D of the seat section turn bladder zone 425B may be coupled to a bottom surface (e.g., in the −Y direction of the coordinate axes of FIG. 9C) of the seat substrate layer 917. Similarly, according to various aspects of the present disclosure, each of the subject seat right side zone 434B and the subject seat left side zone 434D of the seat section working cushion zone 435B may be coupled to a top surface (e.g., in the +Y direction of the coordinate axes of FIG. 9C) of the seat substrate layer 917. In such aspects, the seat substrate layer 917 may function to keep the various zones (e.g., 424B, 424D, 434B, 434D) in position within the seat section 905B of the third person support surface 904 (e.g., relative to other internal components and/or the like).

In other aspects, in light of FIG. 9C, the seat substrate layer 917 may be divided (depicted in phantom as optional). In such aspects, a first portion of the seat substrate layer 917 may be positioned between the subject seat right side zone 424B of the seat section turn bladder zone 425B and the subject seat right side zone 434B of the seat section working cushion zone 435B. Here, the subject seat right side zone 424B of the seat section turn bladder zone 425B may be coupled to a bottom surface (e.g., in the −Y direction of the coordinate axes of FIG. 9C) of the first portion of the seat substrate layer 917 and the subject seat right side zone 434B of the seat section working cushion zone 435B may be coupled to a top surface (e.g., in the +Y direction of the coordinate axes of FIG. 9C) of the first portion of the head substrate layer 915. Similarly, a second portion of the seat substrate layer 917 may be positioned between the subject seat left side zone 424D of the seat section turn bladder zone 425B and the subject seat left side zone 434D of the seat section working cushion zone 435B. Here, the subject seat left side zone 424D of the seat section turn bladder zone 425B may be coupled to a bottom surface (e.g., in the −Y direction of the coordinate axes of FIG. 9C) of the second portion of the seat substrate layer 917 and the subject seat left side zone 434D of the seat section working cushion zone 435B may be coupled to a top surface (e.g., in the +Y direction of the coordinate axes of FIG. 9C) of the second portion of the seat substrate layer 917.

In some aspects, the seat substrate layer 917 (e.g., depicted in FIG. 9C in phantom as optional) may extend upwardly (e.g., in the +Y direction of the coordinate axes of FIG. 9C) on the first lateral side (e.g., in the −X direction of the coordinate axes of FIG. 9C) and the second lateral side (e.g., in the +X direction of the coordinate axes of FIG. 9C). In such aspects, a first lateral end (e.g., in the −X direction of the coordinate axes of FIG. 9C) of each of the plurality of adjacent air tubes 442 (FIG. 4) of the seat section support cushion zone 444B may couple to the seat substrate layer 917 on the first lateral side and a second lateral end (e.g., in the +X direction of the coordinate axes of FIG. 9C) of each of the plurality of adjacent air tubes 442 (FIG. 4) of the seat section support cushion zone 444B may couple to the seat substrate layer 917 on the second lateral side to keep the seat section support cushion zone 444B in position within the seat section 905B of the third person support surface 904. According to various aspects, the first lateral end and the second lateral end of each of the plurality of adjacent air tubes 442 may include a fastener insertable within respective receiving apertures (not shown) defined and positioned in the seat substrate layer 917 for each of the plurality of adjacent air tubes 442.

Referring to FIGS. 9B and 9C in light of FIG. 9A, the subject head right side zone 424A of the head section turn bladder zone 425A (FIG. 9A) and the subject seat right side zone 424B of the seat section turn bladder zone 425B (FIG. 9A) may turn and/or roll the subject toward and/or onto the subject's left side, as similarly described herein. Further, the subject head left side zone 424C of the head section turn bladder zone 425A (FIG. 9A) and the subject seat left side zone 424D of the seat section turn bladder zone 425B (FIG. 9A) may turn and/or roll the subject toward and/or onto the subject's right side, as similarly described herein.

Referring still to FIGS. 9B and 9C in light of FIG. 9A, the subject head right side zone 434A of the head section working cushion zone 435A (FIG. 9A) and the subject seat right side zone 434B of the seat section working cushion zone 435B (FIG. 9A) may assist in turning and/or rolling the subject toward and/or onto the subject's left side, as similarly described herein. Further, the subject head left side zone 434C of the head section working cushion zone 435A (FIG. 9A) and the subject seat left side zone 434D of the seat section working cushion zone 435B (FIG. 9A) may assist in turning and/or rolling the subject toward and/or onto the subject's right side, as similarly described herein.

FIG. 9D depicts a cross-sectional view, along axis F-F of FIG. 9A, of the third person support surface 904, according to various aspects described herein. As described in FIG. 9A, the foot bladder layer 960 may include a plurality of foot air bladders 962 positioned over (e.g., in the +Y direction of the coordinate axes of FIG. 9D) a foot support layer 964. Further in view of FIG. 9D, the foot substrate layer 919 may be positioned below (e.g., in the −Y direction of the coordinate axes of FIG. 9D) the foot support layer 964. According to various aspects described herein, the foot substrate layer 919 may comprise a fabric layer or a polymer layer. In some aspects, the foot substrate layer 919 may comprise a coated, woven (e.g., non-tear), and/or non-stretch material. Here, it should be appreciated that the first person support surface 704 and/or the second person support surface 804 may similarly include a foot substrate layer 919 as described herein.

In some aspects, as depicted in FIG. 9D, the foot substrate layer 919 may extend from a first lateral side (e.g., in the −X direction of the coordinate axes of FIG. 9D) of the foot support layer 964 to a second lateral side (e.g., in the +X direction of the coordinate axes of FIG. 9D) of the foot support layer 964. According to various aspects of the present disclosure, the foot support layer 964 may be coupled to a top surface (e.g., in the +Y direction of the coordinate axes of FIG. 9D) of the foot substrate layer 919. In such aspects, the foot substrate layer 919 may function to keep the foot support layer 964 in position within the foot section 905C of the third person support surface 904 (e.g., relative to other internal components and/or the like).

In some aspects, the foot substrate layer 919 (e.g., depicted in FIG. 9D in phantom as optional) may extend upwardly (e.g., in the +Y direction of the coordinate axes of FIG. 9D) on the first lateral side (e.g., in the −X direction of the coordinate axes of FIG. 9D) and the second lateral side (e.g., in the +X direction of the coordinate axes of FIG. 9D). In such aspects, a first lateral end (e.g., in the −X direction of the coordinate axes of FIG. 9D) of each of the plurality of foot air bladders 962 of the foot bladder layer 960 may couple to the foot substrate layer 919 on the first lateral side and a second lateral end (e.g., in the +X direction of the coordinate axes of FIG. 9D) of each of the plurality of foot air bladders 962 of the foot bladder layer 960 may couple to the foot substrate layer 919 on the second lateral side to keep the plurality of foot air bladders 962 in position within the foot section 905C of the third person support surface 904. According to various aspects, the first lateral end and the second lateral end of each of the plurality of foot air bladders 962 may include a fastener insertable within respective receiving apertures (not shown) defined and positioned in the foot substrate layer 919 for each of the plurality of foot air bladders 962.

In view of FIG. 9D, according to various aspects of the present disclosure, the foot section 905C (FIG. 9A) of the third person support surface 904 may house an enclosure 973 (e.g., shown in phantom as optional, similar to enclosure 473 of FIG. 4A). The enclosure 973 may be positioned within a central portion (e.g., in the +Y and −Y directions, in the +Z and −Z directions, and/or in the +X and −X directions) of the foot section 905C (e.g., surrounded by the plurality of foot air bladders 962). In some aspects, the enclosure 973 (e.g., pneumatic air control box, electrical air control box, or combination thereof) may house air valves, air manifolds, and/or air control boards, to support continuous low pressure (CLP) and/or alternating low pressure (ALP) functionality as described herein. In one aspect, for example, the enclosure 973 may house components including an alternating air manifold (not shown, e.g., independent of or dependent on (e.g., downstream of) an air manifold of the first enclosure 911) and an alternating air control board (not shown, e.g., that controls the alternating air manifold to distribute air) to provide the CLP and/or ALP functionality, as described herein. According to other aspects, the enclosure 973 of the foot section 905C may house air valves, air manifolds, air control boards, and/or a blower (e.g., similar to the first enclosure 411, the second enclosure 413, and the third enclosure 470 of FIG. 4) to distribute air to the plurality of air tubes, air bladders, and/or MCM layer 450 as discussed herein. In one aspect, for example, the enclosure 973 may house components including a blower and a blower control board (e.g., independent of or dependent on (e.g., slave to) an air control board of the second enclosure 913) to supply a cooling fluid to the MCM layer 450, as described herein. In another aspect, for example, the enclosure 973 may house a blower without a separate blower control board (e.g., blower controlled by the air control board of the second enclosure 913). According to various aspects, positioning such an enclosure 973 in the foot section 905C may further define a relatively larger radiolucent window, as discussed elsewhere herein.

Referring again to FIG. 9A, the support cushion layer 440C, similar to the support cushion layer 440A (e.g., FIG. 4) may include a plurality of adjacent air tubes 442 oriented transverse to the longitudinal axis A-A depicted in FIG. 4. In view of FIG. 9A, the plurality of adjacent air tubes 442 of the support cushion layer 440C may be divided into a head section support cushion zone 444A and a seat section support cushion zone 444B. In some aspects, the head section support cushion zone 444A and the seat section support cushion zone 444B may be controlled (e.g., inflated and/or deflated) independently (FIG. 4, e.g., via supply tubes 446A, 446B, and/or the like). In other aspects, each air tube of the head section support cushion zone 444A and each air tube of the seat section support cushion zone 444B may be controlled (e.g., inflated and/or deflated) independently. For example, in some aspects, the head section support cushion zone 444A may include a head air tube 945C that is controlled (e.g., inflated and/or deflated) independent of each other air tube or set of air tubes of the head section support cushion zone 444A. In yet further aspects, one set of air tubes of the head section support cushion zone 444A may be controlled (e.g., inflated and/or deflated) independent of one or more than one other set of air tubes of the head section support cushion zone 444A and one set of air tubes of the seat section support cushion zone 444B may be controlled (e.g., inflated and/or deflated) independent of one or more than one other set of air tubes of the seat section support cushion zone 444B.

Yet further in view of FIG. 9A, the foot bladder layer 960, similar to the foot bladder layer 460 (e.g., FIG. 4) may include a plurality of foot air bladders 962 oriented transverse to the longitudinal axis A-A depicted in FIG. 4. The plurality of foot air bladders 962 may be arranged in a foot section zone 907. Similar to as described herein, the plurality of foot air bladders 962 of the foot section zone 907 may be divided into one or more than one foot zone and each foot zone may be controlled (e.g., inflated and/or deflated) independently (FIG. 4, e.g., via supply tubes 466A, 466B, 466C and/or the like). In other aspects, each foot air bladder of the plurality of foot air bladders 962 may be controlled (e.g., inflated and/or deflated) independently. In yet further aspects, one set of foot air bladders may be controlled (e.g., inflated and/or deflated) independent of one or more than one other set of foot air bladders.

Continuous and/or Alternating Low Pressure Functionality

Accordingly, in light of FIG. 9A, various aspects of the present disclosure include a continuous low pressure (CLP) functionality. In such aspects, each air tube of the head section support cushion zone 444A of the support cushion layer 440C, each air tube of the seat section support cushion zone 444B of the support cushion layer 440C, and/or each foot air bladder of the foot section zone 907 may be controlled (e.g., inflated and/or deflated) to maintain a continuous low pressure. According to various aspects, the continuous low pressure may be a balanced pressure. In such aspects, a balanced pressure may be a pressure that corresponds to a load of the subject that optimally supports the subject while reducing pressure on the subject's body. According to various aspects, as the load changes relative to the head section support cushion zone 444A, the seat section support cushion zone 444B, and/or the foot section zone 907 (e.g., subject changes position, person support apparatus itself changes position, and/or the like) the balanced pressure may be adjusted in each air tube and/or each foot air bladder, respectively. In some aspects, a pressure transducer associated with each air tube of the head section support cushion zone 444A, a pressure transducer associated with each air tube of the seat section support cushion zone 444B, a pressure transducer associated with each foot air bladder of the foot section zone 907, and/or a subject weight scale associated with a frame of the person support apparatus 102 (FIG. 1) may detect such load changes and an air control board (e.g., of enclosure 973) may adjust any balanced pressure(s) based on factors including a subject's weight, a position of the person support apparatus 102, and/or the like. In some aspects, the head air tube 945C of the head section support cushion zone 444A may (e.g., independently) maintain and/or adjust a balanced pressure to support the subject's head with minimal movement.

Furthermore, in light of FIG. 9A, various aspects of the present disclosure include an alternating low pressure (ALP) functionality. In such aspects, pressure redistribution may be realized by deflating (e.g., wholly or partially) and re-inflating (e.g., wholly or partially) alternate air tubes and/or foot air bladders to relieve pressure on a subject's body. Such aspects may further reduce the occurrence of pressure injuries. According to various aspects described herein, the deflating and re-inflating may occur periodically. Accordingly, the third person support surface 904 of FIG. 9A is capable of providing not only pulmonary therapies (e.g., CLRT & P&V, as described herein) but also CLP and ALP therapies in addition to MCM.

In view of FIG. 9A, the head section support cushion zone 444A may include a first set of alternating air tubes 945A (e.g., marked with “1” in FIG. 9A), a second set of alternating air tubes 945B (e.g., marked with “2” in FIG. 9A) and a head air tube 945C. In such an aspect, the first set of alternating air tubes 945A may be controlled (e.g., inflated and/or deflated) independent of the second set of alternating air tubes 945B and/or the head air tube 945C. In some aspects, the head air tube 945C of the head section support cushion zone 444A may simply maintain and/or adjust a balanced pressure to support the subject's head with minimal movement. Under ALP, however, the first set of alternating air tubes 945A may, periodically, be at least partially deflated (e.g., to vent within the third person support surface 904 and/or via a valve-controlled deflation) to redistribute a portion of pressure on the subject's body in the head section support cushion zone 444A from the first set of alternating air tubes 945A to the second set of alternating air tubes 945B. The second set of alternating air tubes 945B may be inflated prior to and/or during deflation of the first set of alternating air tubes 945A. Likewise, under ALP, the second set of alternating air tubes 945B may, periodically, be at least partially deflated (e.g., to vent within the third person support surface 904 and/or via a valve-controlled deflation) to redistribute a portion of pressure on the subject's body in the head section support cushion zone 444A from the second set of alternating air tubes 945B to the first set of alternating air tubes 945A. The first set of alternating air tubes 945A may be inflated prior to and/or during deflation of the second set of alternating air tubes 945B.

As one example, the first set of alternating air tubes 945A and the second set of alternating air tubes 945B may be controlled in a set of phases. In a first phase, each air tube of the first set of alternating air tubes 945A may be deflated to a relatively low pressure (e.g., relative to the balanced pressure as described herein) and each air tube of the second set of alternating air tubes 945B may be inflated to a relatively high pressure (e.g., relative to the balanced pressure as described herein). In some aspects, the low pressure may be a near-zero pressure, a near-atmospheric pressure, or the like and the high pressure may be a predetermined percentage (e.g., 10% - 20%) higher than the balanced pressure. A duration of the first phase may be a first defined time period (e.g., “R” minutes, up to a predetermined maximum of “S” minutes, and/or the like). As one example, the first defined time period may be about 1.5 minutes up to about 15 minutes. Continuing the example, in a second phase, each air tube of the first set of alternating air tubes 945A may be inflated to the balanced pressure and each air tube of the second set of alternating air tubes 945B may be deflated to the balanced pressure. Accordingly, each air tube of the first set of alternating air tubes 945A and each air tube of the second set of alternating air tubes 945B would realize the same balanced pressure. A duration of the second phase may be a second defined time period (e.g., “T” minutes, up to a predetermined maximum of “U” minutes, and/or the like). As one example, the second defined time period may be about 1.5 minutes up to about 15 minutes. Further continuing the example, in a third phase, each air tube of the second set of alternating air tubes 945B may be deflated to a relatively low pressure (e.g., relative to the balanced pressure as described herein) and each air tube of the first set of alternating air tubes 945A may be inflated to a relatively high pressure (e.g., relative to the balanced pressure as described herein). In some aspects, the low pressure may be a near-zero pressure, a near-atmospheric pressure, or the like and the high pressure may be a predetermined percentage (e.g., 10%-20%) higher than the balanced pressure. A duration of the third phase may be a third defined time period (e.g., “V” minutes, up to a predetermined maximum of “W” minutes, and/or the like). As one example, the third defined time period may be about 1.5 minutes up to about 15 minutes. Accordingly, in some aspects, a pressure in each air tube of the head section support cushion zone 444A may alternate (e.g., ALP) from a high pressure or a low pressure to a balanced pressure or from a balanced pressure to a high pressure or a low pressure. In other aspects, a pressure in each air tube of the head section support cushion zone 444A may alternate (e.g., ALP) from a high pressure to a low pressure without a balanced pressure phase or from a low pressure to a high pressure without a balanced pressure phase.

Similarly, in view of FIG. 9A, the seat section support cushion zone 444B may include a first set of alternating air tubes 947A (e.g., marked with “1” in FIG. 9A) and a second set of alternating air tubes 947B (e.g., marked with “2” in FIG. 9A). In such an aspect, the first set of alternating air tubes 947A may be controlled (e.g., inflated and/or deflated) independent of the second set of alternating air tubes 947B. Accordingly, under ALP, the first set of alternating air tubes 947A may, periodically, be at least partially deflated (e.g., to vent within the third person support surface 904 and/or via a valve-controlled deflation) to redistribute a portion of pressure on the subject's body in the seat section support cushion zone 444B from the first set of alternating air tubes 947A to the second set of alternating air tubes 947B. The second set of alternating air tubes 947B may be inflated prior to and/or during deflation of the first set of alternating air tubes 947A. Likewise, under ALP, the second set of alternating air tubes 947B may, periodically, be at least partially deflated (e.g., to vent within the third person support surface 904 and/or via a valve-controlled deflation) to redistribute a portion of pressure on the subject's body in the seat section support cushion zone 444B from the second set of alternating air tubes 947B to the first set of alternating air tubes 947A. The first set of alternating air tubes 947A may be inflated prior to and/or during deflation of the second set of alternating air tubes

As one example, the first set of alternating air tubes 947A and the second set of alternating air tubes 947B may be controlled in a set of phases. In a first phase, each air tube of the first set of alternating air tubes 947A may be deflated to a relatively low pressure (e.g., relative to the balanced pressure as described herein) and each air tube of the second set of alternating air tubes 947B may be inflated to a relatively high pressure (e.g., relative to the balanced pressure as described herein). In some aspects, the low pressure may be a near-zero pressure, a near-atmospheric pressure, or the like and the high pressure may be a predetermined percentage (e.g., 10%-20%) higher than the balanced pressure. A duration of the first phase may be a first defined time period (e.g., “R” minutes, up to a predetermined maximum of “S” minutes, and/or the like). As one example, the first defined time period may be about 1.5 minutes up to about 15 minutes. Continuing the example, in a second phase, each air tube of the first set of alternating air tubes 947A may be inflated to the balanced pressure and each air tube of the second set of alternating air tubes 947B may be deflated to the balanced pressure. Accordingly, each air tube of the first set of alternating air tubes 947A and each air tube of the second set of alternating air tubes 947B would realize the same balanced pressure. A duration of the second phase may be a second defined time period (e.g., “T” minutes, up to a predetermined maximum of “U” minutes, and/or the like). As one example, the second defined time period may be about 1.5 minutes up to about 15 minutes. Further continuing the example, in a third phase, each air tube of the second set of alternating air tubes 947B may be deflated to a relatively low pressure (e.g., relative to the balanced pressure as described herein) and each air tube of the first set of alternating air tubes 947A may be inflated to a relatively high pressure (e.g., relative to the balanced pressure as described herein). In some aspects, the low pressure may be a near-zero pressure, a near-atmospheric pressure, or the like and the high pressure may be a predetermined percentage (e.g., 10%-20%) higher than the balanced pressure. A duration of the third phase may be a third defined time period (e.g., “V” minutes, up to a predetermined maximum of “W” minutes, and/or the like). As one example, the third defined time period may be about 1.5 minutes up to about 15 minutes. Accordingly, in some aspects, a pressure in each air tube of the seat section support cushion zone 444B may alternate (e.g., ALP) from a high pressure or a low pressure to a balanced pressure or from a balanced pressure to a high pressure or a low pressure. In other aspects, a pressure in each air tube of the seat section support cushion zone 444B may alternate (e.g., ALP) from a high pressure to a low pressure without a balanced pressure phase or from a low pressure to a high pressure without a balanced pressure phase.

Likewise, in view of FIG. 9A, a foot section zone 907 may include a first set of alternating foot air bladders 949A (e.g., marked with “1” in FIG. 9A) and a second set of alternating foot air bladders 949B (e.g., marked with “2” in FIG. 9A). In such an aspect, the first set of alternating foot air bladders 949A may be controlled (e.g., inflated and/or deflated) independent of the second set of alternating foot air bladders 949B. Accordingly, under ALP, the first set of alternating foot air bladders 949A may, periodically, be at least partially deflated (e.g., to vent within the third person support surface 904 and/or via a valve-controlled deflation) to redistribute a portion of pressure on the subject's body in the foot section zone 907 from the first set of alternating foot air bladders 949A to the second set of alternating foot air bladders 949B. The second set of alternating foot air bladders 949B may be inflated prior to and/or during deflation of the first set of alternating foot air bladders 949A. Likewise, under ALP, the second set of alternating foot air bladders 949B may, periodically, be at least partially deflated (e.g., to vent within the third person support surface 904 and/or via a valve-controlled deflation) to redistribute a portion of pressure on the subject's body in the foot section zone 907 from the second set of alternating foot air bladders 949B to the first set of alternating foot air bladders 949A. The first set of alternating foot air bladders 949A may be inflated prior to and/or during deflation of the second set of alternating foot air bladders 949B. As one example, the first set of alternating foot air bladders 949A and the second set of alternating foot air bladders 949B may be controlled in a set of phases. In a first phase, each air bladder of the first set of alternating foot air bladders 949A may be deflated to a relatively low pressure (e.g., relative to the balanced pressure as described herein) and each air bladder of the second set of alternating foot air bladders 949B may be inflated to a relatively high pressure (e.g., relative to the balanced pressure as described herein). In some aspects, the low pressure may be a near-zero pressure, a near-atmospheric pressure, or the like and the high pressure may be a predetermined percentage (e.g., 10%-20%) higher than the balanced pressure. A duration of the first phase may be a first defined time period (e.g., “R” minutes, up to a predetermined maximum of “S” minutes, and/or the like).

As one example, the first defined time period may be about 1.5 minutes up to about 15 minutes. Continuing the example, in a second phase, each air bladder of the first set of alternating foot air bladders 949A may be inflated to the balanced pressure and each air bladder of the second set of alternating air bladders 949B may be deflated to the balanced pressure. Accordingly, each air bladder of the first set of alternating foot air bladders 949A and each air bladder of the second set of alternating foot air bladders 949B would realize the same balanced pressure. A duration of the second phase may be a second defined time period (e.g., “T” minutes, up to a predetermined maximum of “U” minutes, and/or the like). As one example, the second defined time period may be about 1.5 minutes up to about 15 minutes. Further continuing the example, in a third phase, each air bladder of the second set of alternating foot air bladders 949B may be deflated to a relatively low pressure (e.g., relative to the balanced pressure as described herein) and each air bladder of the first set of alternating foot air bladders 949A may be inflated to a relatively high pressure (e.g., relative to the balanced pressure as described herein). In some aspects, the low pressure may be a near-zero pressure, a near-atmospheric pressure, or the like and the high pressure may be a predetermined percentage (e.g., 10%-20%) higher than the balanced pressure. A duration of the third phase may be a third defined time period (e.g., “V” minutes, up to a predetermined maximum of “W” minutes, and/or the like). As one example, the third defined time period may be about 1.5 minutes up to about 15 minutes. Accordingly, in some aspects, a pressure in each air bladder of the foot section zone 907 may alternate (e.g., ALP) from a high pressure or a low pressure to a balanced pressure or from a balanced pressure to a high pressure or a low pressure. In other aspects, a pressure in each air bladder of the foot section zone 907 may alternate (e.g., ALP) from a high pressure to a low pressure without a balanced pressure phase or from a low pressure to a high pressure without a balanced pressure phase.

Referring still to FIG. 9A, in some aspects, the head section support cushion zone 444A, the seat section support cushion zone 444B, and/or the foot section zone 907 may be associated with a same balanced pressure. In other aspects, each of the head section support cushion zone 444A, the seat section support cushion zone 444B, and/or the foot section zone 907 may be associated with a different balanced pressure. Accordingly, the third person support surface 904 of the present disclosure is capable of isolating ALP associated with the head section support cushion zone 444A, ALP associated with the seat section support cushion zone 444B, and/or ALP associated with the foot section zone 907 to optimize and/or customize pressures experienced by a subject's body. Furthermore, the ability to isolate ALP associated with the head section support cushion zone 444A, ALP associated with the seat section support cushion zone 444B, and/or ALP associated with the foot section zone 907 enables the third person support surface 904 to maintain existing person support surface functionalities (e.g., seat section deflate, seat section and/or foot section deflate during chair egress, and/or the like). In yet further aspects, the balanced pressure in each of the head section support cushion zone 444A, the seat section support cushion zone 444B, and/or the foot section zone 907 may be manually selectable/adjustable (e.g., to a comfort level of the subject, increase and/or decrease the balanced pressure to feel, and/or the like) via a user interface 124 (FIG. 1, e.g., display) of the person support apparatus 102 (FIG. 1).

According to various aspects, referring still to FIG. 9A, the first set of alternating air tubes 945A of the head section support cushion zone 444A, the first set of alternating air tubes 947A of the seat section support cushion zone 444B, and/or the first set of alternating foot air bladders 949A of the foot section zone 907 may be controlled (e.g., inflated and/or deflated) simultaneously or sequentially. In one aspect, each first set of alternating air tubes 945A, 947A, and/or 949A (e.g., all marked with “1” in FIG. 9A) may be controlled (e.g., inflated and/or deflated) at the same time or substantially the same time. In one example, each first set of alternating air tubes 945A, 947A, and/or 949A may be controlled (e.g., inflated and/or deflated at the same time or substantially the same time) via the set of phases, as described herein. In another example, each first set of alternating air tubes 945A, 947A, and/or 949A may be controlled (e.g., inflated and/or deflated at the same time or substantially the same time) to any predetermined pressure for any defined time period (e.g., “K” minutes, “Y” seconds, and/or the like). In a further aspect, each first set of alternating air tubes 945A, 947A, and/or 949A may be controlled (e.g., inflated and/or deflated) sequentially. In one example, the first set of alternating air tubes 945A of the head section support cushion zone 444A may be controlled (e.g., inflated and/or deflated to any predetermined pressure for any defined time period), then the first set of alternating air tubes 947A of the seat section support cushion zone 444B may be controlled (e.g., inflated and/or deflated to any predetermined pressure for any defined time period), and then the first set of alternating foot air bladders 949A of the foot section zone 907 may be controlled (e.g., inflated and/or deflated to any predetermined pressure for any defined time period). In such aspects, sequential actuation may emulate a wave-like motion between a distal end (e.g., in the +Z direction of the coordinate axes of FIG. 9A) and a proximal end (e.g., in the −Z direction of the coordinate axes of FIG. 9A) of the third person support surface 904. Here it should be appreciated that the first set of alternating air tubes 945A of the head section support cushion zone 444A, the first set of alternating air tubes 947A of the seat section support cushion zone 444B, and/or the first set of alternating foot air bladders 949A of the foot section zone 907 may be actuated in a different sequence (e.g., for different wave-like motions).

Similarly, referring still to FIG. 9A, the second set of alternating air tubes 945B of the head section support cushion zone 444A, the second set of alternating air tubes 947B of the seat section support cushion zone 444B, and/or the second set of alternating foot air bladders 949B of the foot section zone 907 may be controlled (e.g., inflated and/or deflated) simultaneously or sequentially. In one aspect, each second set of alternating air tubes 945B, 947B, and/or 949B (e.g., all marked with “2” in FIG. 9A) may be controlled (e.g., inflated and/or deflated) at the same time or substantially the same time. In one example, each second set of alternating air tubes 945B, 947B, and/or 949B may be controlled (e.g., inflated and/or deflated at the same time or substantially the same time) via the set of phases, as described herein. In another example, each second set of alternating air tubes 945B, 947B, and/or 949B may be controlled (e.g., inflated and/or deflated at the same time or substantially the same time) to any predetermined pressure for any defined time period (e.g., “X” minutes, “Y” seconds, and/or the like). In a further aspect, each second set of alternating air tubes 945B, 947B, and/or 949B may be controlled (e.g., inflated and/or deflated) sequentially. In one example, the second set of alternating air tubes 945B of the head section support cushion zone 444A may be controlled (e.g., inflated and/or deflated to any predetermined pressure for any defined time period), then the second set of alternating air tubes 947B of the seat section support cushion zone 444B may be controlled (e.g., inflated and/or deflated to any predetermined pressure for any defined time period), and then the second set of alternating foot air bladders 949B of the foot section zone 907 may be controlled (e.g., inflated and/or deflated to any predetermined pressure for any defined time period). In such aspects, sequential actuation may emulate a wave-like motion between a distal end (e.g., in the +Z direction of the coordinate axes of FIG. 9A) and a proximal end (e.g., in the −Z direction of the coordinate axes of FIG. 9A) of the third person support surface 904. Here it should be appreciated that the second set of alternating air tubes 945B of the head section support cushion zone 444A, the second set of alternating air tubes 947B of the seat section support cushion zone 444B, and/or the second set of alternating foot air bladders 949B of the foot section zone 907 may be actuated in a different sequence (e.g., for different wave-like motions).

According to yet further aspects, each first set of alternating air tubes 945A, 947A, and/or 949A (e.g., all marked with “1” in FIG. 9A) and each second set of alternating air tubes 945B, 947B, and/or 949B (e.g., all marked with “2” in FIG. 9A) may be controlled (e.g., inflated and/or deflated) simultaneously or sequentially. In one example, the first set of alternating air tubes 945A and the second set of alternating air tubes 945B of the head section support cushion zone 444A, and/or the first set of alternating air tubes 947A and the second set of alternating air tubes 947B of the seat section support cushion zone 444B, and/or the first set of alternating foot air bladders 949A and the second set of alternating foot air bladders 949B of the foot section zone 907 may be controlled (e.g., inflated and/or deflated) at the same time or substantially the same time. In another example, the first set of alternating air tubes 945A may be controlled (e.g., inflated and/or deflated to any predetermined pressure for any defined time period), then the second set of alternating air tubes 945B may be controlled (e.g., inflated and/or deflated to any predetermined pressure for any defined time period), then the first set of alternating air tubes 947A may be controlled (e.g., inflated and/or deflated to any predetermined pressure for any defined time period), then the second set of alternating air tubes 947B may be controlled (e.g., inflated and/or deflated to any predetermined pressure for any defined time period), then the first set of alternating foot air bladders 949A may be controlled (e.g., inflated and/or deflated to any predetermined pressure for any defined time period), and then the second set of alternating foot air bladders 949B may be controlled (e.g., inflated and/or deflated to any predetermined pressure for any defined time period). In such aspects, sequential actuation may emulate a wave-like motion between a distal end (e.g., in the +Z direction of the coordinate axes of FIG. 9A) and a proximal end (e.g., in the −Z direction of the coordinate axes of FIG. 9A) of the third person support surface 904. Here it should be appreciated that each first set of alternating air tubes 945A, 947A, and/or 949A (e.g., all marked with “1” in FIG. 9A) and/or each second set of alternating air tubes 945B, 947B, and/or 949B (e.g., all marked with “2” in FIG. 9A) may be actuated (e.g., together and/or individually) in a different sequence (e.g., for different wave-like motions). Such wave-like motions, as described herein, may produce a massaging (e.g., comfort) effect for the subject, further reduce the risks of pressure injuries as described herein, and/or the like. In some aspects, such wave-like motions may be similarly produced using various zones as described herein (e.g., FIG. 4). In one aspect, for example, the first enclosure 711, 811, 911 and/or the second enclosure 713, 813, 913 may control the head section support cushion zone 444A and the seat section support cushion zone 444B of the support cushion layer 440A in combination with the distal foot zone 468A, the central foot zone 468B, and the proximal foot zone 468C of the foot bladder layer 460 to emulate such wave-like motions. In another aspect, for example, the first enclosure 711, 811, 911 and/or the second enclosure 713, 813, 913 may control the head section support cushion zone 445A and the seat section support cushion zone 445B of the support cushion layer 440B in combination with the distal foot zone 468A, the central foot zone 468B, and the proximal foot zone 468C of the foot bladder layer 460 (see FIG. 4) to emulate such wave-like motions.

In light of FIG. 9A, it should be understood that the head section support cushion zone 444A, the seat section support cushion zone 444B, and/or the foot section zone 907 may be arranged differently. For example, each of the head section support cushion zone 444A and the seat section support cushion zone 444B may include more than two sets of air tubes that function as described herein and the foot section zone 907 may include more than two sets of air bladders that function as described herein. Furthermore, the third person support surface 904 may define yet further zone sections (e.g., a thigh section zone, a lumbar section zone, and/or the like) where each zone section includes two or more than two sets of air tubes and/or air bladders that function as described herein.

FIGS. 10A-10C depict a blower subassembly 902 arranged to supply a fluid (e.g., cooling air) to the MCM layer 450 of the first person support surface 704, the second person support surface 804, the third person support surface 904, or the like, as described herein.

FIG. 10A depicts an illustrative blower subassembly 902, according to various aspects described herein. The blower subassembly 902 may include a blower enclosure 770, 870, 970 (FIGS. 7A, 8A, and 9A) that houses a blower (not shown) and includes one or more than one fluid inlet 901A, 901B and one or more than one fluid supply tube 906A, 906B. According to various aspects, the blower enclosure 770, 870, 970 may be a custom designed blower enclosure (e.g., a housing comprising sound dampening foam and/or chambers configured to reduce blower noise, or the like). According to some aspects, the blower enclosure 770, 870, 970 may include an air manifold that defines the one or more than one fluid supply tube 906A, 906B. In yet further aspects, the blower enclosure 770, 870, 970 may include a blower control board (e.g., independent of or dependent on (e.g., slave to) an air control board of the second enclosure 713, 813, 913) to control the blower (e.g., to optimize flow rate as described herein). In some aspects, the blower enclosure 770, 870, 970 may not include a separate blower control board (e.g., blower controlled by the air control board of the second enclosure 713, 813, 913). In some aspects, the blower enclosure 770, 870, 970 may not include any air valves. According to various aspects of the present disclosure, the blower subassembly 902 may be integrated within the first person support surface 704, the second person support surface 804, the third person support surface 904, or the like such that an external fluid source (e.g., an air source associated with a person support apparatus 102 (FIG. 1), an air source that supports P&V therapy, an air source that supports various bladder pressures, an air source the maintains a pressure in the support cushion layer 440A, 440B to reduce interface pressures with the subject, and/or the like) is not utilized.

According to aspects of the present disclosure, an integrated blower subassembly 902 reduces and/or eliminates deficiencies introduced by an external fluid source. According to various aspects, the integrated blower subassembly 902 provides a fluid source dedicated to increasing MCM performance. In particular, the blower subassembly 902 of the present disclosure may optimize flow rate at a desired interface pressure to realize maximum skin cooling and/or drying. This is an improvement over any existing person support surface that uses a fluid source (e.g., blower, pump, compressor, or the like) external to the person support surface, that fluid source taxed with supplying a fluid for other functionalities (e.g., P&V, turn assist, CLRT, CLP, ALP, or the like) and that is not optimized for MCM. Furthermore, the blower subassembly 902 of the present disclosure reduces and/or eliminates systematic decreases in flow rate (e.g., frictional decreases due to supply tube length from an external fluid source, or the like) and/or pressure drops introduced by external fluid sources (e.g., pressure drops through fittings and connectors, and/or the like). Accordingly, the integrated blower subassembly of the present disclosure can deliver optimized flow rates with lower pressure drops.

According to various aspects described herein, the blower subassembly 902 may be positioned adjacent the MCM layer 450 at a proximal portion (e.g., in the +Z direction of the coordinate axes of FIG. 9A) of the seat section (e.g., seat section 905B) of the person support surface 704, 804, 904 (e.g., near a subject's knee, to minimize blower noise at the subject's head for subject comfort). In one aspect, the blower subassembly 902 may be positioned adjacent the MCM layer 450 within the foot section 906, as described elsewhere herein. In some aspects, more than one blower subassembly 902 may be integrated within the person support surface 704, 804, 904. For example, in light of FIG. 10B, a first blower subassembly 902 may be integrated on a first lateral side (e.g., in the −X direction of the coordinate axes of FIG. 10B) of the person support surface 704, 804, 904 and a second blower subassembly 902 may be integrated on a second lateral side (e.g., in the +X direction of the coordinate axes of FIG. 10B) of the person support surface 704, 804, 904, where the first blower subassembly 902 includes the fluid supply tube 906A and the second blower subassembly 902 includes the fluid supply tube 906B. According to an alternative aspect, the blower subassembly 902 may be removed from the person support surface 704, 804, 904 and the MCM layer 450 as described herein, may be supplied with a fluid from a dedicated external fluid source (e.g., a portable or add-on air source mountable to the person support apparatus 102 and capable of providing a continuous high-flow, low pressure similar and/or equal to the blower subassembly 902, and/or the like) to function as described herein. In such aspects, the dedicated external fluid source may couple to the one or more than one fluid inlet 901A, 901B, as described herein (e.g., if a blower subassembly 902 becomes inoperative). Referring to FIG. 10A, the fluid inlet 901A may include a fluid collector 923A coupled to the blower enclosure 770, 870, 970. The fluid collector 923A may collect a fluid (e.g., air) over a pre-defined surface area. In view of FIG. 10A, the pre-defined surface area may be defined by the shape (e.g., oval and/or the like) and size of the fluid collector body 924A. Further in view of FIG. 10A, the fluid collector 923A may define a fluid collector lip 934A. Similarly, the fluid inlet 901B may include a fluid collector 923B coupled to the blower enclosure 770, 870, 970 and the fluid collector 923B may collect a fluid (e.g., air) over a pre-defined surface area defined by the shape (e.g., oval and/or the like) and size of the fluid collector body 924B. Further, the fluid collector 923B may similarly define a fluid collector lip 934B. According to various aspects of the present disclosure, the blower subassembly 902 may include at least one fluid inlet (e.g., fluid inlet 901A or fluid inlet 901B). In such aspects, the fluid collector 923A and/or the fluid collector 923B may be sized and/or configured to accommodate a predetermined, continuous MCM flow rate to the MCM layer 450. Accordingly, the blower subassembly 902 may output a predetermined, continuous MCM flow rate to the MCM layer 450 to reduce temperature and moisture at the subject interface (e.g., top of the person support surface 704, 804, 904).

FIG. 10B depicts a perspective view of a proximal portion (e.g., in the +Z direction of the coordinate axes of FIG. 4) of the surface foundation layer 410 of FIG. 4, according to various aspects described herein (e.g., corresponding to the seat section 905B of the third person support surface 904). The surface foundation layer 410, as described herein, may be used to integrate the blower subassembly 902 into the first person support surface 704, the second person support surface 804, the third person support surface 904, or the like, as described herein. Referring to FIG. 10B, a proximal portion (e.g., in the +Z direction of the coordinate axes of FIG. 10B) of the surface foundation layer 410 may house a blower enclosure 770, 870, 970. According to various aspects, the blower enclosure 770, 870, 970 may house various valves, pressure sensors, and electronics boards as well as a blower (not shown, e.g., a high-flow, low-pressure blower) to generate a pressure difference to draw in a fluid (e.g., air) from at least one fluid inlet 901A and expel the fluid (e.g., air) through at least one fluid supply tube 906A, 906B. A fluid inlet cavity 944A may be defined in the foundation base 412 (e.g., foam such as thigh foam) and/or the subject right side bolster 714, 814, 914 of the surface foundation layer 410 to receive the fluid collector 923A such that the fluid (e.g., air) can be drawn in through a bottom side (e.g., in the -Y direction of the coordinate axes of FIG. 10B) of the first person support surface 704, the second person support surface 804, the third person support surface 904, and/or the like.

Referring still to FIG. 10B, a supply tube cavity 908 may be further defined in the foundation base 412 of the surface foundation layer 410 (e.g., in the seat section 905B of the third person support surface 904). According to aspects described herein, various supply tubes (FIG. 4, e.g., 426A, 426B, 426C, 426D, 436A, 436B, 436C, 436D, 446A, 446B, 447A, 447B, 466A, 466B, 466C, and/or the like, e.g., polyethylene hoses and/or the like) may be channeled through the subject right channel 774, 874, 974 (e.g., defined in the subject right side bolster 714, 814, 914) and/or the subject left channel 776, 876, 976 (e.g., defined in the subject left side bolster 716, 816, 916) and through the supply tube cavity 908 to an external fluid source (e.g., air source associated with a person support apparatus 102 (FIG. 1), and/or the like). According to various aspects, the external fluid source may include a blower, a compressor, and/or a pump (not shown) associated with the person support apparatus 102 (FIG.1), where the blower, compressor, and/or pump act as a fluid source for various levels of therapy realized by the various person support surfaces 704, 804, 904 described herein. For example, a first level of therapy may include no CLRT therapy or P&V therapy, a second level of therapy may include pulmonary therapy that includes only CLRT therapy, a third level of therapy may include pulmonary plus therapy that includes CLRT therapy and P&V therapy, and/or the like. As another example, a first level of therapy may include no CLRT therapy or P&V therapy with or without CLP and/or ALP therapy, a second level of therapy may include pulmonary therapy that includes only CLRT therapy with or without CLP and/or ALP therapy, a third level of therapy may include pulmonary plus therapy that includes CLRT therapy and P&V therapy with or without CLP and/or ALP therapy, and/or the like. Notably, each of the various levels of therapy described herein may be provided on a standard (e.g., 36 inch (0.9144 meter)) and/or a wide (40 in (1.016 meter)) person support surface. Similarly, according to aspects described herein, the fluid supply tube 906A may be channeled through the subject right channel 774, 874, 974 along a first lateral side (e.g., in the −X direction of the coordinate axes of FIG. 10B) and the fluid supply tube 906B may be channeled through the subject left channel 776, 876, 976 along a second lateral side (e.g., in the +X direction of the coordinate axes of FIG. 10B). Such routing and/or channeling within the subject right channel 774, 874, 974, the subject left channel 776, 876, 976, another portion of the foundation base 412, and/or the like minimizes and/or prohibits a subject from feeling the supply tubes, as described herein, through the person support surface 704, 804, 904. Furthermore, by routing and/or channeling such supply tubes to the first lateral side and the second lateral side of the person support surface 704, 804, 904, and/or moving the blower enclosure 770, 870, 970 toward a proximal end (e.g., in the +Z direction of the coordinate axes of FIG. 10B) a relatively large radiolucent window 920 (e.g., a portion of which is depicted in phantom in FIG. 10B) may be defined in the distal portion (e.g., in the −Z direction of the coordinate axes of FIG. 10B) of the person support surface 704, 804, 904 (e.g., extending distally between the seat and/or waist of the subject and the head and/or neck of the subject positioned on the person support surface 704, 804, 904). Accordingly, the radiolucent window 920 is improved due to less potential interference and/or blockage of images from components internal to the person support surface 704, 804, 904 thereby improving fluoroscopy procedures. For example, the relatively large radiolucent window 920 may create an expanded and/or maximized area for equipment (e.g., a C-arm carrying a first portion of equipment above the person support surface 704, 804, 904 and a second portion of equipment below the deck portion 400 (FIG. 4), the first portion of equipment and/or the second portion of equipment including radiography equipment, fluoroscopy equipment, and/or the like) positioned adjacent the person support apparatus 102 (e.g., FIG. 1) to be located/positioned across the person support surface 704, 804, 904. Accordingly, the relatively large radiolucent window 920 expands and/or maximizes the area of the person support surface 704, 804, 904 on which a subject can be positioned to lie while fluoroscopic procedures are performed on the subject. In such aspects, the head section 401 and/or the seat section 403 (e.g., which may include the thigh section 405) of the deck portion 400 (e.g., FIG. 4) may include a radiolucent portion defined by a radiolucent material (e.g., a polycarbonate such as Lexan® (available through SABIC Global Technologies, Netherlands), a paper phenolic, and/or the like) that is transparent to X-rays thereby permitting X-rays to pass therethrough.

Still referring to FIG. 10B, one or more than one mounting strip 946A, 946B, may be mounted above (e.g., in the +Y direction of the coordinate axes of FIG. 10B) and one or more than one mounting strip 946C may be mounted below (e.g., in the −Y direction of the coordinate axes of FIG. 10B) the foundation base 412 of the surface foundation layer 410 to mount various internal components (e.g., blower subassembly 902, various supply tubes, and/or the like) and/or to provide general stiffness to the person support surface 704, 804, 904 overall structure (e.g., for movement between beds, when cleaning, and/or the like). The one or more than one mounting strip 946A, 946B, 946C may be defined by a material including a polymer, a metal, and/or the like.

FIG. 10C depicts another perspective view of the proximal portion (e.g., in the +Z direction of the coordinate axes of FIG. 4) of the surface foundation layer 410 of FIG. 4, according to various aspects described herein. Referring to FIG. 10C, the at least one fluid inlet may further include the fluid inlet 901A and the fluid inlet 901B. A fluid inlet cavity 944B may be defined in the foundation base 412 (e.g., foam such as thigh foam) and/or the subject right side bolster 714, 814, 914 of the surface foundation layer 410 to receive the fluid collector 923B, such that the fluid (e.g., air) can be drawn in through the firstlateral side (e.g., in the −X direction of the coordinate axes of FIG. 10C) of the first person support surface 704, the second person support surface 804, the third person support surface 904, and/or the like.

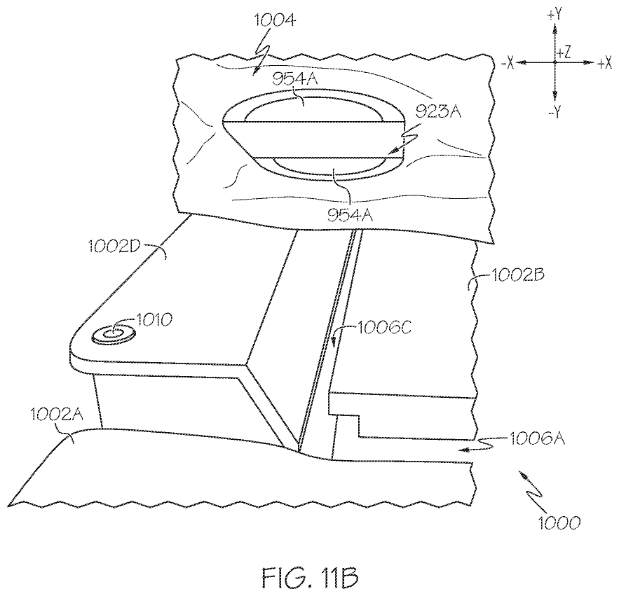

FIG. 11A depicts a perspective view of a fourth illustrative person support surface 1004 including a fluid inlet 901A located on a bottom side (e.g., in the −Y direction of the coordinate axes of FIG. 11A) of the fourth person support surface 1004 and a fluid inlet 901B located on a first lateral side (e.g., in the −X direction of the coordinate axes of FIG. 11A) of the fourth person support surface 1004. Referring to FIG. 11A, the fluid inlet 901A may include a fluid collector 923A, as described herein, that protrudes external to the bottom encasement portion 108 on the bottom side of the fourth person support surface 1004 and the fluid inlet 901B may include a fluid collector 923B, as described herein, that protrudes external to the bottom encasement portion 108 on the first lateral side of the fourth person support surface 1004. According to various aspects described herein, an aperture may be located and defined in the bottom side (e.g., in the −Y direction of the coordinate axes of FIG. 11A) of the bottom encasement portion 108 such that the fluid collector 923A of the fluid inlet 901A can protrude external to the fourth person support surface 1004. Similarly, an aperture may be located and defined in the first lateral side (e.g., in the −X direction of the coordinate axes of FIG. 11A) of the bottom encasement portion 108 such that the fluid collector 923B of the fluid inlet 901B can protrude external to the fourth person support surface 1004. In some aspects, the aperture defined for the fluid collector 923A may include an elastic material (not shown) that expands as the fluid collector 923A is passed from internal to the fourth person support surface 1004, through the aperture located and defined for the fluid collector 923A, and external to the fourth person support surface 1004. After passage of the fluid collector 923A through its aperture, the elastic material may contract about the fluid collector body 924A (e.g., FIG. 10A). The elastic material in conjunction with the fluid collector lip 934A (e.g., FIG. 10A) may assist in keeping the fourth person support surface 1004 fluid-resistant and/or fluid-proof (e.g., with respect to bodily fluids, liquids, and/or the like present on and/or flowing over an external surface of the top encasement portion 106 and/or bottom encasement portion 108 of the fourth person support surface 1004). Similarly, the aperture defined for the fluid collector 923B may include an elastic material (not shown) that expands as the fluid collector 923B is passed from internal to the fourth person support surface 1004, through the aperture located and defined for the fluid collector 923B, and external to the fourth person support surface 1004. After passage of the fluid collector 923B through its aperture, the elastic material may contract about the fluid collector body 924B (e.g., FIG. 10A). The elastic material in conjunction with the fluid collector lip 934B (e.g., FIG. 10A) may assist in keeping the fourth person support surface 1004 fluid-resistant and/or fluid-proof (e.g., with respect to bodily fluids, liquids, and/or the like present on and/or flowing over an external surface of the top encasement portion 106 and/or bottom encasement portion 108 of the fourth person support surface 1004).

Referring still to FIG. 11A, a deck portion 1000 of a person support apparatus 102 (e.g., FIG. 1) may include a plurality of deck sections including a first deck section 1002A, a second deck section 1002B, a third deck section 1002C, and/or the like. According to various aspects, each of the plurality of deck sections 1002A, 1002B, 1002C may be articulable relative to one another. Accordingly, to accommodate articulation, a plurality of lateral gaps (e.g., extending in the −X and +X directions of the coordinate axes of FIG. 11A) may exist in the deck portion 1000 between adjacent deck sections (e.g., lateral gap 1006A between the first deck section 1002A and the second deck section 1002B, lateral gap 1006B between the second deck section 1002B and the third deck section 1002C, and/or the like). In light of FIG. 11A, aspects of the present disclosure realize efficient utilisation of such lateral gaps 1006A, 1006B. More specifically, the fluid collector 923A (and thus the blower enclosure 770, 870, 970 coupled thereto) may be located within the fourth person support surface 1004 such that one or more than one fluid inlet cavity 954A defined in the fluid collector 923A is aligned with a lateral gap (e.g., gap 1006A) of the plurality of lateral gaps in the deck portion 1000 to ensure an open fluid flow path. In light of FIG. 11A, one or more than one fluid inlet cavity 954B may be similarly defined in the fluid collector 923B. Similarly, the fluid collector 923B may be located within the fourth person support surface 1004 such that the one or more than one fluid inlet cavity 954B defined in the fluid collector 923B is aligned with any air gaps defined in a side rail(s) (see FIG. 1) of the person support apparatus 102 to ensure an open fluid flow path.

Further in view of FIG. 11A, according to various aspects, one or more than one person support surface locator 1008 may protrude from the bottom encasement portion 108 of the fourth person support surface 1004. In such aspects, each person support surface locator 1008 may be configured and/or located to be received in a respective person support surface locator receiver 1010 (e.g., FIG. 11B) defined in the deck portion 1000. In some aspects, the one or more than one person support surface locator 1008 may be mounted through a mounting strip 946A, 946B, 946C (FIG. 10B). In other aspects, the one or more than one person support surface locator 1008 may be mounted through an enclosure (e.g., enclosure 411, 413, 470 711, 713, 770, 811, 813, 870, 911, 913, 970, or the like) to minimize a need for mounting strips 946A, 946B, 946C or the like. According to various aspects of the present disclosure, the one or more than one person support surface locator 1008 may locate the fourth person support surface 1004 on the deck portion 1000 such that the one or more than one fluid inlet cavity 954A defined in the fluid collector 923A is aligned with a gap (e.g., lateral gap 1006A) of the plurality of gaps in the deck portion 1000 and/or the one or more than one fluid inlet cavity 954B defined in the fluid collector 923B is aligned with a gap of the side railing.

FIG. 11B depicts another perspective view of the fourth person support surface 1004 of FIG. 11A, according to various aspects described herein. Referring to FIG. 11B, the plurality of deck sections, including the first deck section 1002A and the second deck section 1002B, may not only articulate relative to one another but may also articulate relative to other deck sections (e.g., a fourth deck section 1002D) of the deck portion 1000. Accordingly, to accommodate articulation, a plurality of longitudinal gaps (e.g., extending in the −Z and +Z directions of the coordinate axes of FIG. 11B) may exist in the deck portion 1000 between adjacent deck sections (e.g., longitudinal gap 1006C between the second deck section 1002B and the fourth deck section 1002D, and/or the like). In light of FIG. 11B, aspects of the present disclosure realize efficient utilisation of such longitudinal gaps (e.g., longitudinal gap 1006C). More specifically, the fluid collector 923A (and thus the blower enclosure 770, 870, 970 coupled thereto) may be located within the fourth person support surface 1004 such that one or more than one fluid inlet cavity 954A defined in the fluid collector 923A is aligned with a longitudinal gap (e.g., longitudinal gap 1006C) of the plurality of longitudinal gaps in the deck portion 1000 to ensure an open air flow path. According to various aspects, as depicted in FIG. 11B, the fluid collector 923A (and thus the blower enclosure 770, 870, 970 coupled thereto) may be located within the fourth person support surface 1004 such that its proximally positioned (e.g., in the +Z direction of the coordinate axes of FIG. 11B) fluid inlet cavity 954A is aligned with a lateral gap (e.g., lateral gap 1006A) of the deck portion 1000 and its distally positioned (e.g., in the −Z direction of the coordinate axes of FIG. 11B) fluid inlet cavity 954A is aligned with a longitudinal gap (e.g., longitudinal gap 1006C) to ensure an open air flow path.

FIG. 12A depicts a top plan view of the MCM layer 450 of FIG. 5 that illustrates fluid flow paths into, through, and out of a person support surface 704, 804, 904, according to various aspects described herein. Such defined flow paths may be an improvement over MCM systems including a single inlet from which cooling air seeps into the MCM layers. Referring to FIG. 12A, a fluid (e.g., air) may be drawn into the person support surface 704, 804, 904 by a blower (not shown, e.g., a high-flow, low-pressure blower) housed within a blower enclosure 770, 870, 970 through at least one of fluid inlet 901A and/or fluid inlet 901B (e.g., FIGS. 10A-10C). In such an aspect, the fluid may flow out of the blower enclosure 770, 870, 970 along one or more than one fluid flow path.

According to various aspects, as illustrated in FIG. 12A, in a first fluid flow path, the fluid may flow out of the blower enclosure 770, 870, 970 and into a fluid supply tube 906B channeled along a subject left side bolster 716, 816, 916. In the first fluid flow path, the fluid may flow out of a distal end (e.g., in the −Z direction of the coordinate axes of FIG. 12A) of the fluid supply tube 906B and through a subject left blow horn inlet 1106. Further in the first fluid flow path, the fluid may flow through the subject left blow horn inlet 1106 and into the subject left blow horn 1116 (depicted in phantom in FIG. 12A) positioned on a second lateral side (e.g., in the +X direction of the coordinate axes of FIG. 12A). Similarly, as illustrated in FIG. 12A, in a second fluid flow path, the fluid may flow out of the blower enclosure 770, 870, 970 and into a fluid supply tube 906A channeled along a subject right side bolster 714, 814, 914. In the second fluid flow path, the fluid may flow out of a distal end (e.g., in the −Z direction of the coordinate axes of FIG. 12A) of the fluid supply tube 906A and through a subject right blow horn inlet 1104. Further in the second fluid flow path, the fluid may flow through the subject right blow horn inlet 1104 and into the subject right blow horn 1114 (depicted in phantom in FIG. 12A, see FIG. 12B) positioned on a first lateral side (e.g., in the −X direction of the coordinate axes of FIG. 12A). According to other aspects, a vertical fabric and at least one transverse and/or longitudinal spacer channel may open into the seat MCM portion 510.

Referring still to FIG. 12A, the fluid of the first fluid flow path may flow from the subject left blow horn 1116 and the fluid of the second fluid flow path may flow from the subject right blow horn 1114 into an array of holes 514 defined in and/or through the bottom MCM sheet 506 (e.g., FIG. 5) and/or the seat MCM portion 510 of the MCM layer 450 to distribute the fluid across the surface of the seat MCM portion 510. According to various aspects, the subject right blow horn 1114 and the subject left blow horn 1116 may be fixedly attached to a bottom surface (e.g., in the −Y direction of the coordinate axes of FIG. 12A) of the bottom MCM sheet 506 (e.g., FIG. 12B). In some aspects, the combined first fluid flow path and second fluid flow path may flow out of the array of holes 514 of the seat MCM portion 510 and into a distal portion (e.g., in the −Z direction of the coordinate axes of FIG. 12A) of the MCM layer 450 (e.g., toward the head MCM portion 512). Here, as discussed with respect to FIG. 5, the fluid is able to flow between the seat MCM portion 510 and the head MCM portion 512 on the top MCM sheet 502 side. In light of FIG. 12A, the combined fluid may flow distally (e.g., in the −Z direction of the coordinate axes of FIG. 12A) toward a vent 1120 defined in a bottom surface (e.g., in the −Y direction of the coordinate axes of FIG. 12A) of the MCM layer 450 (see FIG. 12B, e.g., defined in the bottom MCM sheet 506). As discussed herein, the fixed attachment at the first side 513A, the second side 513B, and the third side 513C of the head MCM portion 512 (e.g., FIG. 5) may promote the distal fluid flow across the top (e.g., in the +Y direction of the coordinate axes of FIG. 12A) surface of the head MCM portion 512. Furthermore, a lack of the fixed attachment at a fourth side 513D (FIG. 5) may permit the fluid flow toward the vent 1120. In other aspects, the combined first fluid flow path and second fluid flow path may flow out of the array of holes 514 of the seat MCM portion 510 and into both a distal portion (e.g., in the −Z direction of the coordinate axes of FIG. 12A) of the MCM layer 450 (e.g., toward the head MCM portion 512) and a proximal portion (e.g., in the −Z direction of the coordinate axes of FIG. 12A) of the MCM layer 450 (e.g., toward the foot MCM portion 508 (see FIG. 12B, dashed fluid flow lines). Here, as discussed with respect to FIG. 5, the fluid may flow between the seat MCM portion 510 and both the head MCM portion 512 and the foot MCM portion 508 on the top MCM sheet 502 side. The combined fluid may ultimately flow distally (e.g., in the −Z direction of the coordinate axes of FIG. 12A) toward the vent 1120. The combined fluid may then flow out of the vent 1120 and into the enclosure 1130 defined by the top encasement portion 106 and the bottom encasement portion 108 (see FIG. 12B). The combined fluid may flow out of the enclosure 1130 through one or more than one fluid outlet 1124A, 1124B, 1124C (FIGS. 12A and 12B) defined in the top encasement portion 106 and/or the bottom encasement portion 108 of the person support surface 704, 804, 904. According to various aspects, each fluid outlet 1124A, 1124B, 1124C may include a respective fluid flap 1126A, 1126B, 1126C having a first edge permanently coupled above (e.g., in the +Y direction of the coordinate axes of FIG. 12B) each respective fluid outlet 1124A, 1124B, 1124C and a second edge that extends over and/or beyond each respective fluid outlet 1124A, 1124B, 1124C such that the person support surface 704, 804, 904 remains fluid-resistant and/or fluid-proof.

Referring still to FIG. 12A, according to various aspects, the subject right blow horn 1114 and the subject left blow horn 1116 may be supplanted by a vertical fabric inlet (not shown) and/or at least one channel spacer that extends between a first lateral side (e.g., in the −X direction of the coordinate axes of FIG. 12A) and a second lateral side (e.g., in the +X direction of the coordinate axes of FIG. 12A) at the seat MCM portion 510 of the person support surface 704, 804, 904 and/or at least one channel spacer that extends between a proximal side (e.g., in the +Z direction of the coordinate axes of FIG. 12A) and a distal side (e.g., in the −Z direction of the coordinate axes of FIG. 12A) at the seat MCM portion 510 of the person support surface 704, 804, 904 to supply the fluid (e.g., cooling air) from the fluid supply tubes 906A, 906B to the seat MCM portion 510 through the various bladders (e.g., the plurality of turn bladders 422, the plurality of working cushion bladders 432, and/or the plurality of adjacent air tubes 442, 443, as described herein).

FIG. 12B depicts a side view of the MCM layer 450 of FIG. 12A that illustrates fluid flow paths into, through, and out of the person support surface 704, 804, 904, according to various aspects described herein. Referring to FIG. 12B, in line with FIG. 12A, a fluid (e.g., air) may be drawn into the person support surface 704, 804, 904 by a blower (not shown, e.g., a high-flow, low-pressure blower) through a fluid inlet 901A. As illustrated in FIG. 12B, in the second fluid flow path, the fluid may flow into a fluid supply tube 906A channeled along a subject right side bolster 714, 814, 914. In the second fluid flow path, the fluid may flow out of a distal end (e.g., in the −Z direction of the coordinate axes of FIG. 12B) of the fluid supply tube 906A and through a subject right blow horn inlet 1104. Further in the second fluid flow path, the fluid may flow through the subject right blow horn inlet 1104 and into the subject right blow horn 1114. According to various aspects described herein, the subject right blow horn 1114 may include a fabric subject right blow horn 1114. In light of FIG. 12B, the first fluid flow path into the subject left blow horn 1116 (e.g., FIG. 12A), as described herein, should be similarly understood.

Referring still to FIG. 12B, in line with FIG. 12A, the fluid of the second fluid flow path may flow from the subject right blow horn 1114 into the array of holes 514 defined in and/or through the seat MCM portion 510 and/or bottom MCM sheet 506 of the MCM layer 450 (FIG. 5) to distribute the fluid across the surface of the seat MCM portion 510. Further in line with FIG. 12A, in some aspects, a combined first fluid flow path and second fluid flow path may flow out of the array of holes 514 of the seat MCM portion 510 and into a distal portion (e.g., in the −Z direction of the coordinate axes if FIG. 12B) of the MCM layer 450 toward the vent 1120 defined in a bottom surface (e.g., in the −Y direction of the coordinate axes of FIG. 12B) of the MCM layer 450 (FIG. 12B, e.g., defined in the bottom MCM sheet 506). In other aspects, the combined first fluid flow path and second fluid flow path may flow out of the array of holes 514 of the seat MCM portion 510 and into both a distal portion (e.g., in the −Z direction of the coordinate axes of FIG. 12B) of the MCM layer 450 (e.g., toward the head MCM portion 512) and a proximal portion (e.g., in the −Z direction of the coordinate axes of FIG. 12B) of the MCM layer 450 (e.g., toward the foot MCM portion 508 (see FIG. 12B, dashed fluid flow lines). Here, as discussed with respect to FIG. 5, the fluid may flow between the seat MCM portion 510 and both the head MCM portion 512 and the foot MCM portion 508 on the top MCM sheet 502 side. The combined fluid may ultimately flow distally (e.g., in the −Z direction of the coordinate axes of FIG. 12B) toward the vent 1120. The combined fluid may then flow out of the vent 1120 and into the enclosure 1130 defined by the top encasement portion 106 and the bottom encasement portion 108. The combined fluid may flow out of the enclosure 1130 through one or more than one fluid outlet 1124A, 1124B defined in the top encasement portion 106 and/or the bottom encasement portion 108 of the person support surface 704, 804, 904. As depicted in FIG. 12B, each of the one or more than one fluid outlet 1124A, 1124B may include a respective fluid flap 1126A, 1126B having a first edge fixedly coupled above (e.g., in the +Y direction of the coordinate axes of FIG. 12B) each respective fluid outlet 1124A, 1124B and a second edge that extends over and/or beyond each respective fluid outlet 1124A, 1124B such that the person support surface 704, 804, 904 remains fluid-resistant and/or fluid-proof.

In light of FIGS. 12A and 12B, aspects of the present disclosure include a person support surface 704, 804, 904 capable of self-supported MCM as well as externally supported therapies (e.g., CLRT, P&V, CLP, ALP, and/or the like). Accordingly, the person support surface 704, 804, 904 described herein is able to support not only MCM but also therapies including CLRT, P&V, CLP, ALP and/or the like. Adding the self-supported MCM may provide beneficial results including an increased turn dwell time. For example, a subject under CLRT therapy using a person support surface 704, 804, 904 as described herein, may be held in a turn position for a relatively longer period of time (e.g., up to 2 hours, up to and/or between 2-4 hours, and/or the like, selectable via a user interface 124 (FIG. 1) of a person support apparatus 102) than a previous, relatively shorter period of time (e.g., about ½ hour). An increased turn dwell time permits a subject to maintain a lung over lung position for a relatively longer duration such that the subject's lungs can effectively drain. Furthermore, such aspects permit a subject to realize longer durations of uninterrupted rest in addition to a reduced risk of pressure injuries.

It should now be understood that the systems described herein include person support surfaces that include a combination of components realize a plurality of features and functionalities (e.g., turn assist, CLRT, P&V, CLP, ALP, MCM, and/or the like) such that the person support surfaces are interchangeably usable on and/or compatible with various person support apparatuses (e.g., a standard person support apparatus, an advanced articulation person support apparatus, a chair egress person support apparatus, and/or the like). Accordingly, each person support surface may allow more than one different person support apparatuse to support a wide range of therapies while introducing additional therapies including improved microclimate management (MCM) via a blower integrated within the person support surface itself and a particular MCM layer and flow path of cooling air through the person support surface. Particular integration of the blower within the person support surfaces may also improve other procedures including fluoroscopy procedures.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1.-62. (canceled)

63. A person support system, comprising:
a person support surface, including:
a surface foundation layer including a proximal end, a distal end, a first lateral side bolster and a second lateral side bolster, wherein the surface foundation layer extends between the proximal end and the distal end along a longitudinal axis;
a foot bladder layer positioned proximally adjacent to the surface foundation layer, the foot bladder layer comprising one or more tube bladders arranged between one or more raft layers and a substrate in a system vertical direction, the one or more tube bladders arranged to define one or more voids between the one or more raft layers and the substrate.

64. The system of claim 63, wherein the person support surface further includes:
a top encasement portion and a bottom encasement portion;
a blower subassembly;
a turn assist bladder layer;
a support cushion layer, wherein the turn assist bladder layer and the support cushion layer are positioned between the first lateral side bolster and the second lateral side bolster of the surface foundation layer; and
a microclimate management (MCM) layer positioned over the surface foundation layer, the turn assist bladder layer, the support cushion layer, and the foot bladder layer, wherein the blower subassembly is fluidly coupled to the MCM layer such that air is supplied by the blower subassembly to the MCM layer;
wherein the top encasement portion is removably coupled to the bottom encasement portion to enclose the blower subassembly, the surface foundation layer, the turn assist bladder layer, the support cushion layer, the foot bladder layer, and the MCM layer within the person support surface.

65. The system of claim 64, wherein the person support surface further includes:
a working cushion layer positioned between the first lateral side bolster and the second lateral side bolster of the surface foundation layer, wherein the MCM layer is positioned over the working cushion layer, and wherein the top encasement portion is removably coupled to the bottom encasement portion to further enclose the working cushion layer within the person support surface.

66. The system of claim 64, wherein the support cushion layer includes a plurality of air tubes oriented transverse to the longitudinal axis, wherein a first portion of the plurality of air tubes are cylindrically shaped, and wherein a second portion of the plurality of air tubes are shaped to conform to a profile of the surface foundation layer.

67. The system of claim 66, wherein the top encasement portion includes an enclosure that retains the MCM layer in contact with a surface of the top encasement portion.

68. The systemof claim 64, wherein the blower subassembly comprises:
a blower enclosure housing a blower that produces a continuous flow rate of air for the MCM layer;
one or more than one fluid inlet coupled to the blower enclosure, wherein the one or more than one fluid inlet is located on the person support surface to interface with one or more than one gap defined on one or more than one person support apparatus; and
one or more than one fluid supply tube, wherein a first end of each fluid supply tube is coupled to the blower enclosure and a second end of each fluid supply tube is coupled to the MCM layer.

69. (canceled)

70. The system of claim 68, wherein the blower subassembly includes a first fluid supply tube and a second fluid supply tube, and wherein the blower enclosure is positioned in a proximal portion of the person support surface, the first fluid supply tube is routed along the first lateral side bolster of the surface foundation layer, and the second fluid supply tube is routed along the second lateral side bolster of the surface foundation layer to define a radiolucent window in a distal portion of the person support surface for fluoroscopy procedures.

71. The system of claim 68, wherein the MCM layer comprises an internal MCM sheet that defines a seat MCM portion, wherein the seat MCM portion corresponds to a seat section of one or more than one person support apparatus, and wherein an array of holes is defined in the seat MCM portion to uniformly distribute the continuous flow rate of air across a surface of the seat MCM portion.

72. The system of claim 71, wherein the internal MCM sheet further defines a head MCM portion corresponding to a head section of the one or more than one person support apparatus, and wherein the seat MCM portion and the head MCM portion of the MCM layer are configured such that air continuously flows from the seat MCM portion across the head MCM portion toward a vent defined in a distal portion of the MCM layer.

73. The system of claim 64, wherein a sleeve is defined on a surface of the top encasement portion, wherein the sleeve is positioned to correspond with at least one of a head section, a seat section, or a foot section of one or more than one person support apparatus, and wherein the sleeve is accessible to place a medical device under a subject positioned on the person support surface.

74. The system claim 64, wherein the top encasement portion includes one or more than one fluid flap extending over one or more than one interlocking device such that the person support surface is one of fluid-resistant or fluid-proof.

75. A person support surface, including:
a microclimate management (MCM) air source;
a surface foundation layer including a proximal end, a distal end, a first lateral side bolster and a second lateral side bolster, wherein the surface foundation layer extends between the proximal end and the distal end along a longitudinal axis;
a plurality of person support surface layers positioned between the first lateral side bolster and the second lateral side bolster of the surface foundation layer;
a foot bladder layer positioned proximally adjacent to the surface foundation layer, the foot bladder layer comprising one or more tube bladders arranged between one or more raft layers and a substrate in a system vertical direction, the one or more tube bladders arranged to define one or more voids between the one or more raft layers and the substrate; and
a MCM layer positioned over the surface foundation layer, the plurality of person support surface layers, and the foot bladder layer, wherein the MCM air source is fluidly coupled to the MCM layer such that air is supplied by the MCM air source to the MCM layer.

76. The person support surface of claim 75, wherein the plurality of person support surface layers includes one or more than one of a turn assist bladder layer, a support cushion layer, a working cushion layer, a percussion and vibration bladder layer, and an advanced articulation bladder layer.

77. The person support surface of claim 75, further comprising a top encasement portion, wherein the top encasement portion includes an enclosure retaining the MCM layer in contact with a surface of the top encasement portion.

78. The person support surface of claim 75, wherein the MCM air source includes a blower subassembly comprising:
a blower enclosure housing a blower producing a continuous flow rate of air for the MCM layer;
one or more than one fluid inlet coupled to the blower enclosure, wherein the one or more than one fluid inlet is located on the person support surface to interface with one or more than one gap defined on one or more than one person support apparatus; and
one or more than one fluid supply tube, wherein a first end of each fluid supply tube is coupled to the blower enclosure and a second end of each fluid supply tube is coupled to the MCM layer.

79. The person support surface of claim 78, wherein the blower subassembly includes a first fluid supply tube and a second fluid supply tube, and wherein the blower enclosure is positioned in a proximal portion of the person support surface, the first fluid supply tube is routed along the first lateral side bolster of the surface foundation layer, and the second fluid supply tube is routed along the second lateral side bolster of the surface foundation layer to define a radiolucent window in a distal portion of the person support surface for fluoroscopy procedures.

80. The person support surface of claim 75, wherein the MCM layer comprises an internal MCM sheet that defines a seat MCM portion, wherein the seat MCM portion corresponds to a seat section of one or more than one person support apparatus, and wherein an array of holes is defined in the seat MCM portion to uniformly distribute the continuous flow rate of air across a surface of the seat MCM portion.

81. The person support surface of claim 80, wherein the internal MCM sheet further defines a foot MCM portion corresponding to a foot section of the one or more than one person support apparatus, wherein the foot MCM portion includes a spacer that is relatively softer than a spacer associated with the seat MCM portion to reduce a subject's heel interface pressure.

82. The person support surface of claim 80, wherein the internal MCM sheet further defines a head MCM portion corresponding to a head section of the one or more than one person support apparatus, and wherein the seat MCM portion and the head MCM portion of the MCM layer are configured such that air continuously flows from the seat MCM portion across the head MCM portion toward a vent defined in a distal portion of the MCM layer.

83. The person support surface of claim 75, further comprising a top encasement portion, wherein a sleeve is defined on a surface of the top encasement portion and is positioned to correspond with at least one of a head section, a seat section, or a foot section of one or more than one person support apparatus, and wherein the sleeve is accessible to place a medical device under a subject positioned on the person support surface.
